(19) United States
(12) Patent Application Publication
(10) Pub. No.: US 2008/0129272 A1
(43) Pub. Date: Jun. 5, 2008

(54) Reference voltage generating circuit

(75) Inventor: Katsuji Kimura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/907,621

(22) Filed: Oct. 15, 2007

(30) Foreign Application Priority Data
Oct. 16, 2006 (JP) 2006-281619
May 1, 2007 (JP) 2007-121032

(51) Int. Cl. G05F 3/20

(52) U.S. Cl. 323/315

(57) ABSTRACT

Disclosed is a reference voltage generating circuit including first to third current-to-voltage converter circuits, a control circuit for exercising control so that the terminal voltage of the first current-to-voltage converter circuit is made equal to that of the second current-to-voltage converter circuit, and current mirror circuits for driving the first to third current-to-voltage converter circuits. A preset voltage of the third current-to-voltage converter circuit is used as a reference voltage. The first current-to-voltage converter circuit is composed of a diode. The second current-to-voltage converter circuit includes a plurality of parallel connected diodes, a resistor connected in parallel with the plural parallel connected diodes and a resistor connected in series with the parallel-connected diodes and the resistor. The third current-to-voltage converter circuit is composed of a resistor.

### RELATED APPLICATION

This application is based upon and claims the benefit of the priorities of Japanese patent application No. 2006-281619, filed on Oct. 16, 2006 and Japanese patent application No. 2007-121032, filed on May 1, 2007, the disclosure of which is incorporated herein in its entirety by reference thereto.

### FIELD OF THE INVENTION

This invention relates to a reference voltage generating circuit, more specifically, a reference voltage generating circuit that outputs a controlled voltage as an output voltage or a reference voltage generating circuit that outputs a low voltage. More particularly, this invention relates to a CMOS reference voltage generating circuit that delivers a reference voltage of 1.2 V or less having a small temperature characteristic. The CMOS reference voltage generating circuit is formed on a semiconductor integrated circuit, has a small chip area and may operate from a low voltage.

### BACKGROUND OF THE INVENTION

### [Patent Document 1] JP Patent No. 3586073

[Patent Document 2] U.S. Pat. No. 3,617,859 (Nov. 21, 1971)
[Patent Document 3] U.S. Pat. No. 7,009,374 B2 (Mar. 7, 2006)
[Patent Document 4] U.S. Pat. No. 6,788,041 (Sep. 7, 2004)
[Patent Document 5] U.S. Pat. No. 6,531,857 B2 (Mar. 11, 2003)
[Patent Document 6] U.S. Pat. No. 6,930,538 B2 (Aug. 16, 2005)
[Patent Document 7] U.S. Pat. No. 7,113,025 B2 (Sep. 26, 2006)
[Patent Document 8] U.S. Pat. No. 6,531,857 B2 (Mar. 11, 2003)
[Patent Document 9] U.S. Pat. No. 6,677,808 B1 (Jan. 13, 2004)

### [Patent Document 10] US 2005/0285666 A1 (Dec. 29, 2005)

[Patent Document 11] U.S. Pat. No. 7,005,839 B2 (Feb. 28, 2006)

### [Patent Document 12] US 2005/0194957 A1 (Sep. 8, 2005)

[Patent Document 13] Japanese Patent Kokai Publication No. JP-P2006-209212A
[Non-Patent Document 1] Robert J. Widlar, “New Developments in IC Voltage Regulators, IEEE Journal of Solid-State Circuits, Vol. SC-6, No. 1, pp. 2-7, February 1971

### [Non-Patent Document 2] Paul R. Gray and Robert G. Meyer, Analysis and Design of Analog Integrated Circuits, New York; John Wiley & Sons Inc. 1977

[Non-Patent Document 3] K. E. Kuijk, “A Precision Reference Voltage Source”, IEEE Journal of Solid-State Circuits, Vol. SC-8, No. 3, pp. 222-226, June 1973
[Non-Patent Document 4] A. Paul Brokaw, “A simple Three-Terminal IC Bandgap Reference”, IEEE Journal of Solid-State Circuits, Vol. SC-9, No. 6, pp. 388-393, Dec. 19, 1974

### [Non-Patent Document 5] Robert J. Widlar, “A new breed of linear ICs runs at 1-Volt levels”, pp. 115-119, Electronics/Mach 29, 1979

[Non-Patent Document 6] Eric A. Vittos, “MOS Transistors Operated in the Lateral Bipolar Mode and Their Application in CMOS Technology”, IEEE Journal of Solid-State Circuits, Vol. SC-18, No. 3, pp. 273-279, June 1983
[Non-Patent Document 7] Katsuji KIMURA, “Analog Circuit Design Technology for CMOS-Implementation of Wireless Mobile Terminal”, Triceps Co. Ltd. 1999

### [Non-Patent Document 8] H. Bamba et al., “A CMOS Bandgap Reference Circuit with Sub-I-V Operation”, IEEE Journal of Solid-State Circuits, Vol. 34, No. 5, May 1999

### [Non-Patent Document 9] Lizhong et al., “A 1.0V GHz Range 0.13, m CMOS Frequency Synthesizer”, IEEE CICC 2001, pp. 327-330, May 2001

### [Non-Patent Document 10] H. Neuteboom et al., “A DSP-Based Hearing Instrument IC” IEEE Journal of Solid-State Circuits, Vol. 32, No. 11 pp. 1790-1806, November 1997

### [Non-Patent Document 11] P. Malcovati et al., “Curvature-Compensated BiCMOS Bandgap with 1-V Supply Voltage”, IEEE Journal of Solid-State Circuits, Vol. 36, No. 7, July 2001.

FIG. 1 shows an illustrative constitution of a conventional reference voltage generating circuit which is described in U.S. Pat. No. 3,617,859 (Robert C. Dobkin and Robert J. Widlar, “Electrical Regulator Apparatus Including a Zero Temperature Coefficient Voltage Reference Circuit”, Nov. 2, 1971), filed on Mar. 23, 1970. The head inventor is Robert C. Dobkin.

However, this reference voltage generating circuit was disclosed in a treatise (Robert J. Widlar, “New developments in IC Voltage regulators”, IEEE Journal of Solid-State Circuits, Vol. SC-6 No. 1 pp. 2-7 Feb. 1971) with Robert J. Widlar as a sole author. Later on, the circuit shown in FIG. 2 appeared as “Widlar band-gap reference” in Paul R. Gray and Robert G. Meyer, “Analysis and Design of Analog Integrated Circuits” New York: John Wiley & sons, Inc. 1977.

As from publication of this text of Gray & Meyer, that is, since 1977, this circuit bears the name of R. J. Widlar (second co-inventor), an unintelligible phenomenon.

However, more unintelligible to the experts in the technical field is that, in the circuit analysis of the reference voltage generating circuit in Dobkin et al. (U.S. Pat. No. 3,617,859) or in Widlar (JSSC), it is not VBE1 and ΔVBE, obtained from the first transistor Q1 or the second transistor Q2, but VBE2 of a control transistor Q3 and VBE3 of a second transistor Q2, controlling the circuit, that afford the reference voltage VREF.

Such being the case, it is difficult for experts in the relevant technical field to evaluate the results of the circuit analysis. Hence, unlike the U.S. Pat. No. 3,617,859 by Dobkin et al. or the reference voltage generating circuit by Widlar (JSSC), a transistor Q4 is added for control, in place of a constant current source I, in the circuit of the “Widlar band-gap reference” introduced in the Gray & Meyer's text. The transistor Q3, used so far, is now driven by the constant current source I which has been moved to between the power supply and the base of the transistor Q4, by way of modification.

This has made circuit analysis possible. That is, the operation of the reference voltage generating circuit has been clarified by Gray & Meyer, and the Gray & Meyer's circuit, which is not relevant to Dobkin or to Widlar, has now been named the “Widlar band-gap reference”.

In actuality, the reference voltage generating circuit by the Gray & Meyer's text has been put to use as a resistor is used in place of the constant current source I.

The crucial point in the Gray & Meyer's text is that it has clearly demonstrated the operating principle of the reference voltage generating circuit that a thermal voltage VT proportional to absolute temperature (PTAT voltage), as a voltage having a positive temperature coefficient, and VBE complementarily proportional to absolute temperature (CTAT voltage), are summed together with weights to cancel out the temperature characteristic, as shown in FIG. 3. Simply the voltage at this time happens to be on the order of 1.2V, whilst there has not been implemented a circuit for deriving a band gap voltage (1.205V) at 0° Kelvin.

Hence, the present inventor is not fully satisfied with the nomination ‘Widlar band-gap reference’ by Gray & Meyer, as to “Widlar” or “band-gap”, and feels that the circuit may as well be nominated ‘voltage reference’.

Subsequently, in 1972, a reference voltage generating circuit (FIG. 4), employing a diode and an OP amp, was disclosed by Kujik (K. E. Kujik, “A Precision Reference Voltage Source”, IEEE Journal of Solid-State Circuits, Vol. SC-8, No. 3, pp. 222-226, June 1973).

In the Gray & Meyer's text, this circuit is stated as an “improved band-gap reference” (improved band-gap reference voltage generating circuit).

At present, the technology has shifted from bipolar to CMOS. Since bipolar transistors are difficult to fabricate on an LSI, a parasitic bipolar transistor formed is used as a diode.

Hence, the control transistor Q3 was replaced by an OP amp only recently. This has enabled the understanding of the reference voltage generating circuit and an intrinsic state has been reached in which the output voltage is determined by two bipolar transistors and two diodes controlled by a control transistor Q3 and an OP amp, both of which have been omitted.

The Gray & Meyer's text appeared later. The circuit shown in the Gray & Meyer's text was possibly modified so that the output voltage would be determined by two bipolar transistors controlled by the control transistor Q3.

In 1974, A. Paul Brokaw disclosed a self-biased reference voltage generating circuit (A. Paul Brokaw, ‘A Simple Three-Terminal IC Bandgap Reference’, IEEE Journal of Solid-State Circuits, Vol. SC-9, No. 6, pp. 388-393, December 1974).

Later on, in the aforementioned reference voltage generating circuit employing a diode and an OP amp, a self-biased circuit has become popular and has come to be used routinely frequently.

However, surprisingly, the emitter area ratio N of the first and second transistors Q1 and Q2 is not used even in the circuit analysis shown in this Brokaw's treatise. However, in U.S. Pat. No. 3,887,863 (Jun. 3, 1975), directed to the contents of this treatise, a mysterious result is reached that, despite the use of the emitter area ratio N of the emitter area of the first transistor Q1 to that of the first transistor Q2, there lacks N in the analytic equation.

Hence, the expression of ΔVBE with the emitter area ratio N of the first and second transistors Q1 and Q2 is not seen in the Gray & Meyer's text nor in the treatise extended in 1979 by Widlar (Robert J. Widlar, “A new breed of linear ICs runs at 1-Volt levels”, pp. 115-119, Electronics/Mar. 29, 1979, but only appears certainly after 1980.

For example, the description appears in 1983 (Eric A. Vittos, “MOS Transistor Operated in the Lateral Bipolar Mode and Their Application in CMOS Technology”, IEEE Journal of Solid-State Circuits, Vol. SC-18, No. 3, pp. 273-279, June 1983).

That is, despite the fact that the reference voltage generating circuit termed a so-called band-gap reference has come to be put to practical use and disclosed in many treatises, circuit analysis has come to be understood only after ten or more years by those having an ordinary knowledge in the relevant field. This would probably be felt by many as astonishing.

The above will account for the above-described unreasonable notion generally accepted in this sort of the reference voltage generating circuit disclosed so far since 1973.

It may be an indefatigable fact that the engineers in the relevant technical field is not that high in their technical level which may be rather low as compared to the technical level of the engineers of the other technical fields. In reality, this sort of the reference voltage generating circuit, currently most known in the technical field, is shown in FIG. 6. The inventor of this circuit (Bamba) is not specialized in this technical field but is an engineer in the field of memories. Ironically, his inventions, mainly treatises, are recited most often and hence Bamba has now been recognized as an authority in this field. Moreover, Bamba was only 26 years old, that is, was not a veteran but only a youngster engineer when an application for the Bamba's reference voltage generating circuit was filed on Jul. 29, 1997.

The reference voltage generating circuit, devised by Bamba, is described in detail in JP Patent Kokai Publication No. JP-A-11-45125 or in JP Patent No. 3586073.

It is quite natural that, in this reference voltage generating circuit, the reference voltage is obtained by current-to-voltage conversion, as in the same sort of the reference voltage generating circuit, devised earlier, in which temperature characteristic have been cancelled. However, in the reference voltage generating circuit, devised earlier, in which temperature characteristic have been cancelled out, the reference current, having a positive temperature characteristic, is converted into a voltage by an output circuit made up of a resistor and a diode or a transistor connected as a diode. That is, a voltage component the voltage drop of which at a resistor has a positive temperature characteristic and a voltage component the forward voltage of which at the diode (or the transistor connected as diode) has a negative temperature characteristic is generated. These voltage components are summed together to generate a reference voltage of the order of 1.2V from which temperature characteristic have been cancelled out.

On the other hand, in the reference voltage generating circuit, devised by Bamba, and which is described in JP Patent Kokai Publication No. JP-A-11-45125, a reference current exhibiting hardly any temperature characteristic is generated and converted into a voltage by an output circuit made up only of a resistor to generate a reference voltage of an optional voltage value.

Hence, the voltage of 1.2V, prescribed as an output voltage of this sort of the conventional reference voltage generating circuit, and from which temperature characteristic have been cancelled out, is generated by conversion into the current value in the circuit, the reference voltage generating circuit may be said to be a high quality product in that it can be run at a power supply voltage not higher than 1.2V.

In a text “Analog Circuit Design Technology for CMOS-Implementation of Wireless Mobile Terminal”, Triceps Co. Ltd. 1999, written by the present inventor, the current was introduced as ‘current mode type reference voltage generating circuit’ with the detailed circuit analysis, in the same year as the year of the provisional publication. In texts issued as from this time, this Bamba's circuit appears almost without exceptions.

In this manner, it has now become well-known that the reference voltage generating circuit is modified into a current mode circuit to generate a voltage not higher than 1.2V such as to lower the power supply voltage. This circuit style (circuit topology) is shown herein in FIG. 7.

The source of the circuit topology, shown in FIG. 7, is not known. On the other hand, the reference voltage generating circuit, shown in FIG. 8, has long been used as a circuit derived from the reference voltage generating circuit employing an OP amp shown in FIG. 4.

By the way, simulated values of the conventional reference voltage generating circuit, shown in FIG. 8, are shown below. If, If, with VDD=1.8V, N, R1 and R2 are set so that N=4, R1=1.08 kΩ and R2=17.8 kΩ, the values of Vref are:

1.38827V at −53° C.,

1.39399V at 0° C.,

1.3946V at 27° C. and

1.3889V at 103° C.

so that an upside-down cup shaped characteristic has been obtained. The width of the temperature variations is 0.455%.

Thus, the circuit topology of the conventional reference voltage generating circuit for producing 1.2V is the same as that of the Bamba's reference voltage generating circuit for producing an optional reference voltage inclusive of the reference voltage not higher than 1.2V shown in FIG. 6. The reference voltage of 1.2V or an optional reference voltage is produced as three current-voltage (I-V) conversion circuits are made to differ from or to be the same as one another. It may be worthwhile to point this out here since it may give a hint in newly devising the same sort of the reference voltage generating circuit.

The circuit operation is now described in accordance with the contents described in JP Patent Kokai Publication No. JP-A-11-45125. It should be noted however that the startup circuit is omitted, that is, is not described.

In FIG. 6, the common gate voltage of transistors P1 and P2 is controlled by an op amp DA1 so that VA=VB.

Hence,

VA=VB (1)

and

I1=I2 (2)

The current I1 is divided into a current I1A flowing through a diode D1 and a current I1B flowing through a resistor R4. Similarly, the current I2 is divided into a current I2A flowing through a series connected resistor R1 and parallel-connected N diodes D2 and a current I2B flowing through a resistor R2.

If R2=R4 (3)

then

I1A=I2A (4)

and

I1B=I2B (5)

Also, VA and VB may be set so that

VA=VF1 (6)

and

VB=VF2+ΔVF (7)

so that

ΔVF=VF1−VF2 (8)

With the voltage drop at R1 equal to ΔVF, we have

I2A=ΔVF/R1 (9)

and

I1B=I2B=VF1/R2 (10)

Here,

ΔVF=V_{T} ln(N) (11)

where V_{T} is thermal voltage and expressed as

V_{T}=kT/q (12)

where T is the absolute temperature [K], k is a Bolzmann's constant and q is a unit electronic charge.

Hence, I3 (=I2) is converted by a resistor R3 into a voltage such that

$$\begin{matrix}Vref = R 3 I 3 \\ = R 3 \{ VF 1 / R 2 + ( {V}_{T} ln ( N ) ) / R 1 \} \\ = ( R 3 / R 2 ) \{ VF 1 + ( R 2 / R 1 ) ( {V}_{T} ln ( N ) ) \}\end{matrix} \qquad ( 13 )$$

{VF1+(R2/R1)(V_{T} ln(N))} is a voltage value of the order of 1.2V with the temperature characteristic cancelled out. Specifically, VF1 has a negative temperature characteristic of approximately −1.9 mV/° C., while V_{T} has a positive temperature characteristic of 0.853 mV/° C.

In order for the temperature characteristic to be cancelled out, the value of (R2/R1)ln(N) is 22.27.

Also, since V_{T} is 26 mV at ambient temperature, (R2/R1) V_{T} ln(N) is approximately 579 mV at ambient temperature.

Hence, if VF1 is 626 mV at ambient temperature, {VF1+(R2/R1)(V_{T} ln(N))} is approximately 1.205V.

The temperature characteristic is now discussed in some detail. Since a resistor R4 is connected in parallel with a diode D1, the current flowing through the resistor R4 tends to be reduced because of the non-linear temperature characteristic of the diode at lower temperatures. On the other hand, since a resistor R1 is connected in series with a diode D2, the voltage across the diode D2 and the resistor R1 becomes lower than that at the diode D1, in case the current flowing through the diode D2 has a positive temperature characteristic. Since the two voltages are controlled to be equal to each other, the two voltages tend to become equal to each other with increasing current at lower temperatures. The two voltages undergo transitions in the opposite direction at elevated temperatures.

That is, in the present circuit, the currents flowing through the diodes D1, D2 are set to temperature characteristic smaller than those prescribed by (V_{T} ln(N))/R1. The currents flowing through the resistors R2, R4 (VF1/R2, VF1/R4) are slightly increased at lower temperatures.

The driving currents, supplied from the transistors P1, P2 and P3 act for canceling out the non-linearity of temperature characteristic of the forward voltage of diodes, the temperature characteristic of the resulting reference voltage may be set to the characteristic close to a straight line suffering only small variations against temperature.

On the other hand, since the resistance ratio (R3/R2) has no temperature characteristic, the output reference voltage Vref has temperature characteristic cancelled out.

It is noted that the resistor (R3/R2) may be set to an optional value. If setting is 1<(R3/R2), Vref becomes higher than 1.2V, whereas, if setting is 1>(R3/R2), Vref is lower than 1.205V.

The values of simulation result are shown below. If, with VDD=1.2V, N, R1, R2, R3 and R4 are set so that N=100, R1=309.4 kΩ, R2=R4=2063 kΩ and R3=844 kΩ, the values of Vref are:

595.12 mV at −53° C.,

596.18 mV at 0° C.,

596.32 mV at 27° C. and

595.04 mV at 103° C.

so that upside-down cup shaped characteristic has been obtained. The width of the temperature variations is suppressed to a lower value of 0.22%. The number of the parallel-connected diodes does not affect the width of the temperature variations.

Meanwhile, if, with VDD=1.2V, N, R1, R2, R3 and R4 are set so that N=100, R1=0.5178 kΩ, R2=R4=19 kΩ and R3=5 kΩ, the values of Vref are:

367.858 mV at −53° C.,

368.55 mV at 0° C.,

368.645 mV at 27° C. and

367.847 mV at 103° C.

so that upside-down cup shaped characteristic has been obtained. The width of the temperature variations is suppressed to a lower value of 0.217%.

This circuit by Bamba is nominated ‘current mode reference voltage generating circuit’ by the present inventor, as described above. The circuit shown in FIG. 9, which has afforded hint to introduction of the present circuit, was disclosed subsequently (Lizhong et al., “A 1.0V GHz Range 0.13 μm CMOS Frequency Synthesizer”, IEEE CICC 2001, pp. 327-330, May 2001). Since the inventor of this circuit is not an engineer specialized in this technical field, he was possibly not informed of this circuit. However, it would occur readily to an engineer specialized in this technical field that the two OP amps may be formed into a sole OP amp. That is, in this circuit, the second OP amp (A2) may be deleted if the resistor R2 is connected in parallel with the resistor R1, connected in series with the transistor Q2, and also in parallel with the transistor Q2.

FIG. 2 of the Bamba's specification shows the process for introduction to the ‘current mode reference voltage generating circuit’ shown in FIG. 5 herein. This FIG. 2 is coincident with FIG. 9. This process is equivalent to claim 1 of Bamba's Patent No. 3586073, shown in FIG. 1 herein. A similar circuit is shown in e.g. in Chatal's U.S. Pat. No. 6,930,538 B2.

A specified value 10 for N is shown in JP Patent Kokai Publication No. JP-A-11-45125. However, when the circuit was actually implemented (IEEE Symposium on VLSI Circuits 1998 May), N was set to 100 (N=100).

In the CMOS process, the MOS transistor has been reduced in size in keeping with device miniaturization. On the other hand, the size of a diode, converted from a parasitic bipolar device, is significantly larger than that of the MOS transistor.

Moreover, since the ratio of the sizes of the diodes D1 and D2 is made higher by one or two orders of magnitude, the size of the diodes on the chip would be considerable.

FIG. 6 of the JP Patent Kokai Publication No. JP-A-11-45125 shows a circuit, shown herein in FIG. 10, configured to lower the input voltage to an OP amp by voltage division by parallel-connected resistors.

This circuit, appearing often in treatises, originates from Bamba. That is, the circuit is stated in claim 4 of Bamba's Patent 3586073, shown herein in FIG. 7.

That is, in the Bamba's JP Patent Kokai Publication No. JP-A-11-45125, description has been made to permit the process of the invention to be traced definitely, thus in a manner distinct from that by engineers specialized in this technical field.

Hence, those specialized in the relevant technical field may learn how the ‘current-mode reference voltage generating circuit’ has been devised.

This also may account for the fact that the circuit has not been implemented by those specialized in the relevant technical field. That is, the honest process may be traced through step-by-step analysis of the circuit operation to arrive at an improved circuit. Those specialized in the relevant technical field may skip over the steps of the process to arrive at a conclusion.

It is also possible to implement a reference voltage generating circuit, shown herein in FIG. 11, in which the two parallel-connected resistors of this Bamba's reference voltage generating circuit is changed to T-resistors (resistors R2 to R4) (Neaves, U.S. Pat. No. 7,009,374 B2 (Mar. 7, 2006).

Simulated values of the reference voltage generating circuit of FIG. 11 are shown below. If, with VDD=1.3V, N, R1, R2, R3, R4 and R5 are set so that N=2, R1=0.519 kΩ and R2=R3=R4=6.34 kΩ, and R5=5 kΩ, the values of Vref are:

367.32 mV at −53° C.,

368.04 mV at 0° C.,

368.153 mV at 27° C. and

367.425 mV at 107° C.

so that upside-down cup shaped characteristic has been obtained. The width of the temperature variations is suppressed to a lower value of 0.23%.

In this type of the current mode reference voltage generating circuit, a reference voltage lower than 1.205V is obtained. There are four methods, or five methods if the current mode circuit is also included. These are:

(A) a method of generating a current having a positive temperature characteristic or an IPTAT current (Current Proportional to Absolute Temperature) and further connecting a resistor in parallel with a series connection of a resistor and a transistor connected as a diode to lower the reference voltage (H. Neuteboom et al. “A DSP-Based Hearing Instrument IC”, IEEE Journal of Solid-State Circuits, Vol. 32 No. 11, pp. 1790-1806, November 1997), herein shown in FIG. 12;
(B) a method of causing two IPTAT currents, having a positive temperature characteristic, to flow through a transistor connected as diode and through a resistor to cross-link the two by a resistor (U.S. Pat. No. 6,788,041; Sep. 7, 2004);
(C) a method of U.S. Pat. No. 6,531,857 B2 (Mar. 11, 2003) by Peicheng, shown herein in FIG. 13, a method of Washburn's U.S. Pat. No. 7,113,025 B2 (Sep. 26, 2006), shown herein in FIG. 14, where a diode of an output circuit is also used as a diode of a control circuit being compared, or a method shown herein in FIG. 15 in which the forward voltage of the diode is divided to lower the VCTAT current having a negative temperature characteristic and to cause the IPTAT current having a positive temperature characteristic to flow into a voltage-dividing resistor to cancel out the temperature characteristic; and
(D) a method of subtracting the current having a negative temperature characteristic (ICTAT current) from the current having a positive temperature characteristic (IPTAT current) (IPTAT-ICTAT) to increase the positive temperature characteristic to decrease the VPTAT voltage, shown herein in FIG. 16. However, these methods are not as yet well-known by the engineers in this technical field.

It should be noted in connection with the Peicheng's circuit of (C) above that, in substituting FIG. 2 for a hand-written drawing at the filing time, the drawing of the related art was copied and the so copied drawing was lodged, so that an unneeded resistor was not erased but left in FIG. 2.

Of these, the reference voltage generating circuit shown herein in FIG. 12 was proposed at an earliest date, and is such a circuit that enables generation of a reference voltage not higher than 1.2V. However, mysteriously, this circuit was not known until only recently.

This circuit was known only in 2003 as the present inventor referred to this technique as the related art in U.S. Pat. No. 6,528,979 B2 (Mar. 4, 2003) or in JP Patent 3638530.

The reference voltage generating circuit, shown in FIG. 12, was stated in only one page in a long 17-page treatise of a technical field other than this technical field (H. Neuteboom B. M. J. Kup and M. Janssens, “A DSP-Based Hearing Instrument IC”, IEEE J. Solid-State Circuits, Vol. 32, No. 11, pp. 1790-1806, Nov. 1997). This treatise was long neglected because of exchanges in the numbers of resistors entered in the drawings or the numbers of resistors in the equation of the reference voltage, and also because of marked difference in the values of the reference voltages actually obtained on substitution of constants proposed by the writers. Moreover, the circuit was not applied for patent and hence was not referred to as related art.

The circuit of FIG. 12 also has the circuit topology shown in FIG. 7 and is no other than the conventional reference voltage generating circuit shown in FIG. 8 in which an output I-V converter (I-V3) has been changed and a resistor has been added to a resistor+diode.

Hence, the circuit of FIG. 12 and the circuit of FIG. 8, if seen as reference current circuits, are both a PTAT reference current circuit having a positive temperature characteristic. However, this reference voltage generating circuit differs in its character from other reference voltage generating circuits, and hence is in need of circuit analysis.

In FIG. 12, if we let I₁=I₂=I₃

I₁=I₂=I₃=ΔV_{F}/R₁=V_{T} ln(N)/R₁ (14)

Hence,

$${I}_{3} = \frac{{V}_{REF} - {V}_{F 3}}{{R}_{2}} + \frac{{V}_{REF}}{{R}_{3}} = \frac{{V}_{T} ln ( N )}{{R}_{1}} \qquad ( 15 )$$

and hence the resulting reference voltage V_{ref} may be expressed by

$${V}_{ref} = \frac{{R}_{3}}{{R}_{2} + {R}_{3}} ( {V}_{F 3} + {R}_{2} {I}_{3} ) = \frac{{R}_{3}}{{R}_{2} + {R}_{3}} \{ {V}_{F 3} + \frac{{R}_{2}}{{R}_{1}} {V}_{T} ln ( N ) \} \qquad ( 16 )$$

Since {V_{F3}+(R₂/R₁) V_{T} ln(N)} may be set to a voltage of approximately 1.2V, from which temperature characteristic is cancelled out, a reference voltage of 1.2V or less may be obtained with the voltage dividing ratio R₃/(R₂+R₃) (<1).

It should be noted that the reference voltage cannot be set to be V_{F3} or lower. If V_{F3} is 600 mV at ambient temperature, it is approximately 752 mV at −53° C. Hence, the reference voltage value that can be set is 900 mV or higher. That is, the voltage can be lowered to approximately three-fourths (¾) of the reference voltage value.

The values of simulation result are shown below. If, with VDD=1.8V, N, R1, R2 and R3 are set so that N=4, R1=1.19 kΩ, R2=18 kΩ, and R3=36 kΩ, the values of Vref are:

879.82 mV at −53° C.,

886.68 mV at 0° C.,

886.7 mV at 27° C.

879.55 mV at 107° C.

so that upside-down cup shaped characteristic, somewhat smoothed at a high temperature side, has been obtained. The width of the temperature variations is suppressed to a lower value of 0.84%.

Only the circuit analysis of the Bamba's reference voltage generating circuit has been made in some detail, while the circuit analysis of conventional circuits, shown in FIGS. 13 to 16, is omitted. However, if it is understood that the method of canceling out temperature characteristic may be implemented by weighted summation of VPTAT and VCTAT or that of IPTAT and ICTAT, it will be readily understood that the conventional circuit shown in FIGS. 13 to 16 may be obtained by slightly modifying the weighting methods.

Moreover, the method of generating a reference current and driving an output circuit via a current mirror circuit is affected by channel length modulation, and hence the effect of the power supply voltage may present itself, because the output circuit is placed outside the control loop.

Or, the temperature non-linearity of a diode presents itself in the CTAT voltage. Since the PTAT voltage, obtained in the above-described conventional circuits, is superior in temperature linearity, the temperature non-linearity of a diode, unavoidably presents itself with the conventional methods in which the temperature characteristic is cancelled out by the CTAT voltage and the PTAT voltage to generate a reference voltage. The temperature non-linearity may present itself more prominently with the conventional reference voltage generating circuit shown for example in FIG. 6. As a circuit for compensating the temperature non-linearity of a diode, there is a circuit shown herein in FIG. 17. This circuit is applied to the Bamba's reference voltage generating circuit shown herein in FIG. 6.

Although the circuit shown in FIG. 17 is difficult to analyze, the circuit analysis of the original reference voltage generating circuit by Bamba, shown in FIG. 6 herein, has been described above in detail.

In FIG. 17, a diode D3, driven by a current (14) from a common current mirror circuit, is added. Since the current mirror circuit outputs equal currents,

I1=i2=I3=I4 (17)

In the first current-voltage converter circuit, a resistor R1 is connected in parallel with the diode R1. The driving current I1 is divided by the current I1A driving the diode D1 and the current I1B driving the resistor R1 and

I1B=VF1/R1 (18)

where I1B is a current containing a temperature non-linear component of a diode.

Moreover, since a low current IN flows from the diode D3 through resistor R5 to the first current-voltage converter circuit, having the diode D1,

I1B=I1−I1B+IN (19)

In similar manner, the current I4a flowing through the diode D3 is

I4a=I4−2IN=I1−2IN (20)

Here

IN=(VF4−VF1)/R5 (21)

Hence,

$$\begin{matrix}VF 4 - VF 1 = {V}_{T} ln ( I 4 a / I 1 A ) \\ = {V}_{T} ln \{ ( I 1 - 2 IN ) / ( I 1 - I 1 B + I N ) \}\end{matrix} \qquad ( 22 )$$

### In the denominator of within { } of In, −I1B is included.

It is noted that IN<<I1B and VF4−VF1 contains the temperature non-linear component of a diode.

Hence, the non-linear component of a diode is contained in the current IN (={(VF4−VF1)/R5}) flowing through the resistor R5, and flows into the resistor R1 to take care of the temperature non-linear component of a diode, contained in the current I1B flowing in the resistor R1 (=VF1/R).

Hence, the temperature non-linear component of a diode, is scarcely contained in the current I1 (=I3) supplied from the current mirror circuit. That is, the current IN is the current that compensates for the temperature non-linear component of a diode.

Simulated values, obtained by the present inventor, are shown below. If, with VDD=1.3V, N and R0 to R5 are set so that N=24, R0=10.9 kΩ, R1=R2=80 kΩ, R3=35 kΩ, and R4=R5=8.0625 kΩ, the values of Vref are:

515.892 mV at −53° C.,

515.987 mV at 0° C.,

516.063 mV at 27° C.

515.89 mV at 107° C.

so that upside-down cup shaped characteristic, somewhat offset to a high temperature side, has been obtained.

The width of the temperature variations is suppressed to an extremely low value of 0.0382%.

According to SPICE simulation, conducted by the present inventor, when a constant power supply voltage is applied to the Bamba's reference voltage generating circuit, shown in FIG. 6, the characteristic curve is in an upside-down cup shape, within the temperature range of ±80° C. of from −53° C. to 107° C., with the width of the temperature variations of the order of 0.2% to 0.3%. On the other hand, if, with the reference voltage generating circuit of FIG. 17, compensated by the current supplied from the added diode, the constant power supply voltage is applied, the characteristic curve is of a wavy shape to an upside-down cup shape, for the temperature range of ±80° C. of from −53° C. to 107° C., with the width of the temperature variations being less than 0.1%.

Meanwhile, in the reference voltage generating circuit of FIG. 16, temperature non-linearity proper to diodes presents itself most outstandingly, such that, when a constant power supply voltage is applied, an upside-down cup shaped characteristic will appear for the temperature range of ±80° C. of from −53° C. to 107° C., with the width of the temperature variations being 2 to 3%.

As the reference voltage generating circuit, with the circuit topology of FIG. 7, generating a reference voltage not higher than 1.2V, the following three circuits are now described. These are

a reference voltage generating circuit by Wada, shown herein in FIG. 18 (M. Wada, “Reference Power Supply Circuit for Semiconductor Device”, U.S. Pat. No. 7,005,839 B2 (Feb. 28, 2006);

a reference voltage generating circuit by Brokaw, shown herein in FIG. 19 (A. P. Brokaw, “Curvature Corrected Bandgap Reference Circuit and Method” Pub. No. US 2005/0194957 A1 (Sep. 8, 2005)); and

a reference voltage generating circuit by Kimura, shown herein in FIG. 20 (“Reference Voltage Generating Circuit”, JP Patent Kokai Publication No. JP-P2006-209212A (2006.08.10).

The reference voltage generating circuit, shown in FIG. 18, is described in JP Patent Kokai Publication No. JP-P2005-173905A, which is already registered in US (U.S. Pat. No. 7,005,839 B2 (Feb. 28, 2006)). The same circuit is also seen in JP Patent Kokai Publication No. JP-P2006-133916A (FIG. 2) by the present inventor. The reference voltage generating circuit of FIG. 18 is a low voltage reference voltage generating circuit having an outstanding diode non-linear characteristic. This circuit is again filed for patent with the inventor being an engineer of the field of memories and, in terms of circuit characteristics, is apparently a combination of the reference voltage generating circuit of FIG. 8 and the Bamba's reference voltage generating circuit, shown herein in FIG. 6. Stated briefly, the circuit is the current to voltage converter circuit (I-V1) of the Bamba's reference voltage generating circuit less a parallel-connected resistor.

In FIG. 18, since the OP amp exercises control so that VA=VB,

V_{A}=V_{F1}=V_{B} (24)

It is assumed that the current mirror ratio is equal and that output currents I1 to I3 are all equal to one another. The current I1 directly flows through a diode D1 constituting a first current-to-voltage converter circuit (I-V1) so as to be converted into voltage. Turning to the second current-to-voltage conversion circuit (I-V2), the current I2 is divided into a current flowing through resistor R1 into diodes D22 and a current flowing through resistor R2.

Hence,

$$\begin{matrix}{I}_{1} = {I}_{2} \\ = {I}_{3} \\ = ( {V}_{F 1} - {V}_{F 2} ) / {R}_{1} + {V}_{F 1} / {R}_{2} \\ = \{ ( {V}_{F 1} + ( {R}_{2} / {R}_{1} ) Δ {V}_{F} ) / {R}_{2}\end{matrix} \qquad ( 25 )$$

V_{F1} has a temperature characteristic of approximately −1.9 mV/° C., whereas V_{F2} also has a temperature characteristic of approximately −1.9 mV/° C.

If D1 is a unit diode and D2 is N times the unit diode,

ΔV_{F}=V_{T} ln [N{I₁/(I₂−V_{F1}R₂)}] (26)

Hence, we have

V_{REF}=R₃I₃=(R₃/R₂){V_{F1}+(R₂/R₁)ΔV_{F}} (27)

Since I₁=I₂,

### I₁>(I₂−V_{F1}R₂)>1

### I₁/(I₂−V_{F1}R₂)>1

holds.

It will be understood that the term ln of the equation (26) is always positive (>0). That is, ΔV_{F} again has a positive temperature characteristic, in this circuit, in a well-known manner.

Hence, the temperature characteristic is approximately proportional to the thermal voltage V_{T} having temperature characteristic of 0.0853 mV/° C. That is, the temperature characteristic of the term of {V_{F1}+(R2/R1)ΔV_{F}} of the equation (27) can be substantially cancelled out by summing V_{F1} having a negative temperature characteristic and ΔV_{F} having a positive temperature characteristic by setting the resistance ratio (R₂/R₁) and by carrying out the weighted summation.

More specifically, V_{F1} has a negative temperature characteristic of approximately −1.9 mV/° C., such that the current V_{F1}/R₂ has a negative temperature characteristic.

Hence, N{I₁/(I₂−V_{F1}/R₂)} has a negative temperature characteristic, whereas its log value, that is, ln [N{I₁/(I₂−V_{F1}R₂)}] has slightly negative temperature characteristic.

That is, in the equation (16), the term of V_{F1} has a negative temperature characteristic, whereas the term of ΔV_{F} has a positive temperature characteristic. The term of ΔV_{F} is expressed by the product of V_{T} having a positive temperature characteristic and ln [N{I₁/(I₂−V_{F1}R₂)}] having a negative temperature characteristic.

Noteworthy here is the current term (V_{F1}R₂). In this term, the non-linear temperature characteristic of V_{F} appearing in the term of V_{F1} having a negative temperature characteristic and the non-linear temperature characteristic of the term of V_{F1} having a positive temperature characteristic appear superposed together.

Hence, non-linear temperature characteristic of V_{F} appear more pronouncedly in the output voltage V_{REF} of this reference voltage generating circuit than in the Bamba's circuit described above in detail. Moreover, the effect can be variably set by the resistor R2.

Simulated values, obtained by the present inventor, are shown below. If, with VDD=1.3V, N and R1 to R3 are set so that N=2, R1=0.452 kΩ, R 2=19 kΩ and R3=5 kΩ, the values of Vref are:

527.06 mV at −53° C.,

532.72 mV at 0° C.,

533.48 mV at 27° C.

527 mV at 107° C.

so that upside-down cup shaped characteristic has been obtained. The width of the temperature variations is large and amounts to 1.22%.

The reference voltage generating circuit, shown in FIG. 19, is a circuit applied for and provisionally published as US patent. This reference voltage generating circuit is the current-to-voltage conversion circuit (I-V2) of the reference voltage generating circuit of FIG. 18 in which is inserted a series resistor R3. This reference voltage generating circuit allows for circuit analysis.

In FIG. 19, the OP amp exercises control to VA=VB, so that VA=VB=V_{F1} and

$${I}_{2} = \frac{{V}_{F 1} - {V}_{1}}{{R}_{1}} = \frac{{V}_{1} - {V}_{F 2}}{{R}_{2}} + \frac{{V}_{1}}{{R}_{3}} \qquad ( 28 )$$

From the equation (28), V1 is

$${V}_{1} = \frac{{R}_{2} {R}_{3} {V}_{F 1} + {R}_{3} {R}_{1} {V}_{F 2}}{{R}_{1} {R}_{2} + {R}_{2} {R}_{3} + {R}_{3} {R}_{1}} \qquad ( 29 )$$

and the equation (28) may be found from

$$\begin{matrix}{I}_{2} = \frac{( {R}_{2} + {R}_{3} ) {V}_{F 1} - {R}_{3} {V}_{F 2}}{{R}_{1} {R}_{2} + {R}_{2} {R}_{3} + {R}_{3} {R}_{1}} \\ = \frac{{R}_{2} {V}_{F 1} + {R}_{3} Δ {V}_{F}}{{R}_{1} {R}_{2} + {R}_{2} {R}_{3} + {R}_{3} {R}_{1}} \\ = \frac{{R}_{2}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} )\end{matrix} \qquad ( 30 )$$

Since the current I2A flowing through the diode D2 is

$${I}_{2 A} = \frac{{V}_{1} - {V}_{F 2}}{{R}_{2}} = \frac{{R}_{3} Δ {V}_{F} - {R}_{1} {V}_{F 2}}{{R}_{1} {R}_{2} + {R}_{2} {R}_{3} + {R}_{3} {R}_{1}} \qquad ( 31 )$$

we have

$$Δ {V}_{F} = V - {V}_{F 2} = {V}_{T} ln ( \frac{{NI}_{1}}{{I}_{2 A}} ) = {V}_{T} ln \{ \frac{N ( 1 + \frac{{R}_{2}}{{R}_{3}} \frac{{V}_{F 1}}{Δ {V}_{F}} )}{1 - \frac{{R}_{1}}{{R}_{3}} \frac{{V}_{F 2}}{Δ {V}_{F}}} \} \qquad ( 32 )$$

Since R1 and R2<<R3,

ΔV_{F}≈V_{T} ln(N) (33)

Hence, if I1=I2=I3, the reference voltage obtained may be expressed as

$$\begin{matrix}{V}_{REF} = {R}_{4} {I}_{2} \\ = \frac{{R}_{2} {R}_{4}}{{R}_{1} {R}_{2} + {R}_{2} {R}_{3} + {R}_{3} {R}_{1}} ( {V}_{F 1} + \frac{{R}_{3}}{{R}_{2}} Δ {V}_{F} ) \\ \approx \frac{{R}_{2} {R}_{4}}{{R}_{1} {R}_{2} + {R}_{2} {R}_{3} + {R}_{3} {R}_{1}} \{ {V}_{F 1} + \frac{{R}_{3}}{{R}_{2}} {V}_{T} ln ( N ) \}\end{matrix} \qquad ( 34 )$$

Since {V_{F1}+(R₂/R₁)ΔV_{F}} may be set to approximately 1.2V with the temperature characteristic cancelled out. Hence, the reference voltage not higher than 1.2V may be obtained from the voltage dividing ratio of {R₂R₄/(R₁R₂+R₂R₃+R₃R₁)} (<1).

Simulated values, obtained by the present inventor, are shown below. If, with VDD=1.3V, N and R1 to R3 are set so that N=5, R1=1.8 kΩ, R2=0.502 kΩ, R3=27 kΩ, and R3=10 kΩ, the values of Vref are:

365.434 mV at −53° C.,

364.74 mV at −10° C.,

364.8 mV at 0° C.

365.08 mV at 27° C. and

365.183 mV at 107° C.

so that a wave shaped characteristic has been obtained. The width of the temperature variations is suppressed to 0.193%. This width of temperature variations is lower than 0.3% shown in the Patent Publication.

Clearly, this reference voltage generating circuit compensates temperature non-linearity of a diode.

That is, the function of compensating for the temperature non-linearity of a diode may be implemented by simply adding a sole resistor.

The reference voltage generating circuit, which has similarly achieved the function of compensating for the temperature non-linearity of a diode, is shown in FIG. 20. This circuit was devised by the same inventor as the present inventor and described in FIG. 12 of the JP Patent Kokai Publication No. JP-P2006-209212A (2006.8.10).

FIG. 20 shows a reference voltage generating circuit in which the first current-to-voltage converter circuit (I-V1) and the second current-to-voltage conversion circuit (I-V2) are each changed to a current-to-voltage conversion circuit in which a resistor is connected in parallel with a diode and further a resistor is connected in series with the parallel connection. It is noted that the circuit shown in FIG. 20 is not analytic.

If assumed in FIG. 20 that the current mirror ratio is equal and the output currents I1, I2 and I3 are all equal, we have

I₁=I₂=I₃ (35)

The OP amp controls so that VA=VB, wherein

V_{A}=V_{F1}+R₁I₁ (36)

and

V_{B}=V_{F2}+R₃I₂ (37)

so that

V_{F1}−V_{F2}=ΔV_{F}

=I₁(R₃−R₁) (38)

Hence,

I₁=I₂=I₃=ΔV_{F}/(R₃−R₁) (39)

The reference voltage obtained VREF is given by

V_{REF}=R₅I₃=ΔV_{F}/R₅/(R₃−R₁) (40)

In order for Vref not to have a temperature characteristic, ΔV_{F} must be set so as not to have temperature characteristic.

ΔV_{F} may also be expressed as

$$Δ {V}_{F} = {V}_{T} ln \{ N ( \frac{1 - \frac{{V}_{F 1}}{{I}_{1} {R}_{2}}}{1 - \frac{{V}_{F 2}}{{I}_{1} {R}_{4}}} ) \} \qquad ( 41 )$$

Since V_{T} is proportional to absolute temperature, it is changed at a temperature change of ±76° C. in a range of 224/300˜1˜376/300. The exponential value is 2.10995˜2.71828˜3.501997, with the rate of change being −22.4%˜0%˜+28.8%.

However, the width of temperature change at ±76° C. is 152°, so that, if the rate of change is divided by the width of temperature change, the result is −0.337% at most.

It seems to be possible to have this order of temperature change taken charge of by

{1−V_{F1}/(I₁R₂)}/{1−V_{F2}/(I₁R₄)}.

Simulated values, obtained by the present inventor, are shown below. If, with VDD=1.3V, N and R1 to R5 are set so that N=2, R1=1.2 kΩ, R2=80 kΩ, R3=2.311 kΩ, R4=34 kΩ and R5=20 kΩ, the values of Vref are:

633.13 mV at −53° C.,

632.682 mV at −20° C.,

632.81 mV at 0° C.,

632.948 mV at 27° C.,

633.13 mV at 70° C.

632.799 mV at 107° C.

so that wave-shaped characteristic has been obtained. The width of the temperature variations is suppressed to 0.0714%.

It has been confirmed that the temperature non-linearity of a diode has been compensated in this reference voltage generating circuit as well.

### SUMMARY OF THE DISCLOSURE

The above-described conventional reference voltage generating circuits have the following problems.

The first problem is that the adverse effect of the supply power variations is manifested. This results because the output circuit is arranged outside the control loop.

The second problem is that fluctuations become significant. This results because control is exercised so that the voltage in a circuit where there is a resistor connected in series with a diode will become equal to the voltage in a circuit where there is no such resistor.

The third problem is that, since a broad input voltage range for the OP amp is needed, the circuit is difficult to be operated at a low voltage. This results because the input voltage of the OP amp is varied with the temperature.

It is therefore an object of the present invention to provide a reference voltage generating circuit in which a controlled voltage is made a reference voltage and an output circuit is taken into a control loop to reduce variations.

It is another object of the present invention to provide a reference voltage generating circuit improved in characteristic or performance, for example, a reference voltage generating circuit capable of generating an output voltage not less than or not higher than 1V.

It is yet another object of the present invention to provide a reference voltage generating circuit which is improved in operational accuracy and which may be operated at a low voltage. It is a more specific object of the present invention to provide a reference voltage generating circuit affected to a lesser extent by power supply voltage variations or device-based fluctuations, and which may be operated from a voltage on the order of 1.2V by having the output voltage set to 1V or less.

The invention disclosed in the present application has substantially the following constitution.

According to the present invention, there is provided a reference voltage generating circuit including: control means for exercising control so that a preset mid-point terminal voltage of a first current-to-voltage converter circuit will be equal to a preset mid-point terminal voltage of a second current-to-voltage converter circuit, a third current-to-voltage converter circuit, and a current mirror circuit for supplying the current to the first, second and third current-to-voltage converter circuits. A preset output voltage of the third current-to-voltage converter circuit is used as a reference voltage.

The first and second current-to-voltage converter circuits are each composed of a series connection of a resistor and a diode (or a bipolar transistor connected as diode) and a resistor connected in parallel with the series connection to output the aforementioned mid-point terminal voltage. The third current-to-voltage converter circuit is composed of a series connection of a resistor and a diode (or a bipolar transistor connected as diode).

According to the present invention, a reference voltage generating circuit includes first and second current-to-voltage converter circuits, connected to each other via a resistor, control means for exercising control so that the two terminal voltages will be equal to each other, a third current-to-voltage converter circuit, and a current mirror circuit for supplying the currents to the first, second and third current-to-voltage converter circuits. A preset output voltage of the third current-to-voltage converter circuit is used as a reference voltage.

The first current-to-voltage converter circuit is a diode (or a bipolar transistor connected as diode), whereas the second current-to-voltage conversion circuit is composed of a series connection of a resistor and a diode (or a bipolar transistor connected as diode), and the third current-to-voltage converter circuit is a resistor.

According to the present invention, a reference voltage generating circuit includes first and second current-to-voltage converter circuits, having preset mid-point terminals connected to each other via a resistor, and control means for exercising control so that the voltages at the two mid-point terminals will be equal to each other. The reference voltage generating circuit also includes a third current-to-voltage converter circuit, and a current mirror circuit for supplying the currents to the first, second and third current-to-voltage converter circuits. A preset output voltage of the third current-to-voltage converter circuit is used as a reference voltage.

The first and second current-to-voltage converter circuits are each composed of a series connection of a resistor and a diode (or a bipolar transistor connected as diode), and a resistor connected in parallel with the series connection, to output voltages at the two mid-point terminals, whereas the second current-to-voltage conversion circuit is a resistor.

According to the present invention, a reference voltage generating circuit includes control means for exercising control so that a preset output voltage of a first current-to-voltage converter circuit will be equal to a preset output voltage of a second current-to-voltage converter circuit, a third current-to-voltage converter circuit, a fourth current-to-voltage converter circuit, and a current mirror circuit for supplying the current to the first to fourth current-to-voltage converter circuits. The first and second current-to-voltage converter circuits are connected to the third current-to-voltage converter circuit via resistors. A preset output voltage of the fourth current-to-voltage converter circuit is used as a reference voltage.

The first current-to-voltage converter circuit is composed of a diode (or a bipolar transistor connected as diode), whereas the second current-to-voltage conversion circuit is composed of a series connection of a resistor and a diode (or a bipolar transistor connected as diode) and the third and fourth current-to-voltage converter circuits are each a resistor.

In the present invention, a resistor is connected between a diode (or a bipolar transistor connected as diode), driven by the current from the first current mirror circuit, and the first current-to-voltage converter circuit, whereas another resistor is connected between the diode (or bipolar transistor connected as diode), driven by the current from the first current mirror circuit, and the second current-to-voltage converter circuit.

According to the present invention, a reference voltage generating circuit includes first and second current-to-voltage converter circuits, interconnected via a series resistor. A further resistor is connected to a mid-point junction of the series resistor and grounded. The reference voltage generating circuit further includes control means for exercising control so that the terminal voltages of the first and second current-to-voltage converter circuits will be equal to each other. The reference voltage generating circuit further includes third and fourth current-to-voltage converter circuits, and a current mirror circuit for supplying the currents to the first to fourth current-to-voltage converter circuits. A resistor interconnects the third current-to-voltage converter circuit and the first current-to-voltage converter circuit, whereas a further resistor interconnects the third current-to-voltage converter circuit and the second current-to-voltage converter circuit. A preset output voltage of the fourth current-to-voltage converter circuit is used as a reference voltage.

The first and third current-to-voltage converter circuits are each a diode (or a bipolar transistor connected as diode). The second current-to-voltage conversion circuit is composed of a series connection of a resistor and a diode (or a bipolar transistor connected as diode), and the fourth current-to-voltage converter circuit is a resistor.

According to the present invention, a reference voltage generating circuit includes first control means for exercising control so that the two terminal voltages of the first and second current-to-voltage converter circuits will be equal to each other, and third and fourth current-to-voltage converter circuits. The reference voltage generating circuit also includes a first current mirror circuit for supplying the currents to the first to fourth current-to-voltage converter circuits, and a second current mirror circuit for supplying the currents via resistors to the first and second current-to-voltage converter circuits. The reference voltage generating circuit further includes second control means for exercising control so that a preset output voltage of the fourth current-to-voltage converter circuit will be equal to the terminal voltage of one of the two resistors. A preset output voltage of the third current-to-voltage converter circuit is used as a reference voltage.

The first current-to-voltage converter circuit is a diode (or a bipolar transistor connected as diode), and the second current-to-voltage conversion circuit is a series connection of a resistor and a diode (or a bipolar transistor connected as diode), third current-to-voltage converter circuit is a resistor, and the fourth current-to-voltage converter circuit is a diode (or a bipolar transistor connected as diode).

According to the present invention, a reference voltage generating circuit includes a diode (or a bipolar transistor connected as diode) driven by the current from the first current mirror circuit, and a second current mirror circuit for supplying the current via a resistor to each of the first and second current-to-voltage converter circuits. The reference voltage generating circuit also includes second control means for exercising control so that a preset output voltage of the diode (or the bipolar transistor connected as diode) will be equal to the terminal voltage of one of the two resistors.

According to the present invention, a reference voltage generating circuit includes first and second current-to-voltage converter circuits, interconnected via a series resistor. A further resistor is connected to a mid-point junction of the series resistor and grounded. The reference voltage generating circuit further includes control means for exercising control so that the terminal voltages of the first and second current-to-voltage converter circuits will be equal to each other, third and fourth current-to-voltage converter circuits, and a first current mirror circuit for supplying the currents to the first to fourth current-to-voltage converter circuits. The reference voltage generating circuit further includes a second current mirror circuit for supplying the currents via resistors to the first and second current-to-voltage converter circuits, and second control means for exercising control so that a preset output voltage of the fourth current-to-voltage converter circuit will be equal to the terminal voltage of one of the two resistors. A preset output voltage of the fourth current-to-voltage converter circuit is used as a reference voltage.

The first and third current-to-voltage converter circuits are each a diode (or a bipolar transistor connected as diode). The second current-to-voltage conversion circuit is composed of a series connection of a resistor and a diode (or a bipolar transistor connected as diode), and the fourth current-to-voltage converter circuit is a resistor.

According to the present invention, a reference voltage generating circuit includes first and second current-to-voltage converter circuits, driven by the constant current, means for dividing the output voltage of the second current-to-voltage conversion circuit, and means for exercising control so that the terminal voltage of the first current-to-voltage converter circuit will be equal to the divided voltage from the second current-to-voltage conversion circuit. A preset voltage of the second current-to-voltage conversion circuit is used as a reference voltage.

The first current-to-voltage converter circuit is a diode (or a bipolar transistor connected as diode), and the second current-to-voltage conversion circuit is a plural number of parallel-connected diodes (or bipolar transistors connected as diodes).

According to the present invention, a reference voltage generating circuit includes first and second current-to-voltage converter circuits, driven by the constant current, means for dividing the output voltage of the second current-to-voltage conversion circuit, and means for exercising control so that the terminal voltage of the first current-to-voltage converter circuit will be equal to the divided voltage from the second current-to-voltage conversion circuit. The reference voltage generating circuit further includes a third current-to-voltage converter circuit and a current mirror circuit for driving the first to third current-to-voltage converter circuits. A preset voltage of the third current-to-voltage converter circuit is used as a reference voltage.

The first current-to-voltage converter circuit is a diode (or a bipolar transistor connected as diode), and the second current-to-voltage conversion circuit is a plural number of parallel-connected diodes. The third current-to-voltage converter circuit is a resistor.

According to the present invention, a reference voltage generating circuit includes control means for exercising control so that a preset terminal voltage of the first current-to-voltage converter circuit will be equal to a preset terminal voltage of the second current-to-voltage conversion circuit. The reference voltage generating circuit also includes a non-linear current mirror circuit driving the first and second current-to-voltage converter circuits, and a linear current mirror circuit for driving the third current-to-voltage converter circuit for generating the current proportional to the current that drives the first current-to-voltage converter circuit or the second current-to-voltage conversion circuit. A preset voltage of the third current-to-voltage converter circuit is used as a reference voltage.

The first current-to-voltage converter circuit is a diode (or a bipolar transistor connected as diode), and the second current-to-voltage conversion circuit is a plural number of parallel-connected diodes (or bipolar transistors connected as diodes) to output the mid-point terminal voltage. The third current-to-voltage converter circuit is a resistor.

According to the present invention, a reference voltage generating circuit includes control means for exercising control so that a preset terminal voltage of the first current-to-voltage converter circuit will be equal to a preset terminal voltage of the second current-to-voltage conversion circuit, and a current mirror circuit for driving the first to third current-to-voltage converter circuits. A preset voltage of the third current-to-voltage converter circuit is used as a reference voltage.

The first current-to-voltage converter circuit is a parallel connection of a diode (or a bipolar transistor connected as diode) and a resistor, and the second current-to-voltage conversion circuit is composed of a series connection of a resistor and a plural number of diodes (or bipolar transistors connected as diodes) and a resistor connected in parallel with the series connection to output the aforementioned mid-point terminal voltage. The third current-to-voltage converter circuit is a resistor.

According to the present invention, a reference voltage generating circuit includes control means for exercising control so that a preset terminal voltage of the first current-to-voltage converter circuit will be equal to a preset terminal voltage of the second current-to-voltage conversion circuit, and a current mirror circuit for driving the first to third current-to-voltage converter circuits. A preset voltage of the third current-to-voltage converter circuit is used as a reference voltage.

The first current-to-voltage converter circuit is a parallel connection of a diode (or a bipolar transistor connected as diode) and a resistor to output the aforementioned mid-point terminal voltage. The second current-to-voltage conversion circuit is composed of a series connection of a resistor and a plural number of diodes (or bipolar transistors connected as diodes) and a resistor connected in parallel with the series connection to output the mid-point terminal voltage. The third current-to-voltage converter circuit includes a resistor.

In the present invention, there are provided a MOS transistor having a drain grounded via a resistor, having a gate grounded directly, and a source driven by a current of a positive temperature characteristic, and means for dividing the drain-to-source voltage of the MOS transistor with the divided voltage being used as a reference voltage.

According to the present invention, a reference voltage generating circuit includes first and second current-to-voltage converter circuits, and means for exercising control so that the terminal voltage of the first current-to-voltage converter circuit will be equal to the terminal voltage of the second current-to-voltage converter circuit. The reference voltage generating circuit also includes a third current-to-voltage converter circuit, and a current mirror circuit for driving the first to third current-to-voltage converter circuits. A preset voltage of the third current-to-voltage converter circuit is used as a reference voltage.

The first current-to-voltage converter circuit is a diode (or a bipolar transistor connected as diode) and the second current-to-voltage conversion circuit is composed of a parallel connection of a plural number of parallel-connected diodes (or bipolar transistors connected as diodes) and a resistor, and a further resistor connected in series with the parallel connection. The third current-to-voltage converter circuit is a resistor.

According to the present invention, a reference voltage generating circuit includes first and second current-to-voltage converter circuits, and means for exercising control so that the terminal voltage of the first current-to-voltage converter circuit will be equal to the terminal voltage of the second current-to-voltage converter circuit. The reference voltage generating circuit also includes a current mirror circuit for driving the first to third current-to-voltage converter circuits. A preset voltage of the third current-to-voltage converter circuit is used as a reference voltage.

The first current-to-voltage converter circuit is composed of a parallel connection of a diode (or a bipolar transistor connected as diode) and a resistor, and the second current-to-voltage conversion circuit is composed of a parallel connection of a plural number of parallel-connected diodes (or bipolar transistors connected as diodes) and a resistor, and a further resistor connected in series with the parallel connection. The third current-to-voltage converter circuit is a resistor.

According to the present invention, a reference voltage generating circuit includes first and second current-to-voltage converter circuits, and means for exercising control so that the terminal voltage of the first current-to-voltage converter circuit will be equal to the terminal voltage of the second current-to-voltage converter circuit. The reference voltage generating circuit also includes a third current-to-voltage converter circuit, and a current mirror circuit for driving the first to third current-to-voltage converter circuits. A preset voltage of the third current-to-voltage converter circuit is used as a reference voltage.

The first current-to-voltage converter circuit is composed of a parallel connection of a diode (or a bipolar transistor connected as diode) and a resistor, another resistor connected in series with the parallel connection, and a further resistor connected in parallel with the series connection of the resistor and the parallel connection. The second current-to-voltage conversion circuit is composed of a parallel connection of a plural number of parallel-connected diodes (or bipolar transistors connected as diodes) and a resistor, another resistor connected in series with the parallel connection, and a further resistor connected in parallel with the series connection of the resistor and the parallel connection. The third current-to-voltage converter circuit is a resistor.

The meritorious effects of the present invention are summarized as follows.

A first meritorious effect of the present invention is that the variations may be minimized. The reason is that, according to the present invention, the output circuit is taken into a control loop and the reference voltage is the controlled voltage.

A second meritorious effect of the present invention is that the adverse effect due to fluctuations may be reduced. The reason is that, in the present invention, the circuit topology of two current-to-voltage converter circuits may be identified with that of the output circuit.

A third meritorious effect of the present invention is that the reference voltage generating circuit may be operated at a low voltage. The reason is that, in the present invention, the output voltage is fixed at a constant voltage value.

Still other features and advantages of the present invention will become readily apparent to those skilled in this art from the following detailed description in conjunction with the accompanying drawings wherein examples of the invention are shown and described, simply by way of illustration of the mode contemplated of carrying out this invention. As will be realized, the invention is capable of other and different examples, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a diagram showing an illustrative conventional circuit.

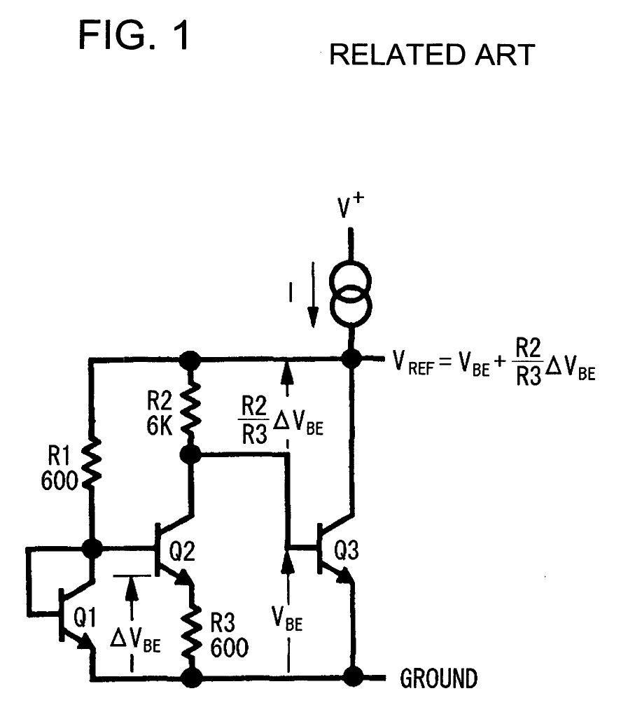

FIG. 2 is a diagram showing an illustrative conventional circuit appearing in literature.

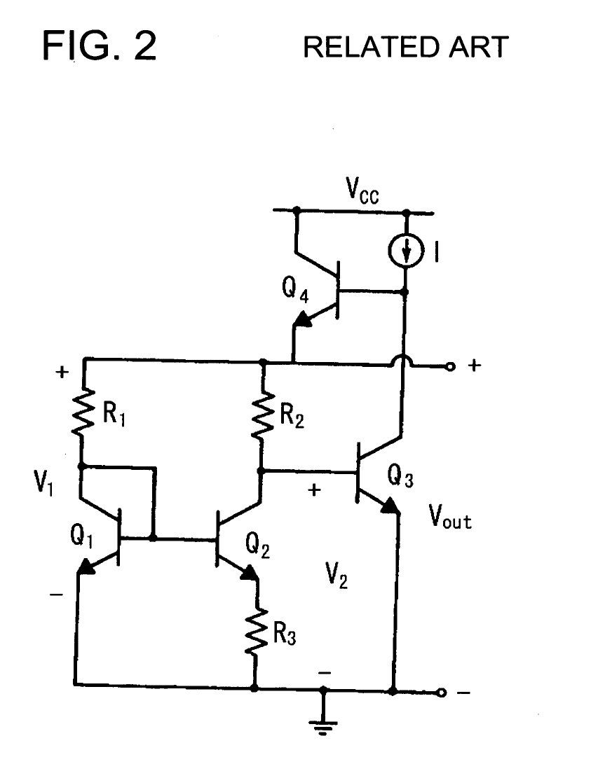

FIG. 3 is a diagram for illustrating the method for canceling out temperature characteristic of a conventional circuit appearing in literature.

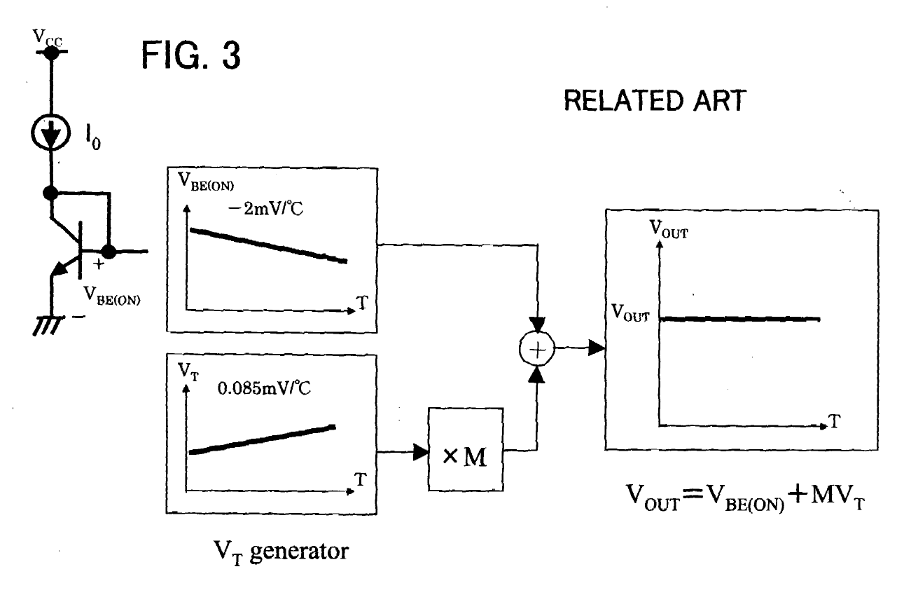

FIG. 4 is a diagram showing an illustrative conventional circuit appearing in literature.

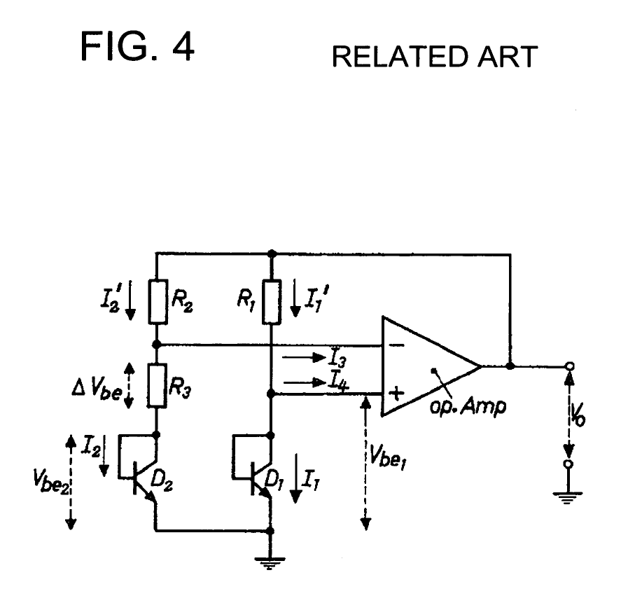

FIG. 5 is a diagram showing an illustrative conventional circuit of a self-bias configuration.

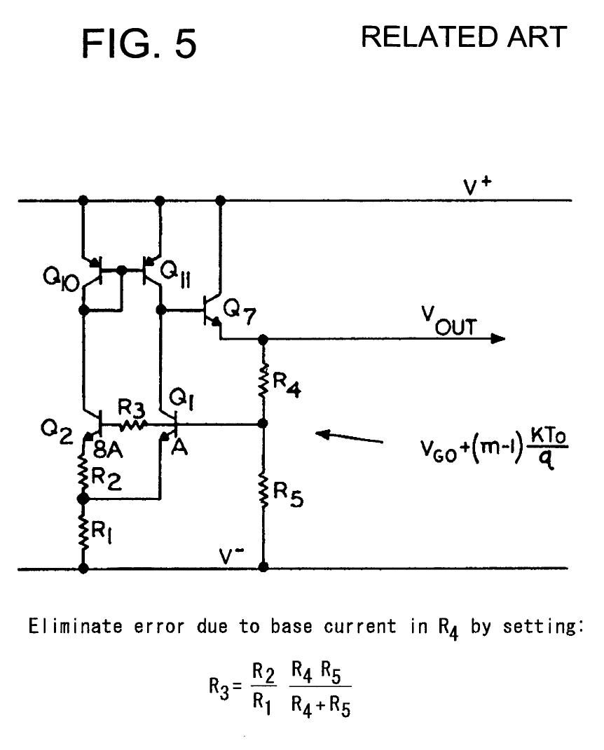

FIG. 6 is a diagram showing an illustrative low-voltage conventional circuit.

FIG. 7 is a block diagram showing an illustrative circuit topology of a reference voltage generating circuit.

FIG. 8 is a diagram showing a well-known illustrative conventional circuit.

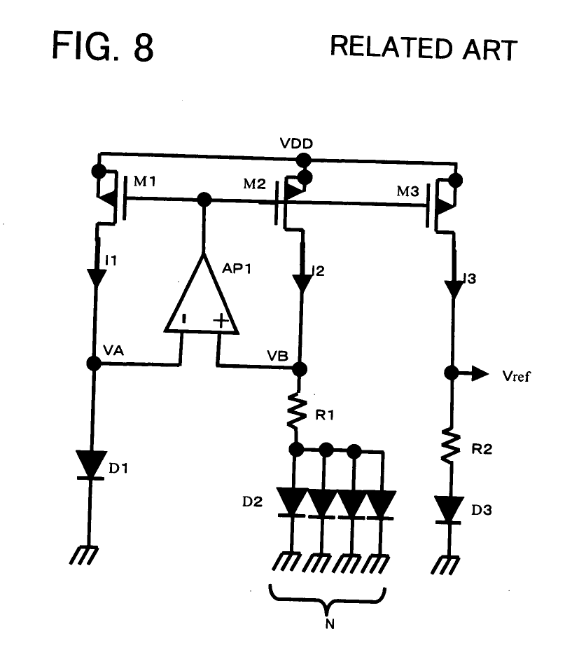

FIG. 9 is a diagram showing an illustrative circuit devised in the course of development of a low-voltage conventional circuit.

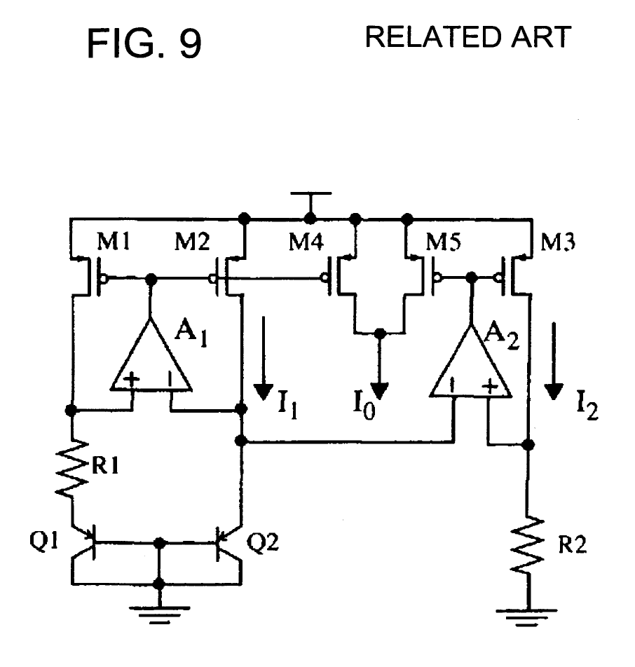

FIG. 10 is a diagram showing a conventional circuit in which a low input voltage is used.

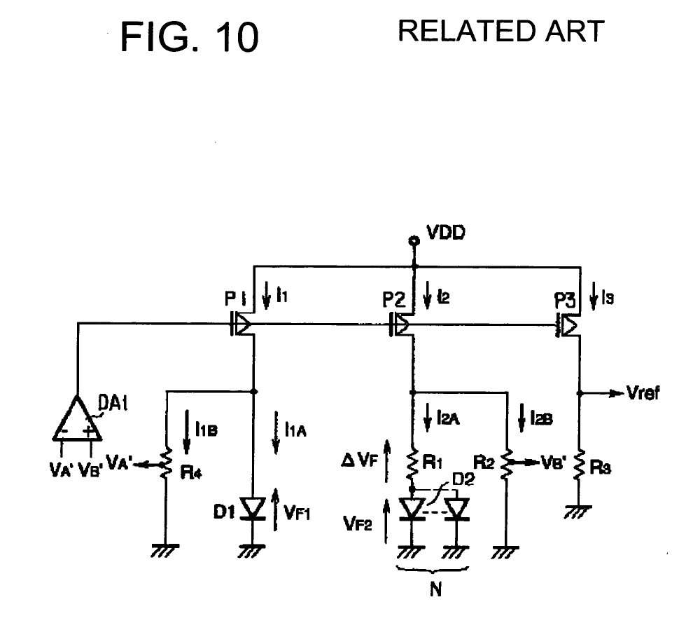

FIG. 11 is a diagram showing a modification of a low-voltage conventional circuit.

FIG. 12 is a diagram showing an illustrative conventional circuit (1) in which an output circuit is configured to achieve a low input voltage.

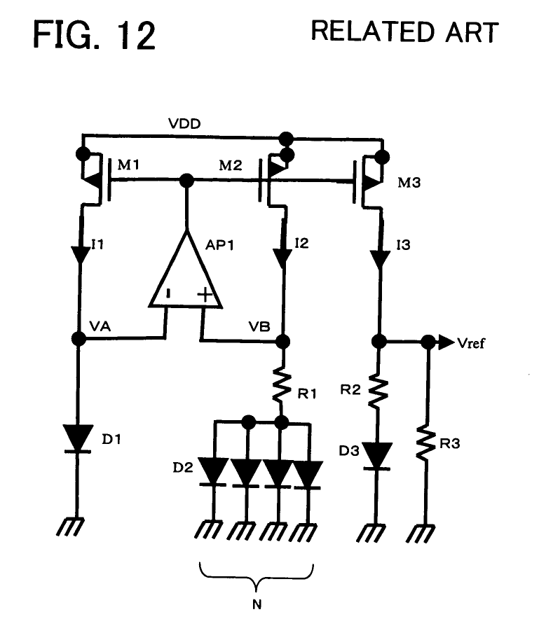

FIG. 13 is a diagram showing an illustrative conventional circuit (2) in which an output circuit is configured to achieve a low input voltage.

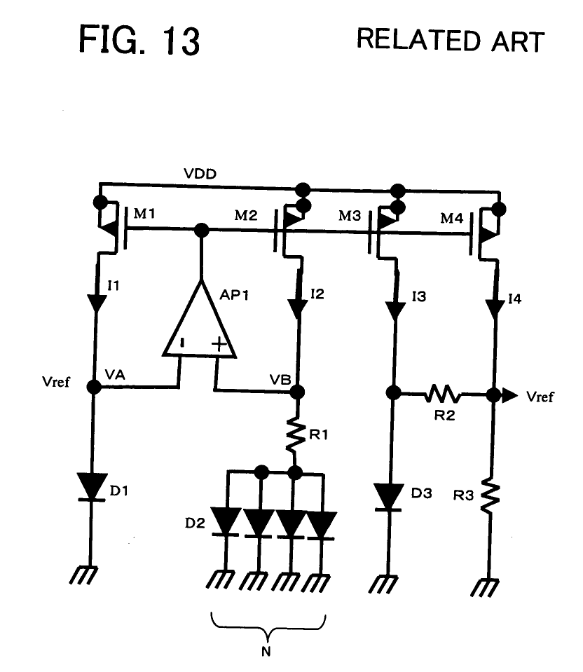

FIG. 14 is a diagram showing a modification of the illustrative conventional circuit (2) in which an output circuit is configured to achieve a low input voltage.

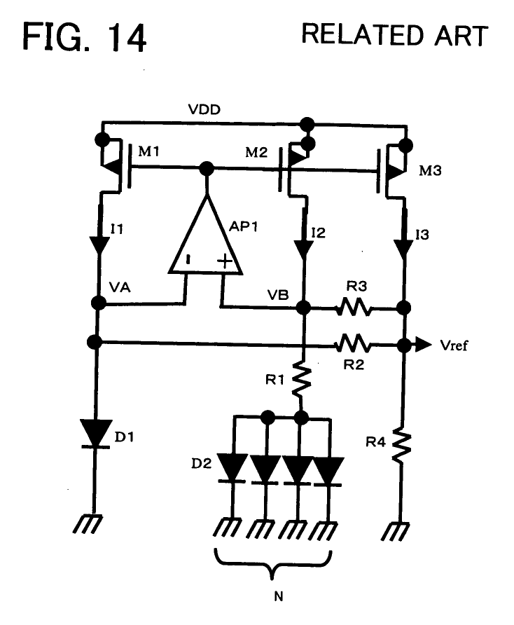

FIG. 15 is a diagram showing a modification of the illustrative conventional circuit (3) in which an output circuit is configured to achieve a low input voltage.

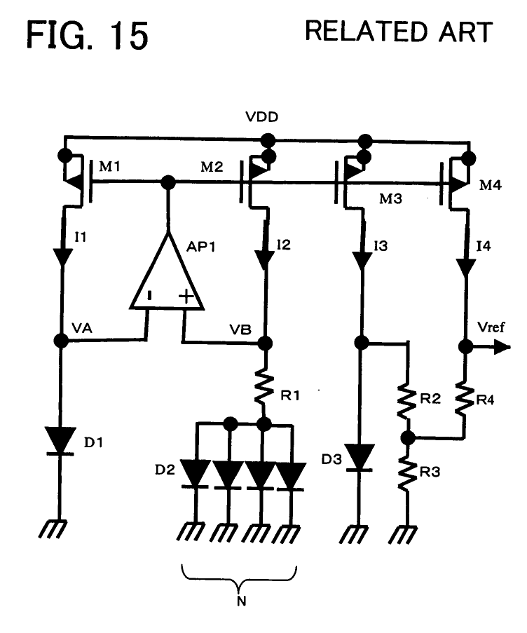

FIG. 16 is a diagram showing another illustrative conventional circuit in which temperature characteristic is increased to achieve a low input voltage.

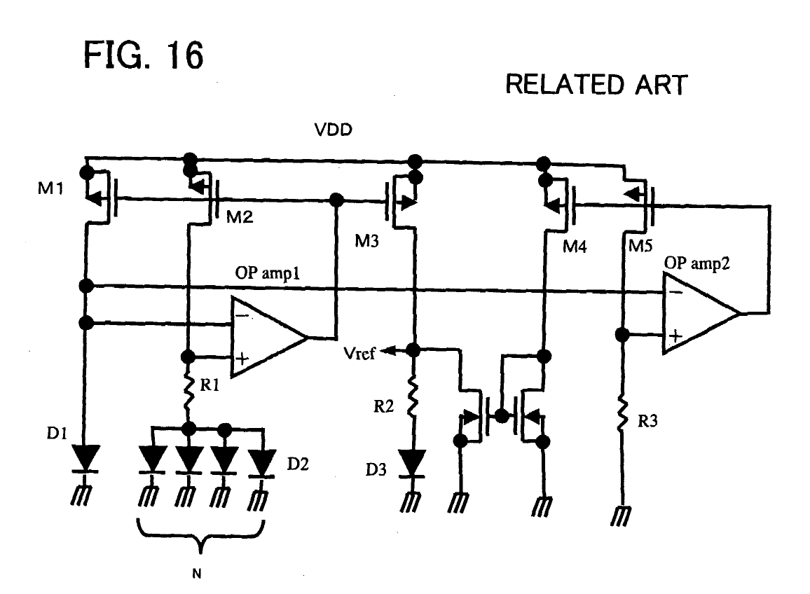

FIG. 17 is a diagram showing an illustrative conventional circuit (1) with improved temperature non-linearity of a diode.

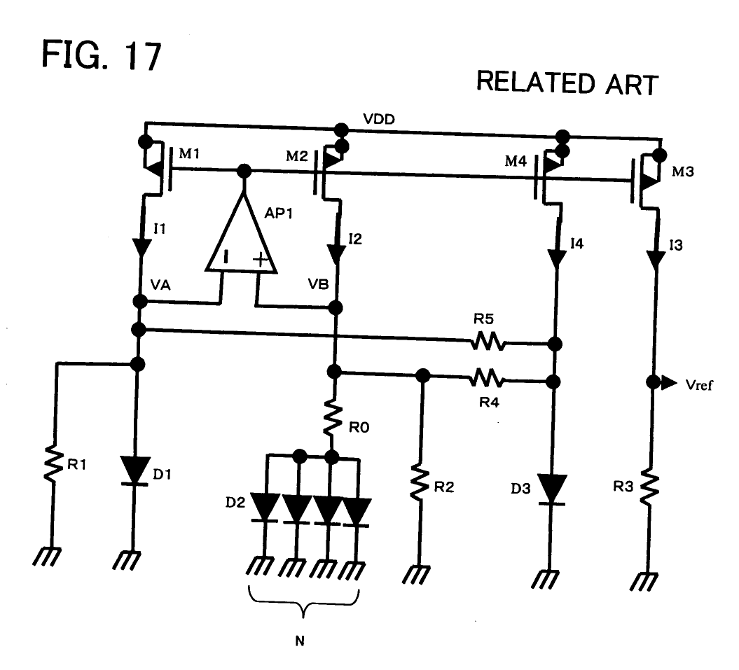

FIG. 18 is a diagram showing an illustrative conventional circuit with apparent temperature non-linearity of a diode.

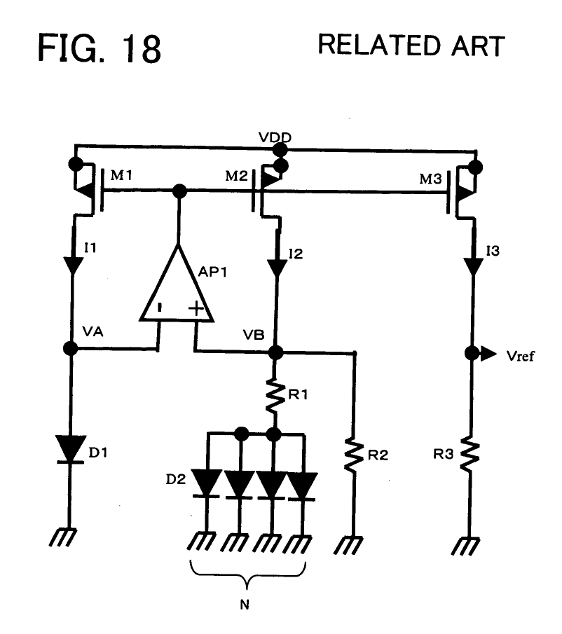

FIG. 19 is a diagram showing an illustrative conventional circuit (2) with compensated temperature non-linearity of a diode.

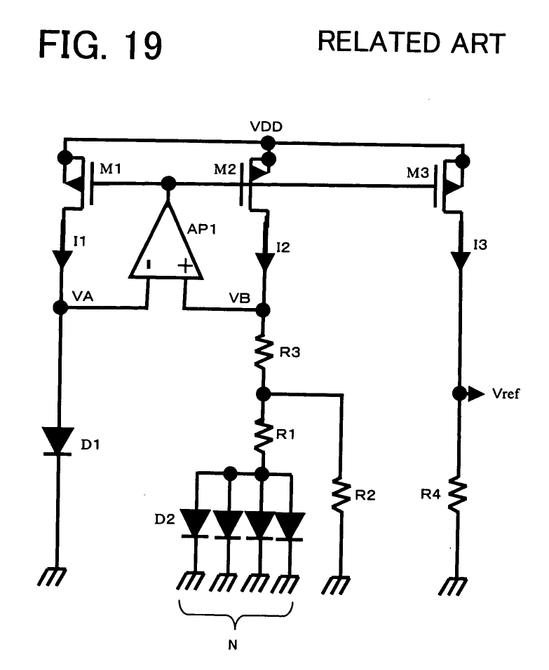

FIG. 20 is a diagram showing an illustrative conventional circuit (3) with compensated temperature non-linearity of a diode.

FIG. 21 is a diagram showing a circuit configuration of an embodiment of the present invention (claim 1).

FIG. 22 is a diagram showing a circuit configuration of an embodiment of the present invention (claim 2).

FIG. 23 is a diagram showing a circuit configuration of an embodiment of the present invention (claim 3).

FIG. 24 is a diagram showing a circuit configuration of an embodiment of the present invention (claim 4).

FIG. 25 is a diagram showing a circuit configuration of an embodiment of the present invention (claim 4).

FIG. 26 is a diagram showing a circuit configuration of an embodiment of the present invention (claim 4).

FIG. 27 is a diagram showing a circuit configuration of an embodiment of the present invention (claim 4).

FIG. 28 is a diagram showing a circuit configuration of an embodiment of the present invention (claim 5).

FIG. 29 is a diagram showing a circuit configuration of an embodiment of the present invention (claim 7).

FIG. 30 is a diagram showing a circuit configuration of an embodiment of the present invention (claim 7)

FIG. 31 is a diagram showing a circuit configuration of an embodiment of the present invention (claim 8).

FIG. 32 is a diagram showing a circuit configuration of an embodiment of the present invention.

FIG. 33 is a diagram showing a circuit configuration of an embodiment of the present invention.

FIG. 34 is a diagram showing a circuit configuration of an embodiment of the present invention.

FIG. 35 is a diagram showing a circuit configuration of an embodiment of the present invention.

FIG. 36 is a diagram showing a circuit configuration of an embodiment of the present invention(claim 9).

FIG. 37 is a diagram showing a circuit configuration of an embodiment of the present invention (claim 10).

FIG. 38 is a diagram showing a circuit configuration of an embodiment of the present invention (claim 11).

FIG. 39 is a diagram showing a circuit configuration of an embodiment of the present invention (claim 12).

FIG. 40 is a diagram showing a circuit configuration of an embodiment of the present invention (claim 13).

FIG. 41 is a diagram showing a circuit configuration of an embodiment of the present invention (claim 14).

FIG. 42 is a diagram showing a circuit configuration of an embodiment of the present invention (claim 15).

FIG. 43 is a diagram showing a circuit configuration of an embodiment of the present invention (claim 16).

FIG. 44 is a diagram showing a circuit configuration of an embodiment of the present invention (claim 17).

FIGS. 45A and 45B are diagrams showing a list of the widths of temperature variations of the conventional and inventive circuits.

FIG. 46 is a diagram showing the circuit configuration of another first embodiment of the present invention (claim 1).

FIG. 47 is a diagram showing the circuit configuration of another second embodiment of the present invention (claim 1).

FIG. 48 is a diagram showing the circuit configuration of another third embodiment of the present invention (claim 1).

FIG. 49 is a diagram showing the circuit configuration of another first embodiment of the present invention (claim 3).

FIG. 50 is a diagram showing the circuit configuration of another second embodiment of the present invention (claim 3).

FIG. 51 is a diagram showing the circuit configuration of another third embodiment of the present invention (claim 3).

FIG. 52 is a diagram showing the circuit configuration of another first embodiment of the present invention (claim 4).

FIG. 53 is a diagram showing the circuit configuration of another second embodiment of the present invention (claim 4).

FIG. 54 is a diagram showing the circuit configuration of another third embodiment of the present invention (claim 4).

FIG. 55 is a diagram showing the circuit configuration of another fourth embodiment of the present invention (claim 4).

FIG. 56 is a diagram showing the circuit configuration of another fifth embodiment of the present invention (claim 4).

FIG. 57 is a diagram showing the circuit configuration of another sixth embodiment of the present invention (claim 4).

FIG. 58 is a diagram showing the circuit configuration of another first embodiment of the present invention (claim 5).

FIG. 59 is a diagram showing the circuit configuration of another second embodiment of the present invention (claim 5).

FIG. 60 is a diagram showing the circuit configuration of another third embodiment of the present invention (claim 5).

FIG. 61 is a diagram showing the circuit configuration of another first embodiment of the present invention (claim 15).

FIG. 62 is a diagram showing the circuit configuration of another second embodiment of the present invention (claim 15).

FIG. 63 is a diagram showing the circuit configuration of another third embodiment of the present invention (claim 15).

FIG. 64 is a diagram showing the circuit configuration of another first embodiment of the present invention (claim 16).

FIG. 65 is a diagram showing the circuit configuration of another second embodiment of the present invention (claim 16).

FIG. 66 is a diagram showing the circuit configuration of another third embodiment of the present invention (claim 16).

FIG. 67 is a diagram showing the circuit configuration of another first embodiment of the present invention (claim 17).

FIG. 68 is a diagram showing the circuit configuration of another second embodiment of the present invention (claim 17).

FIG. 69 is a diagram showing the circuit configuration of another third embodiment of the present invention (claim 17).

FIG. 70 is a diagram showing the circuit configuration of an embodiment of the present invention.

FIG. 71 is a diagram showing the circuit configuration of another embodiment of the present invention.

### PREFERRED MODES OF THE INVENTION

Certain preferred embodiments of the present invention will now be described with reference to the drawings.

### Embodiment

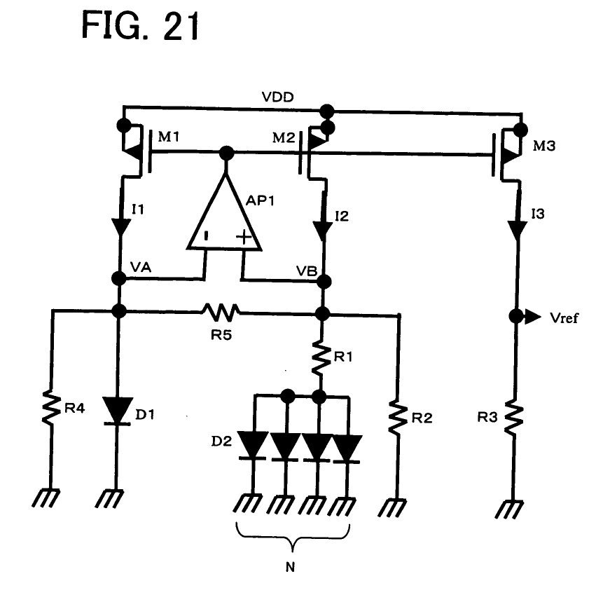

FIG. 21 depicts a diagram showing the circuit configuration of an embodiment of a CMOS reference voltage generating circuit of the present invention (claim 1).

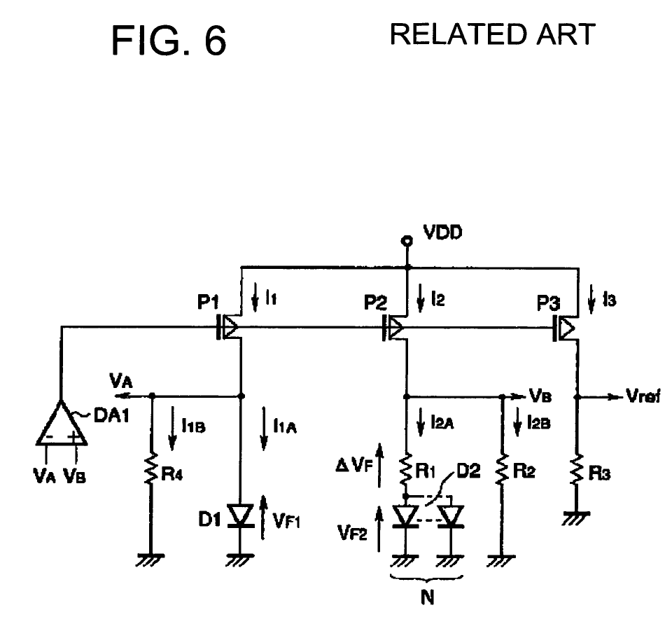

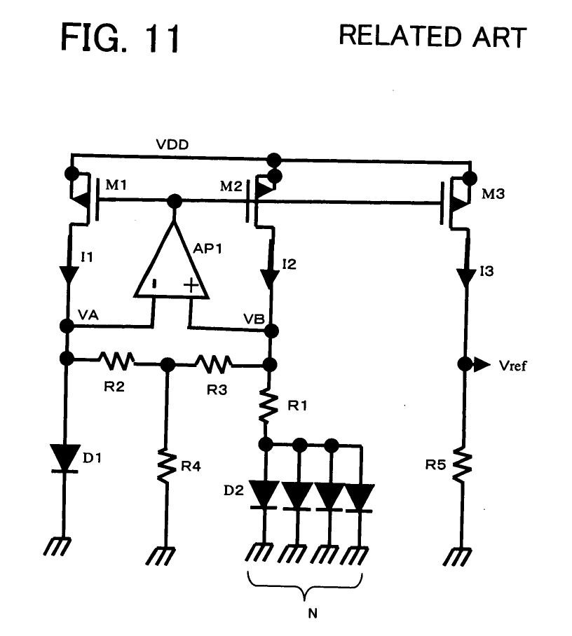

The reference voltage generating circuit, shown in FIG. 6, may be changed to T-resistors shown in FIG. 11. As a matter of course, the reference voltage generating circuit of FIG. 11 in which its T-resistors are changed to a π-resistor is equivalent to the circuit with the T-resistors.

The circuit shown in FIG. 21 is the conventional reference voltage generating circuit of FIG. 11 in which the T-resistors are changed to a π-resistor. The circuit is equivalent to the conventional Bamba's reference voltage generating circuit of FIG. 6, in which a resistor R5 is newly connected between two input terminals of the OP amp (AP1).

The operation of the present embodiment is now described. Referring to FIG. 21, during the stable circuit operation, the OP amp (AP1) exercises control so that VA=VB. Hence, no current flows through the resistor R5, so that the circuit operation remains the same. If VA≠VB at startup, the current flows via resistor R5 from the terminal at a high voltage towards the terminal at a low voltage. Hence, the time until VA=VB, representing the condition for the stable operation, may be expected to be shorter than with the conventional Bamba's reference voltage generating circuit.

The values of simulation result are shown below. If, with VDD=1.3V, N and R1 to R5 are set so that N=4, R1=0.518 kΩ, R2=R3=R4=19 kΩ and R5=5 kΩ, the values of Vref are:

367.82 mV at −53° C.,

368.7 mV at 27° C. and

368.02 mV at 107° C.

so that upside-down cup shaped characteristic has been obtained. The width of the temperature variations is suppressed to a lower value of 0.24%.

### Other Embodiment of the Invention

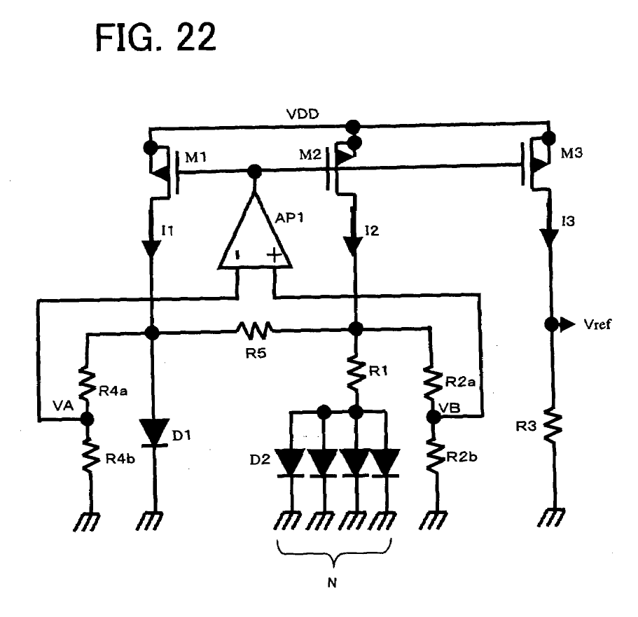

FIG. 22 depicts a diagram showing the circuit configuration of an embodiment of a CMOS reference voltage generating circuit of the present invention (claim 2).

In FIG. 22, two parallel-connected resistors R2, R4 of FIG. 21 are changed to voltage-dividing resistors (R2a, R2b) and (R4a, R4b), respectively, to lower the input voltages to the OP amp (AP1). There is substantially no change in the circuit operation, and hence the reference voltage similar to that of FIG. 21 is obtained.

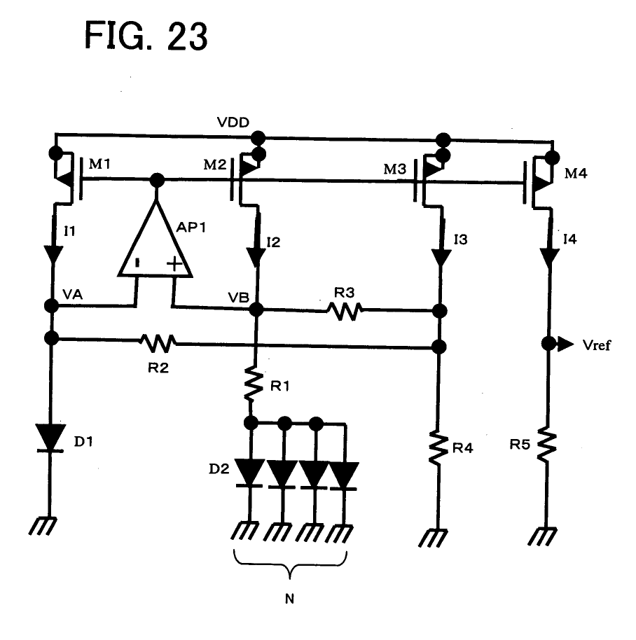

FIG. 23 depicts a diagram showing the circuit configuration of an embodiment of a CMOS reference voltage generating circuit of the present invention (claim 3). A low reference voltage may be obtained by driving the common terminal of the T-resistors of the conventional reference voltage generating circuit of FIG. 11 with the current from the current mirror circuit.

In FIG. 23, transistors M1 to M4 constitute a current mirror circuit. The OP amp (AP1) controls the common gate voltage of the transistors M1 to M4 so that two input terminal voltages of the OP amp will be equal to each other. This determines the currents I1 to I4 flowing through the current mirror circuit.

The first current-to-voltage converter circuit for comparison is composed of a diode (or a bipolar transistor connected as a diode) D1. The second current-to-voltage converter circuit is composed of a series connection of a resistor R1 and diodes (or bipolar transistors connected as diodes) D2. Specifically, the ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The current I3 from the MOS transistor M3 drives a resistor R4, the terminal of which is connected via resistors R2 and R3 to terminals under control of the first and second current-to-voltage converter circuits.

An output circuit is made up of a resistor and is controlled by the current I4 from the MOS transistor M4 to output a reference voltage Vref.

The operation of the present embodiment is now described. Referring to FIG. 23, with the forward voltages VF1 and VF2 of the diodes D1 and D2 (or bipolar transistors connected as diodes), the OP amp (AP1) exercises control so that the voltages at the two input terminals will be equal to each other (VA=VB).

If the output currents from the current mirror circuit (M1 to M4) are equal to one another,

I₁=I₂=I₃=I₄ (162)

With the terminal voltage VC of the resistor R4, the current flows from VA to VC and from VB to VC, via resistors R2 and R3, respectively.

Hence, the current flowing through the resistor R4 is the sum of these currents and may be represented by

VC=R4{I3+(VA−VC)/R2+(VB−VC)/R3} (163)

Also,

VA=VF1 (164)

so that, if R2=R3,

(VA−VC)/R2=(VB−VC)/R3 (165)

The currents flowing through the diodes (or transistors connected as dodes) D1, D2 are equal to each other and

ΔV_{F}=VF1−VF2=V_{T} ln(N) (166)

Also, the following equation holds:

$$\begin{matrix}13 = 12 \\ = ( VF 1 - VF 2 ) / R 1 + ( VF 1 - VC ) / R 2 \\ = Δ VF / R 1 + ( VF 1 - VC ) / R 2\end{matrix} \qquad ( 167 )$$

Hence, the equation (163) is

$${V}_{C} = \frac{{R}_{2} {R}_{4}}{{R}_{2} + 2 {R}_{4}} {I}_{3} + \frac{2 {R}_{4}}{{R}_{2} + 2 {R}_{4}} {V}_{F 1} \qquad ( 168 )$$

so that, by substitution into the equation (146), I3 may be obtained by

$$\begin{matrix}{I}_{3} = {I}_{4} \\ = \frac{1}{{R}_{4}} \frac{{R}_{2} + 3 {R}_{4}}{{R}_{2} + 2 {R}_{4}} ( {V}_{F 1} + \frac{{R}_{2} + 2 {R}_{4}}{{R}_{1}} Δ {V}_{F} ) \\ = \frac{1}{{R}_{4}} \frac{{R}_{2} + 3 {R}_{4}}{{R}_{2} + 2 {R}_{4}} \{ {V}_{F 1} + \frac{{R}_{2} + 2 {R}_{4}}{{R}_{1}} {V}_{T} ln ( N ) \}\end{matrix} \qquad ( 169 )$$

Hence, the reference voltage Vref is

$${V}_{ref} = {R}_{5} {I}_{4} = \frac{{R}_{5}}{{R}_{4}} \frac{{R}_{2} + 3 {R}_{4}}{{R}_{2} + 2 {R}_{4}} \{ {V}_{F 1} + \frac{{R}_{2} + 2 {R}_{4}}{{R}_{1}} {V}_{T} ln ( N ) \} \qquad ( 170 )$$

It is noted that {VF1+(R2+2R4)V_{T} ln(N)/R1} can be set to a voltage value on the order of 1.2V having temperature characteristic cancelled out. Specifically, VF1 has a negative temperature characteristic of approximately −1.9 mV/° C., whereas V_{T} has a positive temperature characteristic of approximately 0.0853 mV/° C. Thus, to cancel out the temperature characteristic, it is sufficient to set the value of (R2+2R4)ln(N)/R1 to 22.27. V_{T} is 26 mV at ambient temperature, so that, at ambient temperature, (R2+2R4)V_{T} ln(N)/R1 is approximately 579 mV. Thus, if VF1 is 626 mV at ambient temperature, {VF1+(R2+2R4)V_{T} ln(N)/R1} is approximately 1.205V.

The reference voltage Vref, thus obtained, is a constant voltage which is divided by resistances and multiplied by (R5/R4){(R2+3R4)/(R2+2R4)} and which may be set to 1.205V or less. That is, the reference voltage Vref is a constant voltage having temperature characteristic cancelled out. Hence, it may be used as reference voltage.

The values of simulation result are shown below. If, with VDD=1.3V, N and R1 to R5 are set so that N=2, R1=0.513 kΩ and R2=R3=R4=6.15 kΩ and R5=5 kΩ, the values of Vref are:

367.82 mV at −53° C.,

368.7 mV at 27° C. and

368.02 mV at 107° C.

so that upside-down cup shaped characteristic has been obtained. The width of the temperature variations is suppressed to a lower value of 0.29%.

### Other Embodiment of the Invention

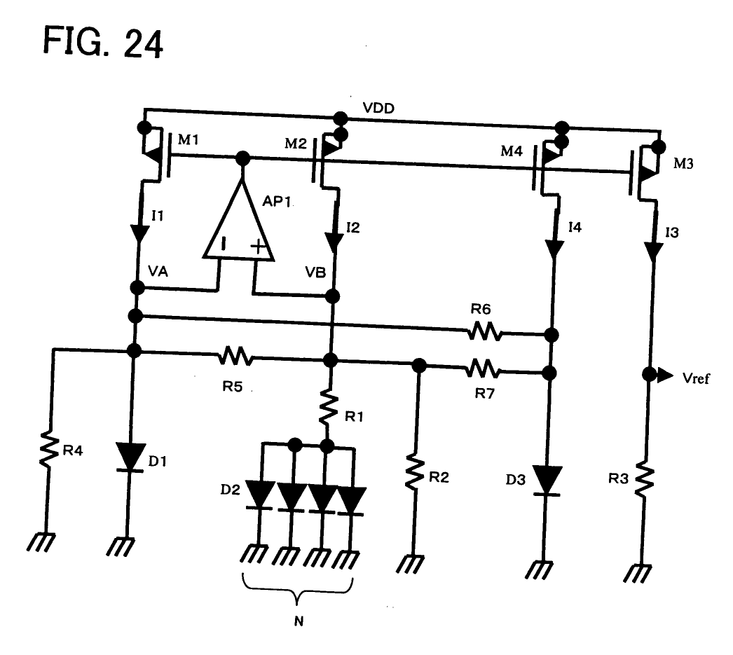

FIG. 24 depicts a diagram showing the circuit configuration of a first embodiment of a CMOS reference voltage generating circuit of the present invention (claim 4). In FIG. 24, the CMOS reference voltage generating circuit, shown in FIG. 21, is added with a circuit that compensates for temperature non-linearity of a diode. That is, a transistor M4, added to the current mirror circuit, drives a diode D3. The diode D3 is connected via resistor R6 to a first current-to-voltage converter circuit (D1, R4), while being connected via resistor R7 to a second current-to-voltage converter circuit (R1, D2, R2).

The operation of the present embodiment is now described. In FIG. 24, a transistor M4, a diode D3 and resistors R6 and R7, added to FIG. 21, is a compensation circuit that compensates for temperature non-linearity of a diode.

The values of simulation result are shown below. If, with VDD=1.3V, N and R1 to R7 are set so that N=2, R1=0.5737 kΩ, R2=R4=R5=19 kΩ, R6=R7=3 kΩ and R3=5 kΩ, the values of Vref are:

328.029 mV at −53° C.,

328.319 mV at −10° C.,

328.95 mV at 27° C.

328.983 mV at 70° C. and

328.943 mV at 107° C.

so that a wave shaped characteristic has been obtained. The width of the temperature variations is suppressed to a lower value of 0.034%.

### Further Embodiment of the Invention

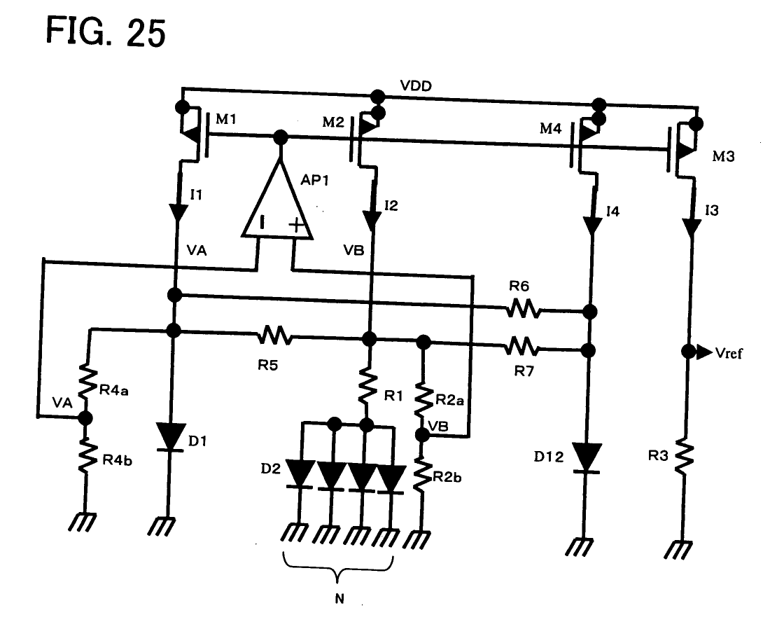

FIG. 25 depicts a diagram showing the circuit configuration of a second embodiment of a CMOS reference voltage generating circuit of the present invention (claim 4). In FIG. 25, the CMOS reference voltage generating circuit, shown in FIG. 22, is added to with a circuit that compensates for temperature non-linearity of a diode. That is, a transistor M4, added to the current mirror circuit, drives a diode D3. The diode D3 is connected via resistor R6 to a first current-to-voltage converter circuit, while being connected via resistor R7 to a second current-to-voltage converter circuit.

In FIG. 25, two parallel-connected resistors R2 and R4 of FIG. 24 are split into voltage-dividing resistors (R2a, R2b) and (R4a, R4b), respectively, where R2a=R4a and R2b=R4b, thereby lowering the input voltages to the OP amp (AP1) and the OP amp (AP2).

### Other Embodiment of the Invention

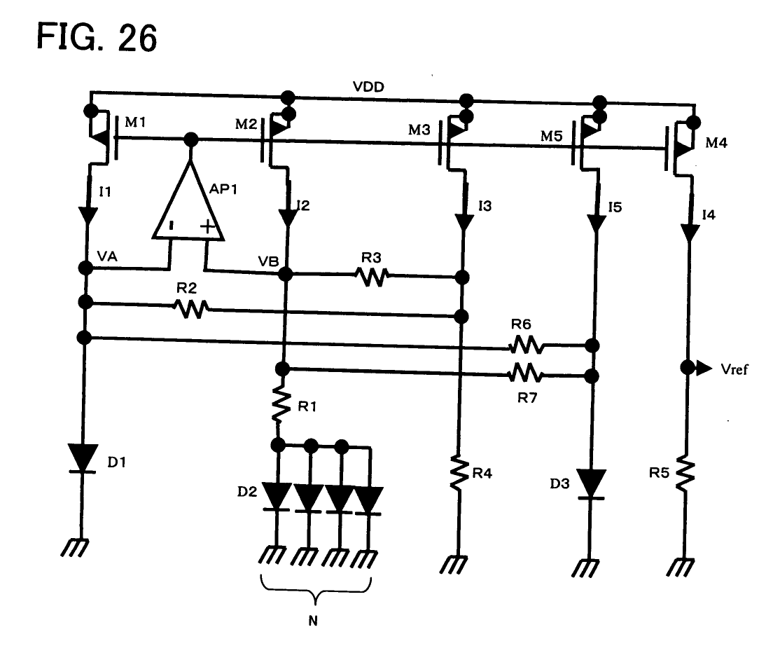

FIG. 26 depicts a diagram showing the circuit configuration of a third embodiment of a CMOS reference voltage generating circuit of the present invention (claim 4). In FIG. 26, the CMOS reference voltage generating circuit, shown in FIG. 23, is added to with a circuit that compensates for temperature non-linearity of a diode. That is, a transistor M5, added to the current mirror circuit, drives a diode D3. The diode D3 is connected via resistor R6 to a first current-to-voltage converter circuit (D1), while being connected via resistor R7 to a second current-to-voltage converter circuit (R1, D2).

The values of simulation result are shown below. If, with VDD=1.3V, N and R1 to R7 are set so that N=2, R1=0.58367 kΩ, R2=R3=R4=6.15 kΩ, R6=R7=3 kΩ and R5=5 kΩ, the values of Vref are:

255.103 mV at −53° C.,

255.35 mV at 27° C. and

255.1 mV at 103° C.

so that upside-down cup shaped characteristic has been obtained. The width of the temperature variations is suppressed to a lower value of 0.098%.

### Further Embodiment of the Invention

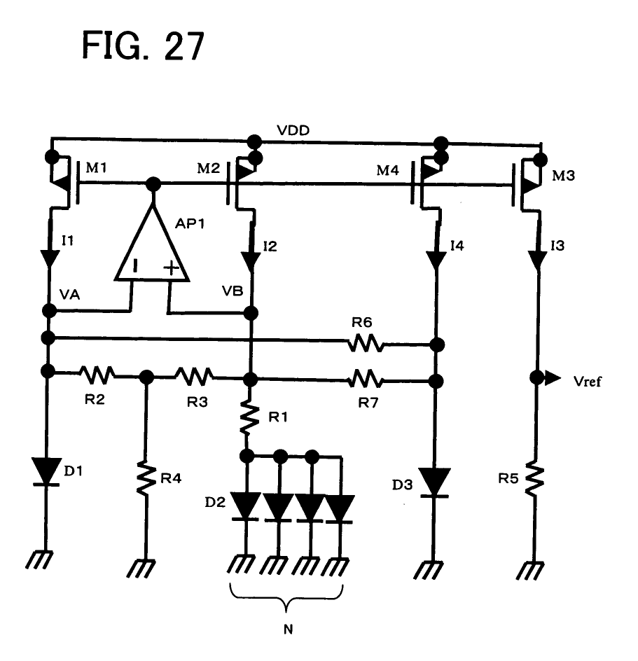

FIG. 27 depicts a diagram showing the circuit configuration of an embodiment of a CMOS reference voltage generating circuit of the present invention (claim 5). In FIG. 27, the CMOS reference voltage generating circuit, shown in FIG. 11, is added to with a circuit that compensates for temperature non-linearity of a diode. That is, a transistor M4, added to the current mirror circuit, drives a diode D3. The diode D3 is connected via resistor R6 to a first current-to-voltage converter circuit, while being connected via resistor R7 to a second current-to-voltage converter circuit.

The values of simulation result are shown below. If, with VDD=1.3V, N and R1 to R7 are set so that N=2, R1=0.574 kΩ, R2=R3=R4=6.34 kΩ, R5=5 kΩ and R6=R7=3 kΩ, the values of Vref are:

327.735 mV at −53° C.,

327.638 mV at −20° C.,

327.6833 mV at 27° C.

327.7292 mV at 80° C. and

327.6996 mV at 107° C.

so that a wave shaped characteristic has been obtained. The width of the temperature variations is suppressed to 0.03%.

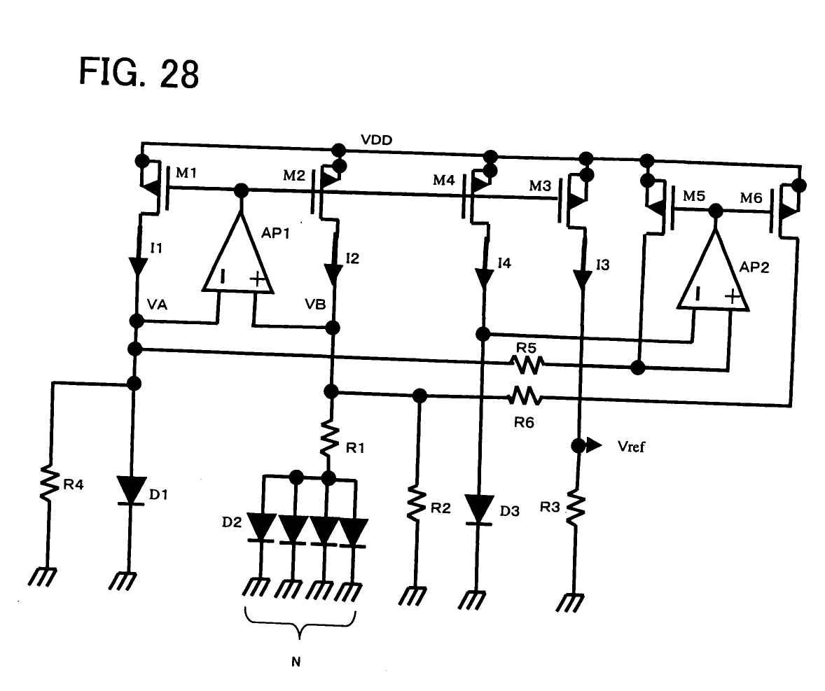

FIG. 28 depicts a diagram showing the circuit configuration of an embodiment of a CMOS reference voltage generating circuit of the present invention (claim 6).

In FIG. 28, the CMOS reference voltage generating circuit, shown in FIG. 6, is added to with a circuit that compensates for temperature non-linearity of a diode. That is, MOS transistors M1 to M4 constitute a first current mirror circuit with a current ratio of 1:1:1. The transistor M4, added to the first current mirror circuit, drives a diode D3. A second current mirror circuit, made up of transistors M5 and M6, supplies the current to the first and second current-to-voltage converter circuits, as the transistor gate voltages are controlled by the second OP amps AP2 so that the terminal voltage of the diode D3 added will be equal to the terminal voltage of the resistor R5.

In FIG. 28, the terminal voltage of the resistor R5 is used as a control voltage. Alternatively, the terminal voltage of the resistor R6 may also be used for producing similar results. That is, although the resistance value of the resistor that is to develop the control voltage needs to be set to a desired value, the resistor not used for developing the control voltage may be of an optional value.

The operation of the present embodiment is now described. In FIG. 28, the transistor M4, the diode D3, resistors R5 and R6, and the OP amp (AP2), added to FIG. 6, constitute a circuit for compensating for temperature non-linearity of a diode.

The values of simulation result are shown below. If, with VDD=1.3V, N and R1 to R6 are set so that N=2, R1=0.54023 kΩ, R2=R4=9 kΩ, R5=R6=5 kΩ and R3=5 kΩ, the values of Vref are:

342.6753 mV at −53° C.

342.609 mV at −10° C.,

342.6387 mV at 27° C.

342.6735 mV at 80° C. and

342.6627 mV at 107° C.

so that a wave shaped characteristic has been obtained. The width of the temperature variations is suppressed to 0.0196%.

### Other Embodiment of the Invention

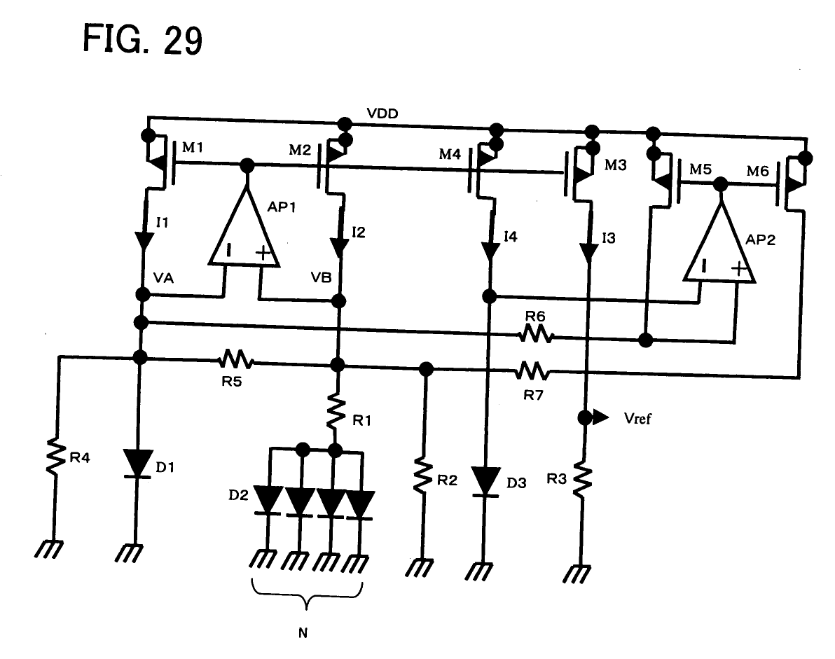

FIG. 29 depicts a diagram showing the circuit configuration of a first embodiment of a CMOS reference voltage generating circuit of the present invention (claim 7).

In FIG. 29, the CMOS reference voltage generating circuit, shown in FIG. 21, is added to with a circuit that compensates for temperature non-linearity of a diode. That is, MOS transistors M1 to M4 constitute a first current mirror circuit with a current ratio of 1:1:1:1. The transistor M4, added to the first current mirror circuit, drives a diode D3. A second current mirror circuit, made up of transistors M5 and M6, supplies the current to the first and second current-to-voltage converter circuits, via resistors R6, R7, as the transistor gate voltages are controlled by the second OP amps (AP2) so that the terminal voltage of the diode D3 added will be equal to the terminal voltage of the resistor R5.

In FIG. 29, the terminal voltage of the resistor R6 is used as a control voltage. Alternatively, the terminal voltage of the resistor R7 may also be used for producing similar results. That is, although the resistance value of the resistor that is to develop the control voltage needs to be set to a desired value, the resistor not used for developing the control voltage may be of an optional value.

The operation of the present embodiment is now described. In FIG. 29, the transistor M4, the diode D3, resistors R6, R7 and the OP amp (AP2), added to FIG. 21, constitute a circuit for compensating for temperature non-linearity of a diode.

The values of simulation result are shown below. If, with VDD=1.3V, N and R1 to R7 are set so that N=2, R1=0.54187 kΩ, R2=R4=R5=19 kΩ, R6=R7=5 kΩ and R3=5 kΩ, the values of Vref are:

342.283 mV at −53° C.,

342.2278 mV at −10° C.,

342.252 mV at 27° C.

342.2829 mV at 80° C. and

342.271 mV at 107° C.

so that a wave shaped characteristic has been obtained. The width of the temperature variations is suppressed to 0.0159%.

### Other Embodiment of the Invention

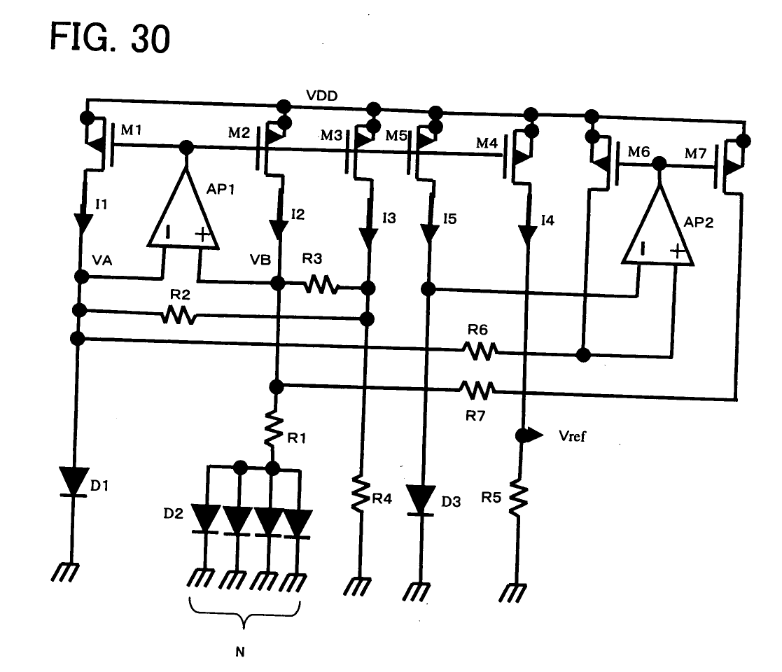

FIG. 30 depicts a diagram showing the circuit configuration of a second embodiment of a CMOS reference voltage generating circuit of the present invention (claim 7).

In FIG. 30, the CMOS reference voltage generating circuit, shown in FIG. 23, is added to with a circuit that compensates for temperature non-linearity of a diode. That is, MOS transistors M1 to M4 constitute a first current mirror circuit with a current ratio of 1:1:1:1. The transistor M4, added to the first current mirror circuit, drives a diode D3.

A second current mirror circuit, made up of transistors M6, M7, supplies the current to the first current-to-voltage converter circuit (D1) and the second current-to-voltage converter circuit (resistor R1 and N diodes D2), via resistors R6 and R7, as the transistor gate voltages are controlled by the second OP amps (AP2) so that the terminal voltage of the diode D3 added will be equal to the terminal voltage of the resistor R6.

In FIG. 30, the terminal voltage of the resistor R6 is used as a control voltage. Alternatively, the terminal voltage of the resistor R7 may also be used for producing similar results. That is, although the resistance value of the resistor that is to develop the control voltage needs to be set to a desired value, the resistor not used for developing the control voltage may be of an optional value.

The operation of the present embodiment is now described. In FIG. 30, the transistor M5, the diode D3, resistors R6, R7 and the OP amp (AP2), added to FIG. 23, constitute a circuit for compensating for temperature non-linearity of a diode.

The values of simulation result are shown below. If, with VDD=1.3V, N and R1 to R7 are set so that N=2, R1=0.56518 kΩ, R2=R3=R4=6.15 kΩ, R6=R7=4 kΩ and R5=5 kΩ, the values of Vref are:

258.512 mV at −53° C.,

258.4962 mV at −20° C.,

258.5073 mV at 27° C.

258.5139 mV at 60° C. and

258.496 mV at 107° C.

so that a wave shaped characteristic has been obtained. The width of the temperature variations is suppressed to 0.0685%.

### Other Embodiment of the Invention

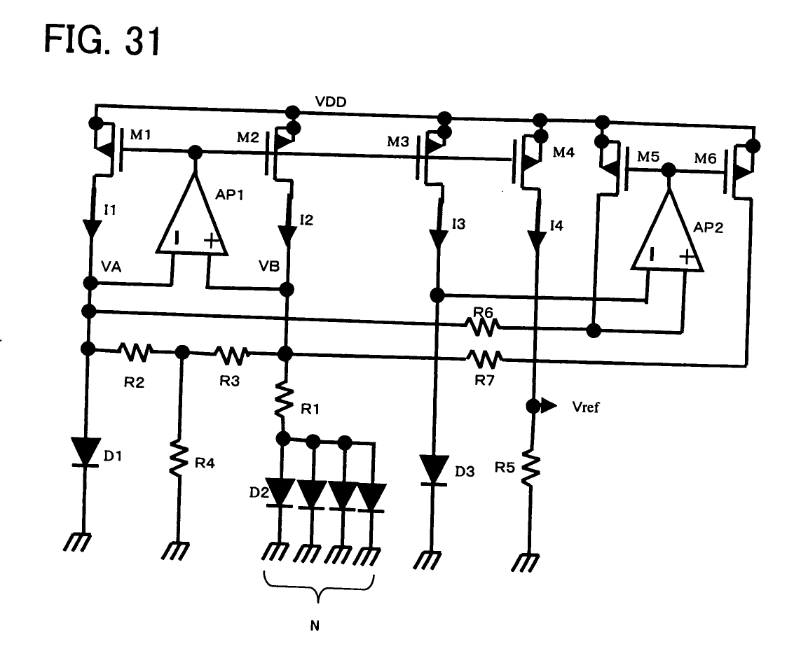

FIG. 31 depicts a diagram showing the circuit configuration of a first embodiment of a CMOS reference voltage generating circuit of the present invention (claim 8).

In FIG. 31, the CMOS reference voltage generating circuit, shown in FIG. 11, is added to with a circuit that compensates for temperature non-linearity of a diode. That is, MOS transistors M1 to M4 constitute a first current mirror circuit with a current ratio of 1:1:1:1. The transistor M3, added to the first current mirror circuit, drives a diode D3. A second current mirror circuit, made up of transistors M5 and M6, supplies the current to the first and second current-to-voltage converter circuits, via resistors R6, R7, as the transistor gate voltages are controlled by the second OP amps (AP2) so that the terminal voltage of the diode D3 added will be equal to the terminal voltage of the resistor R6.

In FIG. 31, the terminal voltage of the resistor R6 is used as a control voltage. Alternatively, the terminal voltage of the resistor R7 may also be used for producing similar results. That is, although the resistance value of the resistor that is to develop the control voltage needs to be set to a desired value, the resistor not used for developing the control voltage may be of an optional value.

The operation of the present embodiment is now described. In FIG. 31, the transistor M3, the diode D3, resistors R6 and R7, and the OP amp (AP2), added to FIG. 11, constitute a circuit for compensating for temperature non-linearity of a diode.

The values of simulation result are shown below. If, with VDD=1.3V, N and R1 to R7 are set so that N=2, R1=0.54245 kΩ, R2=R3=R4=6.34 kΩ, R6=R7=5 kΩ and R3=5 kΩ, the values of Vref are:

341.9005 mV at −53° C.,

341.8455 mV at −10° C.,

341.87 mV at 27° C.

341.9017 mV at 80° C. and

341.89 mV at 107° C.

so that a wave shaped characteristic has been obtained. The width of the temperature variations is suppressed to 0.0164%.

### Other Embodiment of the Invention

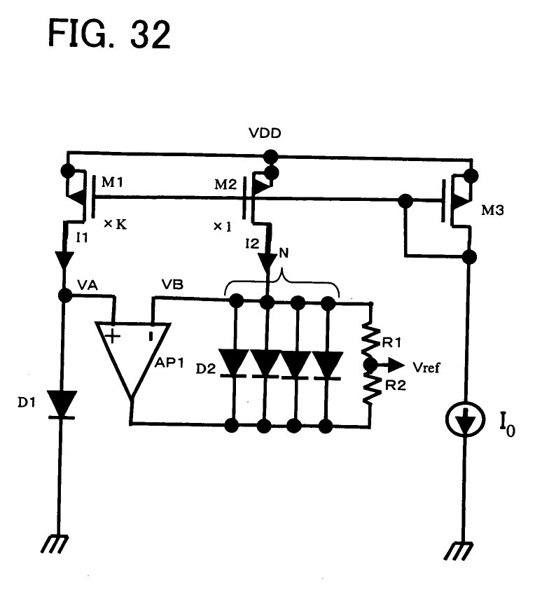

FIG. 32 depicts a diagram showing the circuit configuration of a CMOS reference voltage generating circuit of the present invention.

In FIG. 32, MOS transistors M1 to M3 constitute a current mirror circuit with the current ratio of K:1:1. By the MOS transistor M3, driven with a constant current I0, currents I1 (=K10) and I2 (=I0) flow through the MOS transistors M1 and M2, respectively. The common gate voltage is controlled by the OP amp (AP1) so that two input terminal voltages of the OP amp will be equal to each other.

The first and second current-to-voltage converter circuits for comparison are each made up of diodes (bipolar transistors connected as diodes). The number of diodes of the first current-to-voltage converter circuit differs from that of the second current-to-voltage converter circuit. The ratio of the numbers of the diodes (or bipolar transistors connected as diodes) in the parallel path of each of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminal of the diode (or the bipolar transistor connected as diode) D2 of the second current-to-voltage converter circuit is connected to an output of the OP amp (AP1) and is controlled so that the terminal voltages of the first and second current-to-voltage converter circuits will be equal to each other.

An output circuit is made up by resistors R1 and R2 that divide the forward voltage of the diode (or the bipolar transistor connected as diode) D2 of the second current-to-voltage converter circuit. The divided voltage is output as the reference voltage Vref.

The operation of the present embodiment is now described. Referring to FIG. 32, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 and I2 from the current mirror circuit is K:1,

I1=K10 (171)

I2=I0 (172)

If D1 is a unit diode (or a bipolar transistor connected as a diode), and D2 are N parallel-connected unit diodes (or bipolar transistors connected as diodes), the voltage difference ΔVF of D1 and D2 is expressed as

ΔVF=VF1−VF2=V_{T} ln(KN) (173)

Since V_{T} has a positive temperature characteristic of 0.0853 mV/° C., the voltage difference has a positive temperature characteristic and appears across the ground and the output voltage of the OP amp (AP1).

The forward voltage VF1 of D1 has a negative temperature characteristic of approximately −1.9 mV/° C., so that, if temperature characteristic is to be canceled out, it is sufficient to cancel them out with the voltage difference ΔV_{F} of the diodes D1 and D2 and the forward voltage V_{F} of the diodes (or the bipolar transistors connected as diodes). However, since V_{T} is 26 mV at ambient temperature, ln(KN) is only 4 if KN=55, so that the voltage difference ΔV_{F} of the diodes D1 and D2 is only 104 mV (ΔVF=V_{T} ln(KN)=104 mV).

Hence, the temperature characteristic of ΔVF=V_{T} ln(KN) are +0.3412 mV/° C., viz., it is sufficient to set the forward voltage V_{F} of the diode (or bipolar transistor connected as diode) to 1/5.5686 and to carry out weighted summation. The voltage-dividing resistors R1, R2 are set to sufficiently large values and the current flowing in the voltage-dividing resistor is discounted. If VF2 is about 579 mV at ambient temperature, the divided voltage is 104 mV, and about 208 mV is obtained as a weighted-summed constant voltage having temperature characteristic canceled out. VF1 at this time is about 683 mV at ambient temperature.

In FIG. 32, the voltage-dividing resistor R1 is connected to VB. However, similar characteristics may be obtained if the resistor is connected to VA.

### Specified Circuit for an Embodiment

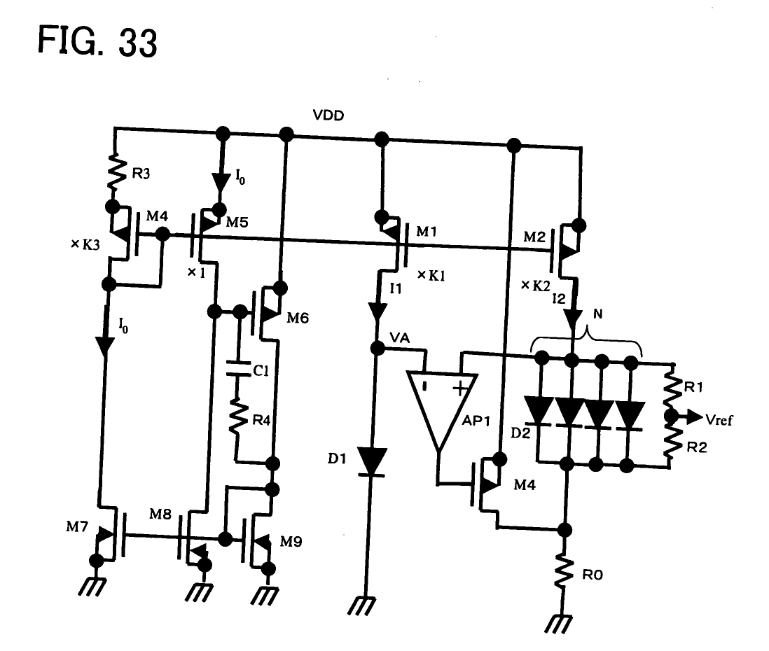

FIG. 33 shows an illustrative circuit in which, in a circuit shown in FIG. 32, the constant current Iₒ is supplied from a reference voltage generating circuit that uses a reverse Widlar current mirror circuit arranged as a self-bias circuit. I₀ has a positive temperature characteristic. It should be noted however that ΔV_{F} is not higher than approximately 100 mV even at ambient temperature.

The values of simulation result are shown below. If, with VDD=1.2V, N and K1 to K3 are set so that N=6, K1=2, K2=9 and K3=4, and R1 to R4 and C1 are such that R0=70 kΩ, R1=2187 kΩ, R2=200 kΩ, R3=250 kΩ, R4=500 kΩ and C1 is 50 pF, the values of Vref are:

145.36 mV at −53° C.,

145.362 mV at −40° C.

145.07 mV at 27° C. and

145.35 mV at 103° C.

so that upside-down cup shaped characteristic has been obtained. The width of the temperature variations is suppressed to 0.68%.

### Other Embodiment of the Invention

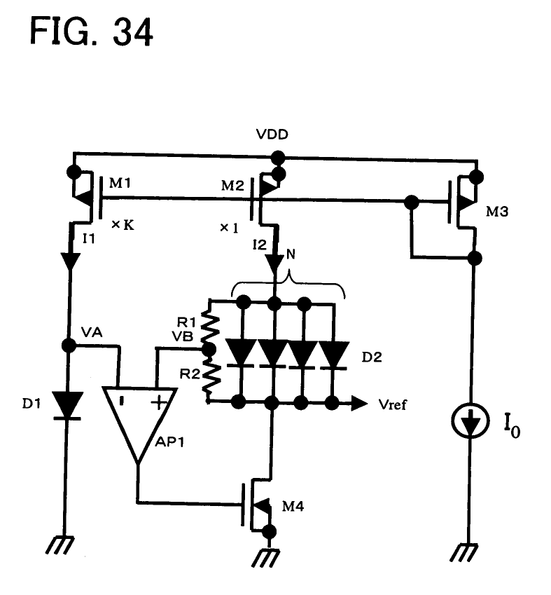

FIG. 34 is a diagram showing the circuit configuration of a CMOS reference voltage generating circuit for an embodiment the present invention. In the circuit shown in FIG. 32, the value of ΔVF, with positive temperature characteristic, generated against the ground, is at most about 100 mV or less, even at ambient temperature. Hence, it is necessary to specifically deign the circuit to provide a positive circuit operation. To this end, the circuit configuration shown in FIG. 34 may possibly be used.

In FIG. 34, MOS transistors M1 to M3 constitute a current mirror circuit with the current ratio of K:1:1, so that, by the MOS transistor M3, driven by the constant current I₀, I1 (=K10) and I2 (=I0) flow through the MOS transistors M1 and M2, respectively. The common gate voltage is controlled by the OP amp (AP1) so that two input terminal voltages of the OP amp will be equal to each other. The first current-to-voltage converter circuit is made up of a diode (or a transistor connected as diode), whereas the second current-to-voltage converter circuit is made up of a diode (or a transistor connected as diode) and voltage-dividing resistors R1 and R2.

The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N.

Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2 of the second current-to-voltage converter circuit are connected to the gate of the transistor controlled by the output voltage of the OP amp (AP1), and control is exercised so that the terminal voltage of the first current-to-voltage converter circuit will be equal to the divided voltage of the second current-to-voltage converter circuit.

The reference voltage Vref is output from the lower electrodes of the diodes (or the bipolar transistors connected as diodes) D2 of the second current-to-voltage converter circuit.

The operation of the present embodiment is now described. Referring to FIG. 34, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 and I2 from the current mirror circuit is K:1,

I1=K1₀ (174)

and

I2=I₀ (175)

If D1 is a unit diode (or a bipolar transistor connected as a diode), and D2 are N parallel-connected unit diodes (or bipolar transistors connected as diodes), the voltage difference ΔVF of D1 and D2 is expressed as

ΔVF=VF1−VF2=V_{T} ln(KN) (176)

Since V_{T} has a positive temperature characteristic of 0.0853 mV/° C., the voltage difference has a positive temperature characteristic, and is included in a voltage appearing across the ground and the output voltage of the OP amp (AP1).

On the other hand, the forward voltage VF1 of D1 has a negative temperature characteristic of about −1.9 mV/° C. Since the forward voltage VF2 of D2 also has a negative temperature characteristic of about −1.9 mV/° C., the temperature characteristic of the voltage as divided by the voltage-dividing resistors R1, R2 is diminished in keeping with the voltage-dividing resistance ratio such that

VA=VF1=VB (177)

and

$${V}_{B} = {V}_{ref} + \frac{{R}_{2}}{{R}_{1} + {R}_{2}} {V}_{F 2} \qquad ( 178 )$$

Therefore,

$$\begin{matrix}{V}_{ref} = {V}_{F 1} - \frac{{R}_{2}}{{R}_{1} + {R}_{2}} {V}_{F2} \\ = \frac{{R}_{1}}{{R}_{1} + {R}_{2}} ( {V}_{F 1} + \frac{{R}_{2}}{{R}_{1}} Δ {V}_{F} ) \\ = \frac{{R}_{1}}{{R}_{1} + {R}_{2}} \{ {V}_{F 1} + \frac{{R}_{2}}{{R}_{1}} {V}_{T} ln ( KN ) \}\end{matrix} \qquad ( 179 )$$

It is noted that {VF1+(R2/R1)V_{T} ln(KN)} may be set to a voltage value on the order of 1.2V having temperature characteristic canceled out. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of (R2/R1)V_{T} ln(KN) to about 22.27 to cancel out the temperature characteristic. Also, since V_{T} is 26 mV at ambient temperature, (R2/R1)V_{T} ln(KN) is about 579 mV at ambient temperature. Therefore, if VF1 is 626 mV at ambient temperature, {VF1+(R2/R1)V_{T} ln(KN)} is about 1.205V.

The reference voltage Vref, thus obtained, is a constant voltage which is divided by resistances and multiplied by R1/(R1+R2) and which may be set to 1.205V or less. That is, the reference voltage Vref is a constant voltage having temperature characteristic canceled out. Hence, the voltage may be used as reference voltage.

### Specified Circuit for an Embodiment

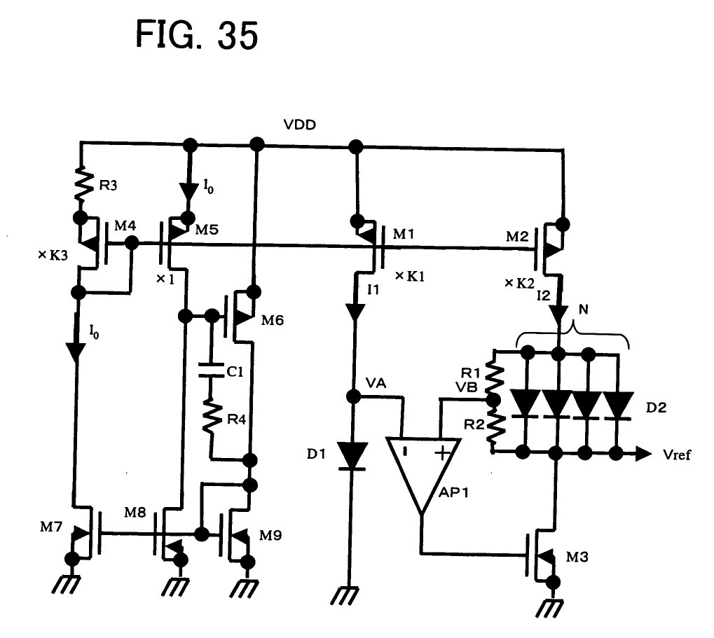

FIG. 35 depicts a circuit configuration of an embodiment of a CMOS reference voltage generating circuit of the present invention. FIG. 35 shows an illustrative circuit in which, in a circuit shown in FIG. 33, the constant current I₀ is supplied from a reference voltage generating circuit that uses a reverse Widlar current mirror circuit arranged as self-bias circuit. The current I₀ has a positive temperature characteristic.

The values of simulation result are shown below. If, with VDD=1.2V, N and K1 to K3 are set so that N=6, K1=2, K2=9 and K3=4, and R1 to R4 and C1 are such that R1=200 kΩ, R2=2220 kΩ, R3=250 kΩ, R4=500 kΩ and C1 is 50 pF, the values of Vref are:

144.94 mV at −53° C.,

145.28 mV at −0° C.

145.34 mV at 27° C. and

144.9 mV at 103° C.

so that upside-down cup shaped characteristic has been obtained. The width of the temperature variations is suppressed to less than 1% for a constant power supply voltage.

### Other Embodiment of the Invention

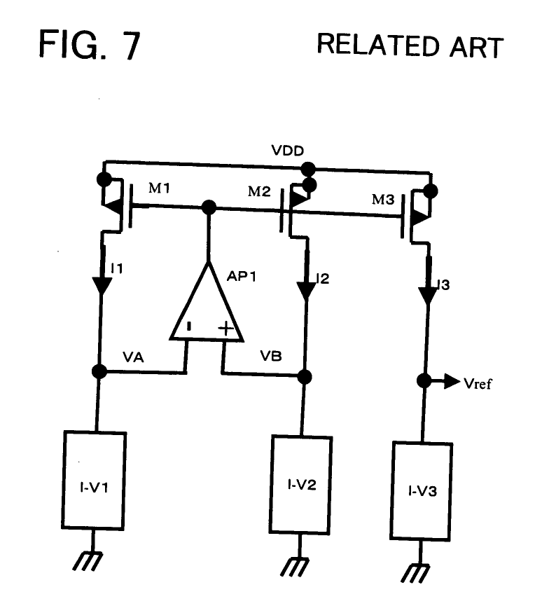

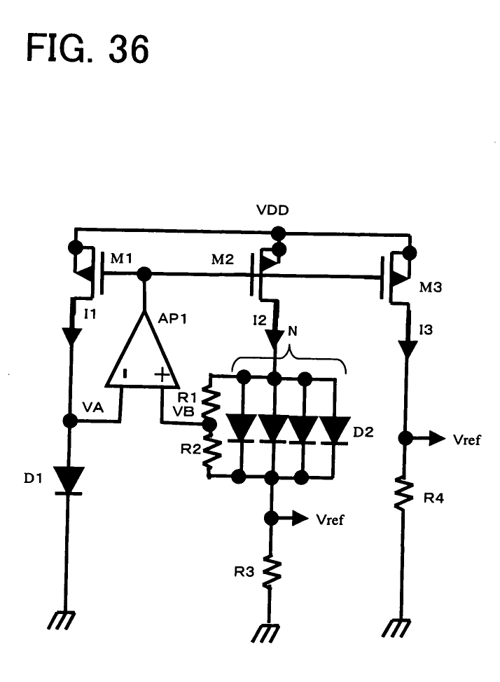

FIG. 36 is a diagram showing the circuit configuration of a CMOS reference voltage generating circuit for claim 9 of the present invention. The circuit of FIG. 36 is designed as a self-bias circuit and the reference current generating circuit shown in FIG. 33 may be dispensed with. The reference voltage generating circuit shown in FIG. 35 is also of the circuit topology shown in FIG. 7.

In FIG. 36, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other. The first current-to-voltage converter circuit for comparison is made up of a diode (or a bipolar transistor connected as diode), whereas the second current-to-voltage converter circuit is made up of diodes (or bipolar transistors connected as diodes), voltage-dividing resistors R1, R2 and a resistor R3 connected in series with the diodes/resistors.

The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2, voltage-dividing resistors R1, R2 and the resistor R3 connected in series with the resistors/diodes of the second current-to-voltage converter circuit, are grounded. Control is exercised so that the terminal voltage of the first current-to-voltage converter circuit will be equal to the divided voltage of the second current-to-voltage converter circuit.

The reference voltage Vref is output by converting the current I3 into a voltage by a resistor R4.

The operation of the present embodiment is now described.

Referring to FIG. 36, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1, I2 and I3 from the current mirror circuit is 1:1:1,

I₁=I₂=I₃ (180)

It is assumed that D1 is a unit diode (or a bipolar transistor connected as a diode), and D2 are N parallel-connected unit diodes (or bipolar transistors connected as diodes). It is also assumed that the voltage-dividing resistors R1, R2 are set to sufficiently large values so that the currents flowing through these voltage-dividing resistors may be discounted. The voltage difference ΔV_{F} of D1 and D2 is expressed as

ΔVF=VF1−VF2=V_{T} ln(N) (181)

where V_{T} has a positive temperature characteristic and hence the voltage difference has a positive temperature characteristic.

On the other hand, the forward voltage VF1 of D1 has a negative temperature characteristic of about −1.9 mV/° C.

The forward voltage VF2 of D2 also has a negative temperature characteristic of about −1.9 mV/° C. Hence, the temperature characteristic of the voltage, divided by the voltage-dividing resistors R1 and R2, is diminished in keeping with the voltage-dividing resistance ratio such that

VA=VF1=VB (182)

and

$${V}_{B} = {I}_{2} {R}_{3} + \frac{{R}_{2}}{{R}_{1} + {R}_{2}} {V}_{F 2} \qquad ( 183 )$$

Hence,

$$\begin{matrix}{I}_{2} = \frac{1}{{R}_{3}} ( {V}_{F 1} - \frac{{R}_{2}}{{R}_{1} + {R}_{2}} {V}_{F 2} ) \\ = \frac{1}{{R}_{3}} \frac{{R}_{1}}{{R}_{1} + {R}_{2}} ( {V}_{F 1} + \frac{{R}_{2}}{{R}_{1}} Δ {V}_{F} ) \\ = \frac{1}{{R}_{3}} \frac{{R}_{1}}{{R}_{1} + {R}_{2}} \{ {V}_{F 1} + \frac{{R}_{2}}{{R}_{1}} {V}_{T} ln ( N ) \}\end{matrix} \qquad ( 184 )$$

Hence,

$$\begin{matrix}{V}_{ref} = {I}_{3} {R}_{4} \\ = \frac{{R}_{4}}{{R}_{3}} \frac{{R}_{1}}{{R}_{1} + {R}_{2}} \{ {V}_{F 1} + \frac{{R}_{2}}{{R}_{1}} {V}_{T} ln ( N ) \}\end{matrix} \qquad ( 185 )$$

It is noted that {VF1+(R2/R1)V_{T} ln(N)} can be set to a voltage value of the order of 1.2V from which temperature characteristic have been cancelled out. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of (R2/R1)V_{T} ln(KN) to about 22.27 to cancel out the temperature characteristic. Also, since V_{T} is 26 mV at ambient temperature, (R2/R1)V_{T} ln(N) is about 579 mV at ambient temperature. Therefore, if VF1 is 626 mV at ambient temperature, {VF1+(R2/R1)V_{T} ln(KN)} is about 1.205V.

The reference voltage Vref, thus obtained, is a constant voltage which is divided by resistances and multiplied by R4/R3){R1/(R1+R2)} and which may be set to 1.205V or less. That is, the reference voltage Vref is a constant voltage having temperature characteristic cancelled out and hence may be used as reference voltage.

In the above-mentioned description, the terminal voltage of the register R4 is used as the reference voltage. However, the reference voltage may well be changed to the terminal voltage of the register R3. In FIG. 36, assuming that the terminal voltage of the register R3 is Vref′, since control is performed by the OP amp (AP1) such that VA=VB, the following equation holds:

$${V}_{F 1} = {Vref}^{′} + \frac{{R}_{2}}{{R}_{1} + {R}_{2}} {V}_{F 2} \qquad ( 230 )$$

where VF1 and VF2 are diode forward voltages of respective D1 and D2.

Vref′ is expressed as follows:

$$\begin{matrix}{Vref}^{′} = {V}_{F 1} - \frac{{R}_{2}}{{R}_{1} + {R}_{2}} {V}_{F 2} \\ = {V}_{F 1} - {V}_{F 2} + \frac{{R}_{1}}{{R}_{1} + {R}_{2}} {V}_{F 2} \\ = Δ {V}_{F} + \frac{{R}_{1}}{{R}_{1} + {R}_{2}} {V}_{F 2} \\ = α {V}_{F 2} + Δ {V}_{F} ( α < 1 )\end{matrix} \qquad ( 231 )$$

Here, since I1=I2, we have:

$$Δ {V}_{F} = {V}_{T} ln ( \frac{N}{1 - \frac{{V}_{F 2}}{{I}_{1} ( {R}_{1} + {R}_{2} )}} ) \qquad ( 232 )$$

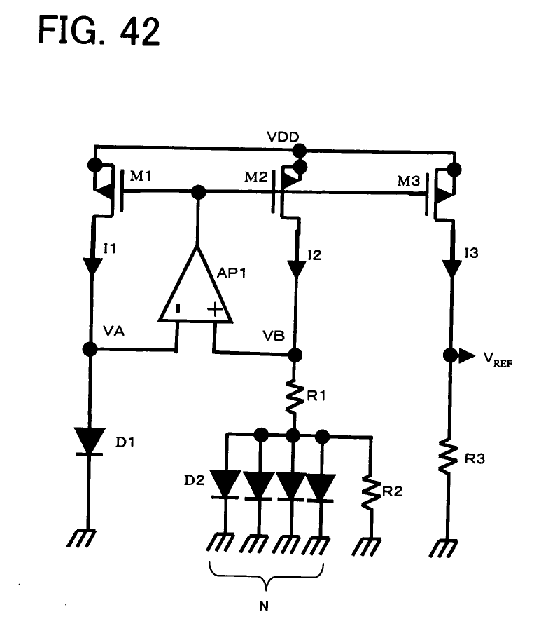

From (232), we see that the reference voltage generating circuit shown in FIG. 36 is capable of improving the non-linear temperature characteristic of the diode, as the reference voltage generating circuit shown in FIGS. 42, 43, and FIG. 44.

The reference voltage of the equation (231) is a low voltage, such as several times 50 mV, as with ones of FIGS. 32, 33, 34 and FIG. 35. In case of the number N of diodes D2 connected in parallel being set to 148, the reverence voltage is about 250 mV. In general, the target value of the reference voltage is set to 200 mV. With the reference voltage generating circuit shown in FIG. 36, the reference voltage is speculated by the number N (log) of diodes D2 connected in parallel, for example, 100 mV@N≈3, 150 mV@N≈20, 200 mV@N≈55, 250 mV@N≈148.

The voltage obtained is far from the band-gap voltage of Si. The reason why the present inventor doesn't call it the band-gap reference but call it voltage reference would be understood.

It should be noted that in the equations (230) and (231), R3 is not present. Actually,

Vref′=R3I2 (232)

The values of simulation result are shown below.

If, with VDD=1.3V, N and R1 to R3 are set so that N=140, R1=2.8 kOhm, R2=13.79 Ohm, and R3=1 kOhm, the reference voltage Vref′ are:

240.782 mV at −53° C.,

240.892 mV at −20° C.,

240.884 mV at 20° C.,

240.912 mV at 60° C. and

240.772 mV at 103° C.

so that the characteristic with a shape of two peaks is obtained. The temperature variation range is suppressed to 0.06%. As described above, other than the conventional voltage Vref=VBE1+KΔVBE≈1.2V(K>>1), the temperature compensated reference voltage or the reference voltage having the temperature non-linearity of VBE of a bipolar transistor or diode compensated can be obtained by Vref′=a VBE+ΔVBE(α<1).

### Other Embodiment of the Invention

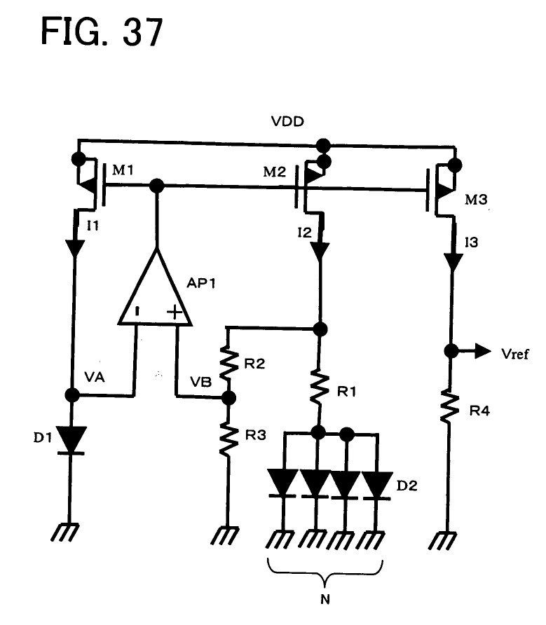

FIG. 37 depicts a diagram showing the circuit configuration of an embodiment of a CMOS reference voltage generating circuit of the present invention (claim 10). In FIG. 36, the resistor R3, connected in series with D2 and the voltage-dividing resistors R1, R2, are grounded. However, there may be cases where the circuit can be implemented only with D2 grounded such that floating connection is not possible. The reference voltage generating circuit shown in FIG. 37 is of the circuit topology shown in FIG. 7.

In FIG. 37, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode (or a bipolar transistor connected as diode), whereas the second current-to-voltage converter circuit is made up of diodes (or bipolar transistors connected as diodes), connected in series with the resistor R1, and voltage-dividing resistors R2 and R3 connected in series with the resistors/diodes. The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four diodes D2 are parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2 of the second current-to-voltage converter circuit, connected in series with resistor R1, and the opposite terminals of the voltage-dividing resistors R2 and R3 connected in parallel with R1-D2, are grounded. The OP amp (AP1) exercises control so that the terminal voltage of the first current-to-voltage converter circuit will be equal to the divided voltage of the second current-to-voltage converter circuit.

The reference voltage Vref output has been converted from the current I3 by resistor R4.

The operation of the present embodiment is now described. Referring to FIG. 37, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1, I2 and I3 from the current mirror circuit is 1:1:1,

I₁=I₂=I₃ (186)

Also,

VA=VF1=VB (187)

and

$${V}_{B} = \frac{{R}_{3}}{{R}_{2} + {R}_{3}} ( {I}_{2} {R}_{1} + {V}_{F 2} ) \qquad ( 188 )$$

It is assumed that D1 is a unit diode (or a bipolar transistor connected as a diode), and D2 are N parallel-connected unit diodes (or bipolar transistors connected as diodes). It is also assumed that the voltage-dividing resistors R2 and R3 are set to sufficiently large values so that the currents flowing through these voltage-dividing resistors may be discounted. The voltage difference ΔVF of D1 and D2 is expressed as

ΔVF=VF1−VF2=V_{T} ln(N) (189)

where V_{T} has a positive temperature characteristic and hence the voltage difference has a positive temperature characteristic.

On the other hand, the forward voltage VF1 of D1 has a negative temperature characteristic of about −1.9 mV/° C. The forward voltage VF2 of D2 also has a negative temperature characteristic of about −1.9 mV/° C. Therefore, temperature characteristic of the voltage resulting from division by the voltage-dividing resistors R2 and R3 are also diminished in keeping with the voltage-dividing resistance ratio.

Hence, from the equation (188), we have

$$\begin{matrix}{I}_{2} = \frac{1}{{R}_{1}} \frac{{R}_{2}}{{R}_{3}} ( {V}_{F 1} + \frac{{R}_{3}}{{R}_{2}} Δ {V}_{F} ) \\ = \frac{1}{{R}_{1}} \frac{{R}_{2}}{{R}_{3}} \{ {V}_{F 1} + \frac{{R}_{3}}{{R}_{2}} {V}_{T} ln ( N ) \}\end{matrix} \qquad ( 190 )$$

Hence, we have

$$\begin{matrix}{V}_{ref} = {I}_{3} {R}_{4} \\ = \frac{{R}_{4}}{{R}_{1}} \frac{{R}_{2}}{{R}_{3}} \{ {V}_{F 1} + \frac{{R}_{3}}{{R}_{2}} {V}_{T} ln ( N ) \}\end{matrix} \qquad ( 191 )$$

It is noted that {VF1+(R3/R2)V_{T} ln(N)} can be set to a voltage value on the order of 1.2V from which temperature characteristic have been cancelled out. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of (R3/R2) ln(N) to about 22.27 to cancel out the temperature characteristic. Also, since V_{T} is 26 mV at ambient temperature, (R3/R2)V_{T} ln(N) is about 579 mV at ambient temperature. Therefore, if VF1 is 626 mV at ambient temperature, {VF1+(R3/R2)V_{T} ln(N)} is about 1.205V.

The reference voltage Vref, thus obtained, is a constant voltage which is divided by resistances and multiplied by (R4/R3)R2/R1) and which may be set to 1.205V or less. That is, the reference voltage Vref is a constant voltage having temperature characteristic cancelled out so that it may be used as reference voltage.

The values of simulation result are shown below. If, with VDD=1.3V, N and R1 to R4 are set so that N=4, R1=2.6 kΩ, R2=23 kΩ, R3=500 kΩ and R4=10 kΩ, the values of Vref are:

288.87 mV at −53° C.,

368.1 mV at 27° C. and

288.76 mV at 103° C.

so that upside-down cup shaped characteristic has been obtained. The width of the temperature variations is suppressed to about 0.4%.

### Other Embodiment of the Invention

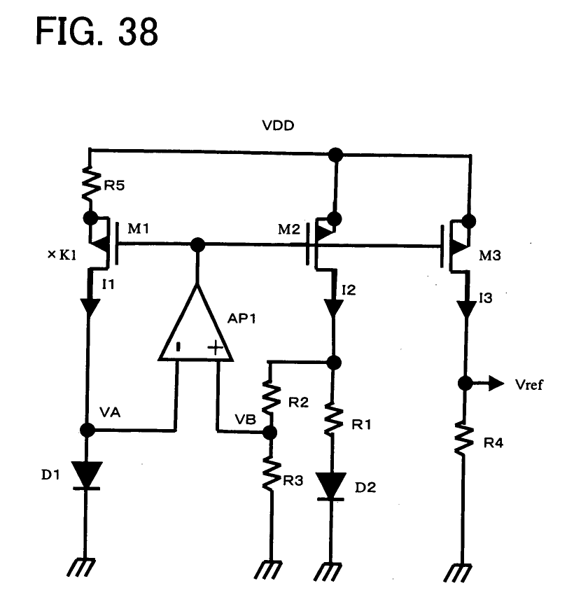

FIG. 38 depicts a diagram showing the circuit configuration of an embodiment of a CMOS reference voltage generating circuit of the present invention (claim 11). If, with the first and second current-to-voltage converter circuits, the numbers of the diodes are equal, the chip size can be reduced further.

In FIG. 38, the MOS transistors M1 and M2, including a resistor R5 as a source resistor constitute a non-linear current mirror circuit (Widlar current mirror). The MOS transistors M2 and M3 constitute a current mirror circuit with the current ratio of 1:1. The currents I1, I2 and I3 flow through the MOS transistors M1, M2 and M3, respectively. The common gate voltage is controlled by the OP amp (AP1) so that two input terminal voltages of the OP amp (AP1) will be equal to each other.

The first current-to-voltage converter circuit for comparison is made up of a diode (or a bipolar transistor connected as diode), whereas the second current-to-voltage converter circuit is made up of a series connection of a resistor R1 and a diode (or a bipolar transistor connected as diode), and voltage-dividing resistors R2 and R3 connected in parallel with the series connection. It is assumed that the number of diodes of the first current-to-voltage converter circuit is equal to that of the second current-to-voltage converter circuit. The ratio of the numbers of the parallel-connected diodes (or bipolar transistors connected as diodes) of the first and second current-to-voltage converter circuits is set to 1:1. Specifically, a sole diode is used for the first current-to-voltage converter circuit, and a sole diode is parallel-connected for the second current-to-voltage converter circuit.

The opposite terminal of the diode (or the bipolar transistor connected as diode) D1 of the first current-to-voltage converter circuit is grounded, whereas the opposite terminals of the diodes (or the bipolar transistors connected as diodes) D2 of the second current-to-voltage converter circuit, connected in series with the resistor R1, and the voltage-dividing resistors R2, R3 connected in parallel with the resistor and D2, are grounded. The OP amp (AP1) exercises control so that the terminal voltage of the first current-to-voltage converter circuit will be equal to the divided voltage of the second current-to-voltage converter circuit.

The reference voltage output Vref has been converted from the current I3 by resistor R4.

The operation of the present embodiment is now described. Referring to FIG. 38, with the forward voltages VF1 and VF2 of the diodes (or bipolar transistors connected as diodes) D1 and D2, the OP amp (AP1) exercises control so that the voltages at the two input terminals will be equal to each other (VA=VB).

The relationship between the output currents I1 and I2 from the non-linear current mirror circuit (Widlar current mirror) is to be found.

The following equations are valid:

I1=K1β(V_{GS1}−V_{TH})²=K1β(V_{GS2}−I1R5−V_{TH})² (192)

I2=β(V_{GS2}−V_{TH}) (193)

where β is a transconductance parameter of the unit transistor M2 and V_{TH} is the threshold voltage.

From the equations (192) and (193), I1=0 when I2=0. Thus, using − for ± in the root of the quadratic equation, we have

$${I}_{1} = \frac{{( \sqrt{4 {K}_{1} {R}_{5} \sqrt{β} \sqrt{{I}_{2}} + 1} - 1 )}^{2}}{4 {K}_{1} β {R}_{5}^{2}} \qquad ( 194 )$$

In the non-linear current mirror circuit (Widlar current mirror), the output current I1 has a positive temperature characteristic with respect to the reference current I2. With VF1<VF2, we have

$$\begin{matrix}Δ {V}_{F} = {V}_{F 2} - {V}_{F 1} \\ = {V}_{T} ln ( \frac{{I}_{2}}{{I}_{1}} ) \\ = {V}_{T} ln \{ \frac{4 {K}_{1} β {R}_{5}^{2} {I}_{2}}{{( \sqrt{4 {K}_{1} {R}_{5} \sqrt{β} \sqrt{{I}_{2}} + 1} - 1 )}^{2}} \}\end{matrix} \qquad ( 195 )$$

On the other hand, the OP amp (AP1) exercises control so that the two input terminal voltages will be equal to each other. Thus, with the forward saturation current I_{S} of the diode (or the bipolar transistor connected as diode) D1 or D2, VA and VB may be expressed as

$${V}_{A} = {V}_{T} ln \{ \frac{{( \sqrt{4 {K}_{1} {R}_{5} \sqrt{β} \sqrt{{I}_{2}} + 1} - 1 )}^{2}}{4 {K}_{1} β {R}_{5}^{2} {I}_{s}} \} \qquad ( 196 )$$

$${V}_{B} = \frac{{R}_{3}}{{R}_{2} + {R}_{3}} \{ {R}_{1} {I}_{2} + {V}_{T} ln ( \frac{{I}_{2}}{{I}_{s}} ) \} \qquad ( 197 )$$

Since VA=VB, the equations (175) and (176) are controlled to be equal to each other. It is however difficult to show the present circuit analytically.

However, by simplification, even if the driving currents for D1 and D2 are slightly changed, the forward voltages VF1, VF2 are approximately logarithmically compressed, so that, qualitatively, no marked changes are produced.

Thus, even if the driving current I1 has a positive temperature characteristic, VA is varied with negative temperature characteristic on the order of −1.9 mV/° C. As for VB, the resistor R1 and the diodes (or bipolar transistors connected as diodes) D2 are connected in series with each other and, although the temperature characteristic of the forward voltage VF2 of D2 are negative (approximately −1.9 mV/° C.), the temperature characteristic is also compressed in keeping with the voltage-dividing resistance ratio, by the voltage-dividing resistors R2, R3. Hence, the temperature characteristic must be matched with the voltage drop by the series resistor R1.

It is therefore necessary for the positive temperature characteristic of the driving current I2 (=I3) to become smaller in magnitude to approach to negative temperature characteristic. That is, the driving current I1 assumes positive temperature characteristic, whereas the temperature characteristic of the driving current I2 (=I3) approach to about zero.

Hence, the reference voltage Vref, obtained on current-to-voltage conversion of the current I3 by the resistor R4, may be made a constant voltage having temperature characteristic cancelled out. It is noted that, by proper setting of R4, Vref may be set to 1.205V or lower, i.e. may be used as reference voltage.

The values of simulation result are shown below. If, with VDD=1.3V, K1 and R1 to R5 are set so that K1=4, R1=1 kΩ, R2=11.4 kΩ, R3=500 kΩ, R4=15 kΩ and R5=2 kΩ, the values of Vref are:

452.97 mV at −53° C.,

454.43 mV at 0° C.,

454.78 mV at 27° C. and

452.87 mV at 103° C.

so that slightly rightward tilted upside-down cup shaped characteristic has been obtained. The width of the temperature variations is suppressed to 0.43%.

### Other Embodiment of the Invention

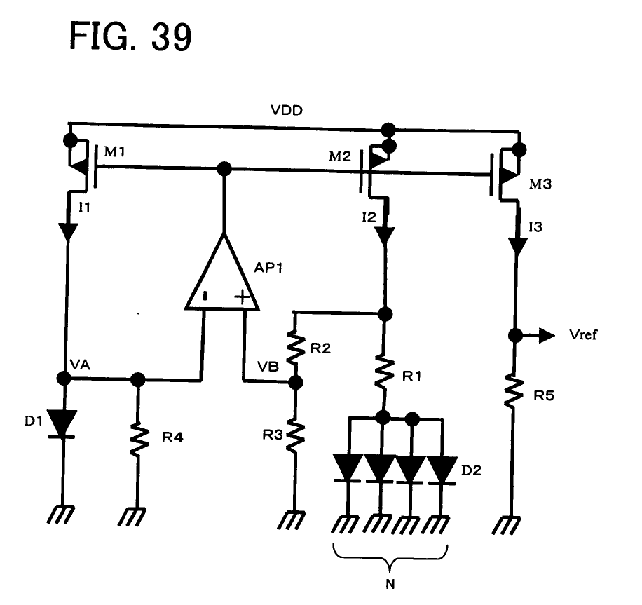

FIG. 39 depicts a diagram showing the circuit configuration of an embodiment of a CMOS reference voltage generating circuit of the present invention (claim 12). The reference voltage generating circuit shown in FIG. 39 again is of the circuit topology shown in FIG. 7.

In FIG. 39, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode D1 (or a bipolar transistor connected as diode), whereas the second current-to-voltage converter circuit is made up of diodes (or bipolar transistors connected as diodes) D2, connected in series with the resistor R1, and voltage-dividing resistors R2, R3 connected in series with the resistor/diodes.

The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four parallel-connected diodes D2 are used for the second current-to-voltage converter circuit.

The opposite terminals of the diode (or the bipolar transistor connected as diode) D1 of the first current-to-voltage converter circuit, and the resistor R4 connected in parallel therewith, are grounded, whereas the opposite terminals of the diodes (or the bipolar transistors connected as diodes) D2 of the second current-to-voltage converter circuit and the voltage-dividing resistors R2 and R3, are also grounded. The OP amp (AP1) exercises control so that the terminal voltage of the first current-to-voltage converter circuit will be equal to the divided voltage of the second current-to-voltage converter circuit.

The reference voltage Vref output has been converted from the current I3 by resistor R4.

The operation of the present embodiment is now described. Referring to FIG. 39, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 and I2 from the current mirror circuit is 1:1:1,

I₁=I₂=I₃ (198)

The driving current I1 is divided into a current I1A flowing through the diode D1 (or bipolar transistor connected as diode) and a current I1B flowing through the resistor R4. In similar manner, the current I2 is divided into a current I2A flowing common through a series connection of the resistor R1 and N parallel-connected diodes D2 (or bipolar transistors connected as diodes) and a current I2B flowing through series connection of resistors R2 and R3.

If

R3=R4 (199)

VA=VB, so that

I1B=I2B (200)

Hence,

I1A=I2A (201)

If we set

ΔVF=VF1−VF2 (202)

the currents flowing through D1 and D2 are equal to each other, so that

ΔVF=VF1−VF2=V_{T} ln(N) (203)

Since V_{T} has a positive temperature characteristic, the voltage difference has a positive temperature characteristic.

If the common terminal voltage of the resistors R1 and R2 is VX,

$${I}_{{ }^{″} B} = {I}_{1 B} = \frac{{V}_{F 1}}{{R}_{4}} \qquad ( 204 )$$

so that

$${V}_{x} = ( {R}_{2} + {R}_{3} ) {I}_{1 B} = \frac{{V}_{F 1}}{{R}_{4}} ( {R}_{2} + {R}_{3} ) \qquad ( 205 )$$

Hence, the divided current I2A is

$${I}_{2 A} = \frac{{V}_{X} - {V}_{F 2}}{{R}_{1}} = \frac{\frac{{R}_{2}}{{R}_{3}} {V}_{F 1} + Δ {V}_{F}}{{R}_{1}} \qquad ( 206 )$$

and hence the following expression

$$\begin{matrix}{I}_{3} = {I}_{2} \\ = {I}_{2 A} + {I}_{2 B} \\ = \frac{{R}_{1} + {R}_{2}}{{R}_{1} {R}_{3}} ( {V}_{F 1} + \frac{{R}_{3}}{{R}_{1} + {R}_{2}} Δ {V}_{F} ) \\ = \frac{{R}_{1} + {R}_{2}}{{R}_{1} {R}_{3}} \{ {V}_{F 1} + \frac{{R}_{3}}{{R}_{1} + {R}_{2}} {V}_{T} ln ( N ) \}\end{matrix} \qquad ( 207 )$$

may be obtained.

Hence, Vref may be obtained as

$$\begin{matrix}{V}_{ref} = {I}_{3} {R}_{5} \\ = \frac{{R}_{5} ( {R}_{1} + {R}_{2} )}{{R}_{1} {R}_{3}} \{ {V}_{F 1} + \frac{{R}_{3}}{{R}_{1} + {R}_{2}} {V}_{T} ln ( N ) \}\end{matrix} \qquad ( 208 )$$

It is noted that [VF1+{R3/(R1+R2)}V_{T} ln(N)] may be set to a voltage value on the order of 1.2V from which temperature characteristic have been cancelled out. Specifically, VF1 has a negative temperature characteristic of about −1.9 mV/° C., whereas V_{T} has a positive temperature characteristic of 0.0853 mV/° C., so that, for canceling out temperature characteristic, it is sufficient to set the value of {R3/(R1+R2)} ln(N) to about 22.27. Also, since V_{T} is 26 mV at ambient temperature, {R3/(R1+R2)}V_{T} ln(N) is about 579 mV at ambient temperature. Therefore, if VF1 is 626 mV at ambient temperature, [VF1+{R3/(R1+R2)}V_{T} ln(N)] is about 1.205V.

The reference voltage Vref, thus obtained, is a constant voltage which is divided by resistances and multiplied by R5(R1+R2){R1R3) and which may be set to 1.205V or less. That is, the reference voltage Vref is a constant voltage having temperature characteristic cancelled out so that it may be used as reference voltage.

The values of simulation result are shown below. If, with VDD=1.3V, N and R1 to R5 are set so that N=3, R1=1.445 kΩ, R2=2.7 kΩ, R3=R4=100 kΩ and R5=15 kΩ, the values of Vref are:

606.44 mV at −53° C.,

607.78 mV at 27° C. and

606.273 mV at 103° C.

so that upside-down cup shaped characteristic has been obtained. The width of the temperature variations is suppressed to about 0.25%.

### Other Embodiment of the Invention

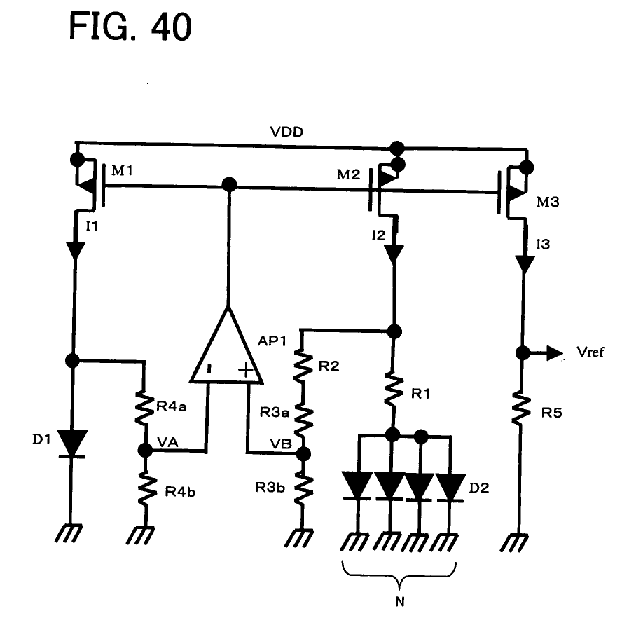

FIG. 40 depicts a diagram showing the circuit configuration of an embodiment of a CMOS reference voltage generating circuit of the present invention (claim 13). The reference voltage generating circuit, shown in FIG. 40, is of the circuit topology shown in FIG. 7.

In FIG. 39, the input voltage to the OP amp may be lowered. Referring to FIG. 40, the resistor R4, connected in parallel with D1, is split into R4a and R4b, the resistor R3 is similarly split into R3a and R3b, and R3B=R4B, the operation similar to that of FIG. 39 may be achieved by setting the mid point voltage VA of the resistors R4a and R4b so as to be equal to the mid point voltage VB of the resistors R3a and R3b, under control by the OP amp (AP1).

The values of simulation result are shown below. If, with VDD=1.3V, N and R1, R2, R3a, R3b, R4b and R5 are set so that N=3, R1=1.44 kΩ, R2+R3a=52.77 kΩ, R3a=R3b=R4b=50 kΩ and R5=15 kΩ, the values of Vref are:

615.53 mV at −53° C.,

616.99 mV at 27° C. and

615.62 mV at 103° C.

so that upside-down cup shaped characteristic has been obtained. The width of the temperature variations is suppressed to about 0.24%.

### Other Embodiment of the Invention

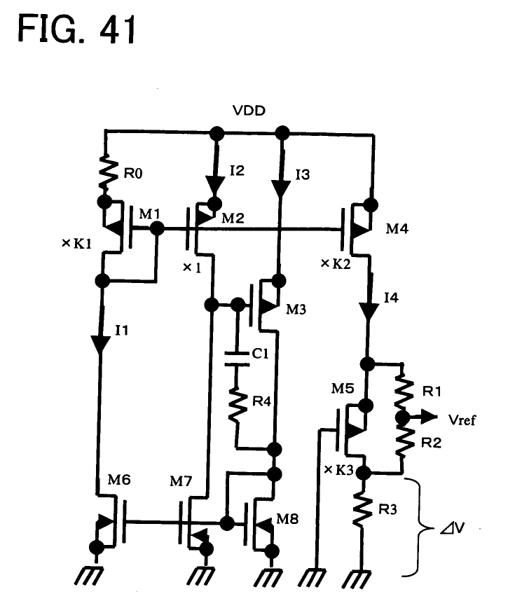

FIG. 41 depicts a diagram showing the circuit configuration of an embodiment of a CMOS reference voltage generating circuit of the present invention (claim 14). If the circuit is constituted by MOS transistors, without using diodes (or bipolar transistors connected as diodes), the chip size may be reduced. FIG. 41 shows an illustrative circuit corresponding to the reference voltage generating circuit of FIG. 33 composed only of MOS transistors without using diodes (or bipolar transistors connected as diodes).

In FIG. 41, a reference current I4 is supplied by a MOS transistor M4 from the reference current circuit used in FIGS. 33 and 35. A diode has two terminals, whereas a MOS transistor has three terminals. The driving current I4 is supplied from the source, the gate is directly grounded and the drain is grounded via resistor R3. The gate source voltage VGS has a negative temperature characteristic, however, the voltage drop across the resistor R3, connected between the ground and the drain, has a positive temperature characteristic because the resistor is driven by the driving current I3 of positive temperature characteristic. Hence, by dividing the drain-to-source voltage VDS by the resistors R1 and R2, the voltage VDS having a negative temperature characteristic may be divided and summed, whereby the reference voltage Vref, having temperature characteristic cancelled out, may be obtained at the voltage-dividing terminal.

The operation of the present embodiment is now described. In FIG. 41, the temperature characteristic of the reference current, output from the reference current circuit, used in FIGS. 33 and 35, affect the characteristics. Hence, the reference current circuit has to be analyzed.

The MOS transistors M1 and M2, with a source resistor R0, constitute an inverse-Widlar current mirror. The MOS transistors M1 and M2 are self-biased by MOS transistors M6 and M7.

A MOS transistor M8, connected as a diode, supplying the common gate voltage of the MOS transistors M6 and M7, is added so that the drain voltage of the MOS transistor M1 will be approximately equal to the drain voltage of the MOS transistor M2. A MOS transistor M3, having a gate connected to the drain of the MOS transistor M2, is used for driving. In addition, in the present circuit, a capacitor C1 and a resistor R4 for compensation are connected in series between the gate and the drain of the MOS transistor M3.

If, with the MOS transistor M2 as a unit transistor, the MOS transistor M1 is K1 (>) times the unit transistor, the drain currents I1, I2 of the MOS transistors M1, M2 may be expressed as

I1=K1β(V_{GS1}−V_{TH}) (209)

I2=β(V_{GS2}−V_{TH})²=β(V_{GS1}+I1R0−V_{TH}) (210)

If we put I1=I2 and substitute the equation (209) into the equation (210), we have

$$( \frac{1}{{K}_{1}} - 1 ) {I}_{1} + 2 {R}_{0} \sqrt{\frac{β}{{K}_{1}}} \sqrt{{I}_{1}} {I}_{1} + β {R}_{0}^{2} {I}_{1}^{2} = 0 \qquad ( 211 )$$

Dividing both sides by I1(≠0), we have

$$β {R}_{0}^{2} {I}_{1} + 2 {R}_{0} \sqrt{\frac{β}{{K}_{1}}} \sqrt{{I}_{1}} + ( \frac{1}{{K}_{1}} - 1 ) = 0 \qquad ( 212 )$$

so that a quadratic equation for √I1 (>0) is obtained.

Solving this, we have

$$\sqrt{{I}_{1}} = \frac{1 - \frac{1}{\sqrt{{K}_{1}}}}{\sqrt{β} {R}_{0}} \qquad ( 213 )$$

Hence, I1 is found to be

$${I}_{1} = \frac{{( 1 - \frac{1}{\sqrt{{K}_{1}}} )}^{2}}{β {R}_{0}^{2}} \qquad ( 214 )$$

Since the transconductance parameter 8 has a negative temperature characteristic, it may be understood that I1 (=I2=I3) has a positive temperature characteristic.

Hence,

$$Δ V = {I}_{1} {R}_{3} = \frac{{{R}_{3} ( 1 - \frac{1}{\sqrt{{K}_{1}}} )}^{2}}{β {R}_{0}^{2}} \qquad ( 215 )$$

and the reference voltage Vref may be expressed as

$$\begin{matrix}{V}_{ref} = Δ V + \frac{{R}_{2}}{{R}_{1} + {R}_{2}} ( {V}_{GS 5} - Δ V ) \\ = \frac{{R}_{2}}{{R}_{1} + {R}_{2}} ( {V}_{GS 5} + \frac{{R}_{1}}{{R}_{2}} Δ V ) \\ = \frac{{R}_{2}}{{R}_{1} + {R}_{2}} \{ {V}_{GS 5} + \frac{{R}_{1}}{{R}_{2}} \frac{{{R}_{3} ( 1 - \frac{1}{\sqrt{{K}_{1}}} )}^{2}}{β {R}_{0}^{2}} \}\end{matrix} \qquad ( 216 )$$

ΔV has a positive temperature characteristic, whereas VGS5 has a negative temperature characteristic. Hence, {VGS5+(R1/R2)ΔV} may be set for canceling out temperature characteristic. Further, by multiplication with R2/(R1+R2) (<1), the voltage can be set to a constant voltage equal to 1V or less.

The values of simulation result are shown below. If, with VDD=1.0V, N and K1 to K3 are set so that N=6, K1=K2=K3=4, and R0 to R4 and C1 are such that R0=250 kΩ, R1=500 kΩ, R2=170 kΩ, R3=300 kΩ, R4=500 kΩ and C1 is 50 pF, the values of Vref are:

406.6 mV at −53° C.,

408.38 mV at −30° C.,

406.3 mV at 0° C.,

404.95 mV at 27° C.

404.81 mV at 40° C. and

409.22 mV at 103° C.

so that a wave shaped characteristic has been obtained. The width of the temperature variations is suppressed to 1.09% for a constant power supply voltage.

### Other Embodiment of the Invention

FIG. 42 depicts a diagram showing the circuit configuration of an embodiment of a CMOS reference voltage generating circuit of the present invention (claim 15). The reference voltage generating circuit shown in FIG. 42 again is of the circuit topology shown in FIG. 7. In FIG. 42, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode (or a bipolar transistor connected as diode) D1, whereas the second current-to-voltage converter circuit is made up of parallel connection of diodes (or bipolar transistors connected as diodes) D2 and a resistor R2, and a resistor R1 connected in series with the resistor/diodes. The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a singe diode D1 is used for the first current-to-voltage converter circuit, while two to four parallel-connected diodes D2 are used for the second current-to-voltage converter circuit.

The reference voltage Vref output has been converted from the current I3 by a resistor R3.

The operation of the present embodiment is now described. Referring to FIG. 42, with the forward voltages VF1 and VF2 of the diodes (or bipolar transistors connected as diodes) D1 and D2, the OP amp (AP1) exercises control so that the voltages at the two input terminals will be equal to each other (VA=VB). Since I-V1 is a single diode, VA=VF1.

Since the current ratio of the output currents I1 to I3 from the current mirror circuit is 1:1:1,

$${I}_{1} = {I}_{2} = {I}_{3} = \frac{{V}_{F 1} - {V}_{F 2}}{{R}_{1}} = \frac{Δ {V}_{F}}{{R}_{1}} \qquad ( 217 )$$

The reference voltage Vref obtained is expressed as

V_{ref}=R₃I₃=ΔV_{F}R₃/R₁ (218)

The following expression:

$$Δ {V}_{F} = {V}_{T} ln ( \frac{N}{1 - \frac{{V}_{F 2}}{{I}_{1} {R}_{2}}} ) \qquad ( 219 )$$

is also valid.

Since V_{T} is proportional to the absolute temperature, it is varied in a range from 224/300˜1˜376/300 for temperature changes of ±76° C. The exponential value is in a range of 2.10995˜2.71828˜3.501997 corresponding to the rate of change of −22.4%˜0%˜+28.8%. However, since the width of temperature change of ±76° C. is 152°, the rate of change of 51.2% divided by the width of temperature change gives a value of −0.337%° C. at most. It appears that this order of temperature change may be taken care of by {1−V_{F1}/(I₁R₂)}/{1−V_{F2}/(I₁R₃)}.

The values of simulation result are shown below. If, with VDD=1.3V, N and R1 to R3 are set so that N=3, R1=6.8065 kΩ, R2=120 kΩ and R3=20 kΩ, the values of Vref are:

168.872 mV at −53° C.,

165.593 mV at −20° C.,

165.637 mV at 0° C.,

165.77 mV at 27° C.,

165.873 mV at 60° C. and

165.592 mV at 107° C.

so that a wave shaped characteristic has been obtained. The width of the temperature variations is suppressed to 0.17%.

### Other Embodiment of the Invention

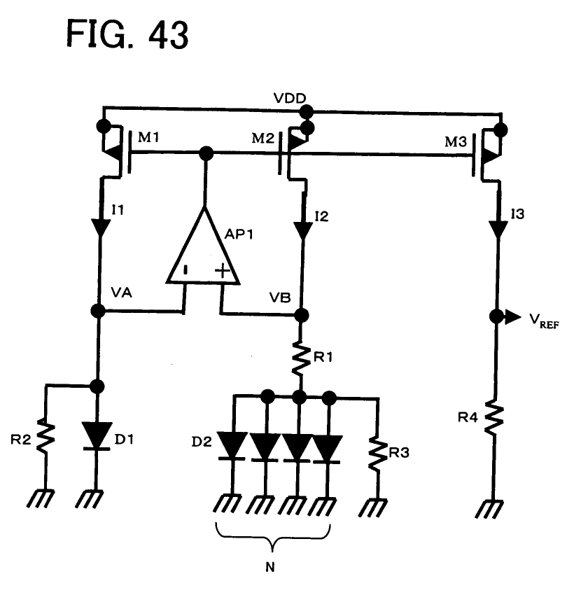

FIG. 43 depicts a diagram showing the circuit configuration of an embodiment of a CMOS reference voltage generating circuit of the present invention (claim 16). The reference voltage generating circuit, shown in FIG. 43, is again of the circuit topology shown in FIG. 7.

In FIG. 43, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other. The first current-to-voltage converter circuit for comparison is made up of parallel connection of a diode (or a bipolar transistor connected as diode) D1 and a resistor R2, whereas the second current-to-voltage converter circuit is made up of parallel connection of diodes (or bipolar transistors connected as diodes) D2 and a resistor R3, and a resistor R1 connected in series with the resistor/diodes. The number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a single diode is used for the first current-to-voltage converter circuit, while two to four parallel-connected diodes are used for the second current-to-voltage converter circuit.

The reference voltage Vref output has been converted from the current I3 by a resistor R4.

The operation of the present embodiment is now described. Referring to FIG. 43, with the forward voltages VF1 and VF2 of the diodes (or bipolar transistors connected as diodes) D1 and D2, the OP amp (AP1) exercises control so that the voltages at the two input terminals will be equal to each other (VA=VB). Since I-V1 is a parallel connection of the diode D1 and the resistor R2, VA=VF1.

Since the current ratio of the output currents I1 to I3 from the current mirror circuit is 1:1:1,

$${I}_{1} = {I}_{2} = {I}_{3} = \frac{{V}_{F 1} - {V}_{F 2}}{{R}_{1}} = \frac{Δ {V}_{F}}{{R}_{1}} \qquad ( 220 )$$

The resulting reference voltage Vref is expressed as

V_{ref}=R₄I₃=ΔV_{F}R₄/R₁ (221)

ΔVF may also be expressed as

$$Δ {V}_{F} = {V}_{T} ln \{ N ( \frac{1 - \frac{{V}_{F 1}}{{I}_{1} {R}_{2}}}{1 - \frac{{V}_{F 2}}{{I}_{1} {R}_{3}}} ) \} \qquad ( 222 )$$

Since V_{T} is proportional to the absolute temperature, it is varied in a range from 224/300˜1˜376/300 for temperature changes of ±76° C. The exponential value is in a range of 2.10995˜2.71828˜3.501997 corresponding to the rate of change of −22.4%˜0%˜+28.8%.

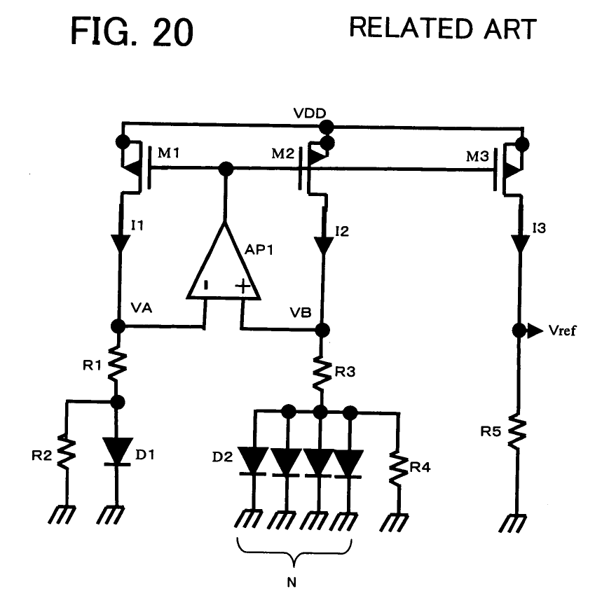

However, since the width of temperature change of ±76° C. is 152°, the rate of change of 51.2% divided by the width of temperature change gives a value of −0.337%° C. at most. It appears that this order of temperature change may be taken care of by {1−V_{F1}/(I₁R₂)}/{1−V_{F2}/(I₁R₃)}. This is equivalent to substitution of R₁ for R₃−R₁ in FIG. 20.

The values of simulation result are shown below. If, with VDD=1.3V, N and R1 to R4 are set so that N=2, R1=0.9887 kΩ, R2=70 kΩ, R3=30 kΩ and R4=20 kΩ, the values of Vref are:

709.6 mV at −53° C.,

709.145 mV at −20° C.,

709.21 mV at 0° C.,

709.425 mV at 27° C.,

709.605 mV at 60° C. and

709.221 mV at 107° C.

so that a wave shaped characteristic has been obtained. The width of the temperature variations is suppressed to 0.0653% for a constant power supply value.

### Other Embodiment of the Invention

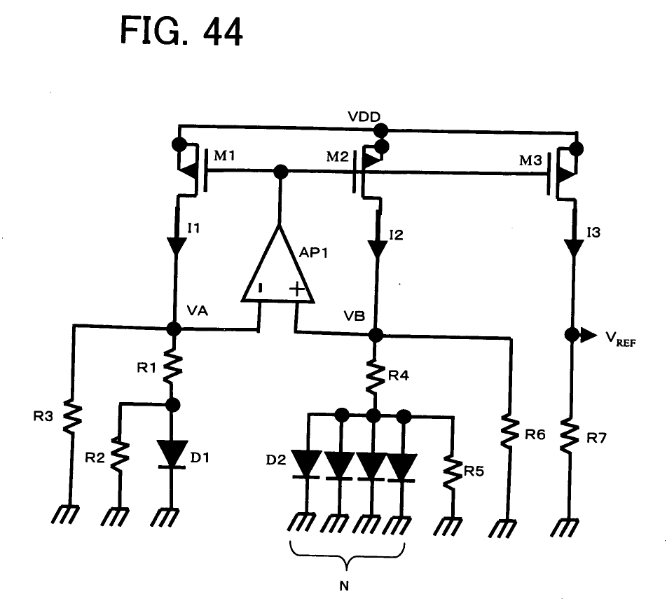

FIG. 44 depicts a diagram showing the circuit configuration of an embodiment of a CMOS reference voltage generating circuit of the present invention (claim 17). The reference voltage generating circuit, shown in FIG. 44, is the reference voltage generating circuit of FIG. 20 added by resistors connected in parallel with the first current-to-voltage converter circuit I-V1 and the second current-to-voltage converter circuit I-V2. The reference voltage generating circuit, shown in FIG. 44, is also of the circuit topology shown in FIG. 7.

In FIG. 44, MOS transistors M1 to M3 constitute a current mirror circuit with the current ratio of 1:1:1, and currents I1, I2 and I3 are caused to flow through the MOS transistors M1 to M3, respectively. The common gate voltage is controlled by the OP amp (AP1) so that two input terminal voltages of the OP amp will be equal to each other.

The first current-to-voltage converter circuit for comparison is made up of a diode (or a bipolar transistor connected as diode) D1, a resistor R2 connected in parallel with D1, a resistor R1 connected in series with D1 and R2, and a resistor R3 connected in parallel with R1, R2 and D1. The second current-to-voltage converter circuit is made up of diodes (or bipolar transistors connected as diodes) D2, a resistor R5 connected in parallel with D2, a resistor R4 connected in series with D2 and R5, and a resistor R6 connected in parallel with R4, R5 and D2.

Thus, the circuit topologies of the first and second current-to-voltage converter circuits are the same, and hence the device matching may be expected to be improved. However, the number of diodes of the first current-to-voltage converter circuit differs from that of the second current-to-voltage converter circuit. The ratio of the numbers of the parallel-connected diodes (or bipolar transistors connected as diodes) of the first and second current-to-voltage converter circuits is set to 1:N. Specifically, a sole diode D1 is used for the first current-to-voltage converter circuit, while two to four parallel-connected diodes D2 are used for the second current-to-voltage converter circuit.

The reference voltage Vref output has been converted from the current I3 by a resistor R4.

The operation of the present embodiment is now described. Referring to FIG. 44, with the forward voltages VF1 and VF2 of the diodes (or bipolar transistors connected as diodes) D1 and D2, the OP amp (AP1) exercises control so that the voltages at the two input terminals will be equal to each other (VA=VB).

Since the current ratio of the output currents I1 to I3 from the current mirror circuit is 1:1:1,

$${I}_{1} = \frac{{V}_{A} - {V}_{F 1}}{{R}_{1}} + \frac{{V}_{A}}{{R}_{3}} = \frac{{V}_{B} - {V}_{F 2}}{{R}_{4}} + \frac{{V}_{B}}{{R}_{6}} = {I}_{2} \qquad ( 223 )$$

Since the OP amp (AP1) exercises control to VA=VB,

$${I}_{1} = \frac{{V}_{A} - {V}_{F 1}}{{R}_{1}} + \frac{{V}_{A}}{{R}_{3}} = \frac{{V}_{B} - {V}_{F 2}}{{R}_{4}} + \frac{{V}_{B}}{{R}_{6}} = {I}_{2} \qquad ( 224 )$$

may be obtained from the equation (223).

Hence,

$${I}_{1} = {I}_{2} = \frac{\begin{matrix}{R}_{3} ( {R}_{4} + {R}_{6} ) {V}_{F 1} - \\ {R}_{6} ( {R}_{1} + {R}_{3} ) {V}_{F 2}\end{matrix}}{\begin{matrix}{R}_{3} {R}_{4} {R}_{6} + {R}_{1} {R}_{3} {R}_{6} - \\ {R}_{6} {R}_{1} {R}_{3} - {R}_{1} {R}_{3} {R}_{4}\end{matrix}} = {I}_{3} \qquad ( 225 )$$

The reference voltage Vref obtained may be expressed as

$$\begin{matrix}{V}_{ref} = {R}_{7} {I}_{3} \\ = \frac{{R}_{7} \{ {R}_{3} ( {R}_{4} + {R}_{6} ) {V}_{F 1} - {R}_{6} ( {R}_{1} + {R}_{3} ) {V}_{F 2} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}} \\ = \frac{{R}_{7} \{ ( {R}_{3} {R}_{4} {V}_{F 1} - {R}_{6} {R}_{1} {V}_{F 2} ) + {R}_{3} {R}_{6} Δ {V}_{F} \}}{{R}_{3} {R}_{4} {R}_{6} + {R}_{1} {R}_{3} {R}_{6} - {R}_{6} {R}_{1} {R}_{3} - {R}_{1} {R}_{3} {R}_{4}}\end{matrix} \qquad ( 226 )$$

Qualitatively, with R₃R₄>R₁R₆, (R₃R₄V_{F1}−R₁R₆V_{F2}) has a negative temperature characteristic, whereas R₃R₆ΔV_{F} has a negative temperature characteristic, resulting in cancellation of temperature characteristic.

The values of simulation result are shown below. If, with VDD=1.3V, N and R1 to R7 are set so that N=2, R1=1.2 kΩ, R2=76 kΩ, R3=97 kΩ, R4=2.00505 kΩ, R5=35 kΩ, R6=100 kΩ and R7=10 kΩ, the values of Vref are:

448.564 mV at −53° C.,

448.3898 mV at −20° C.,

448.4137 mV at 0° C.,

448.4928 mV at 27° C.,

448.5612 mV at 70° C. and

448.446 mV at 107° C.

so that a wave shaped characteristic has been obtained. The width of the temperature variations is suppressed to an extremely low value of 0.039% for a constant power supply value.

### <List of Width of Temperature Variations of the Conventional and Inventive Circuits>

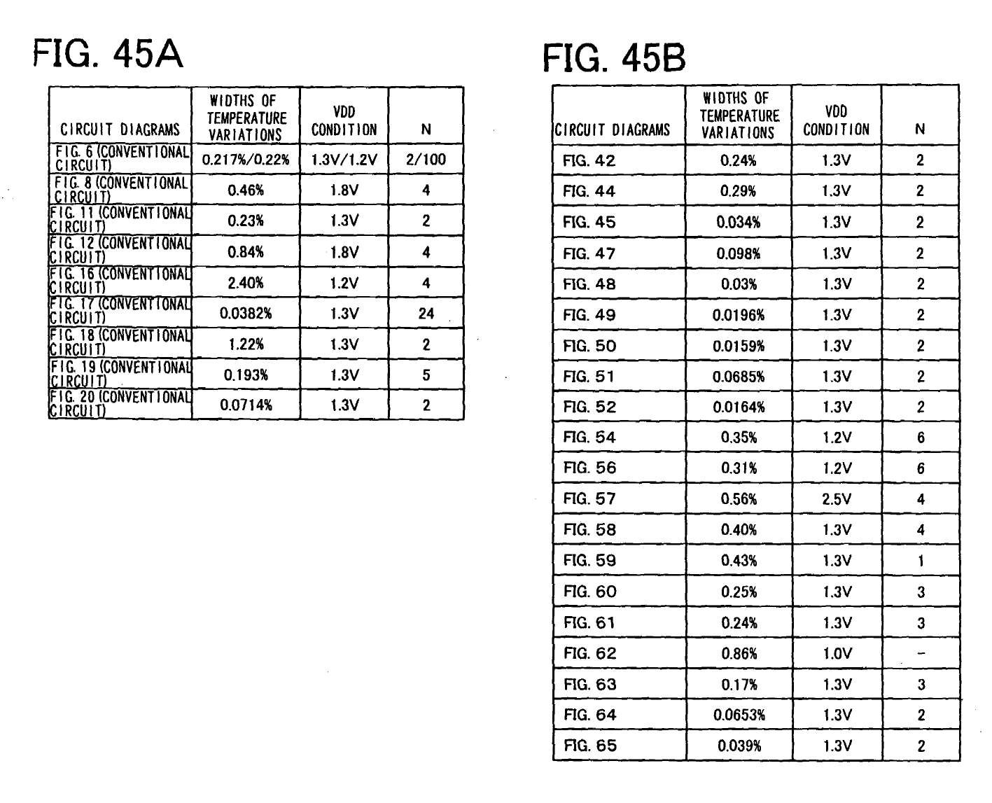

For comparing the circuit of the present invention and the conventional circuit, FIGS. 45A and 45B show the width of temperature variations of main conventional circuits and circuits of the present invention.

### Other Embodiment of the Invention

In the embodiment (FIG. 21) of the present invention (claim 1), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

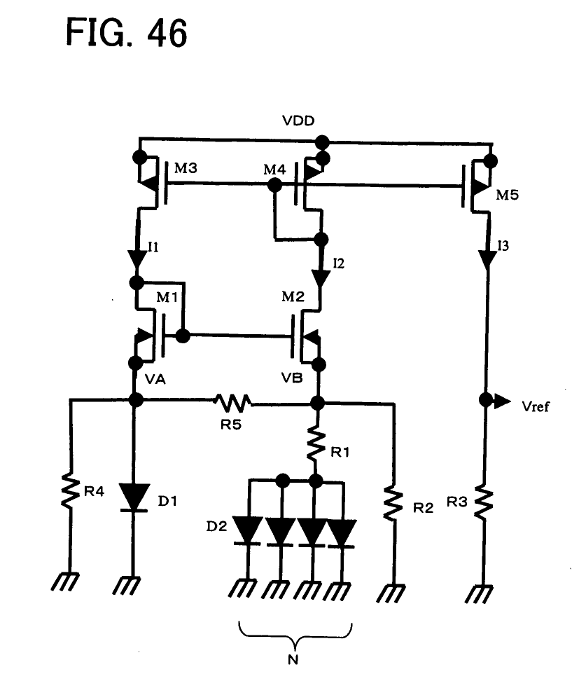

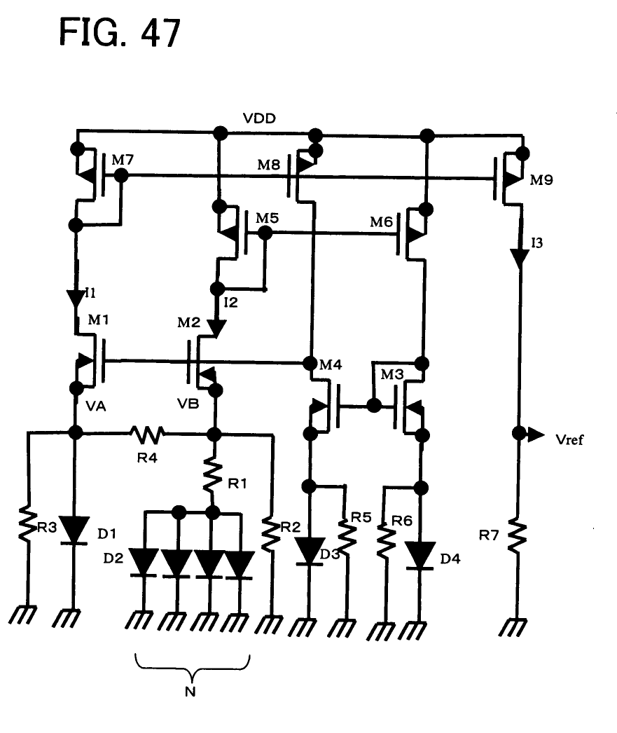

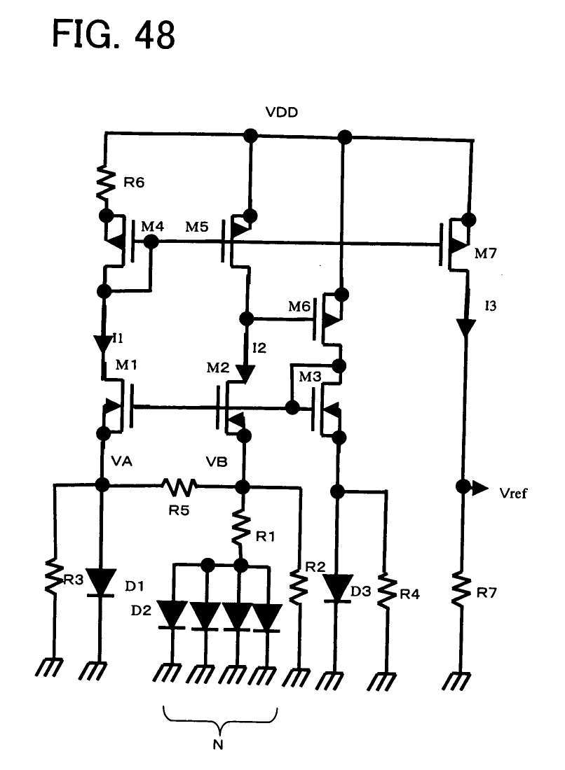

Specifically, the reference voltage generating circuit of FIG. 21 is developed as shown in FIGS. 46 to 48. For reducing the chip size, it is preferred to use the first current-to-voltage converter circuit I-V1 with a smaller number of diodes, as each of the two I-V converters in a control circuit as shown in FIGS. 47 and 48. However, the second current-to-voltage converter circuit (I-V2), with a larger number of diodes, may give the same meritorious effect insofar as the circuit operation is concerned.

In FIG. 46, the gates of n-channel transistors M1 and M2 are connected in common, and M1 has a gate and a drain connected in common. The gates of p-channel transistors M3, M4 and M5 are connected in common, and M4 has a gate and a drain connected in common. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

A resistor R5 interconnects the terminal of the first current-to-voltage converter circuit (I-V1), made up of a parallel connection of a diode D1 and a resistor R4, and the terminal of the second current-to-voltage converter circuit (I-V2), made up of a series connection of a resistor R1 and diodes D2 and a resistor R2 connected in parallel with the series connection. The current I1 flows through transistors M1, M3, and the current I2 flows through transistors M2, M4 to drive the first current-to-voltage converter circuit (I-V1), made up of parallel connection of the diode D1 and the resistor R4, and the second current-to-voltage converter circuit (I-V2), made up of series connection of the resistor R1 and the diodes D2 and the resistor R2 connected in parallel with the series connection.

The current from the transistor M5 drives the resistor R3 to generate the output voltage Vref from the terminal voltage of the resistor R3.

The operation of the present embodiment is now described. By self-biasing, the OP amp in the configuration of FIG. 21 may be dispensed with, as shown in FIG. 46. In this figure, the gates of n-channel transistors M1 and M2 are connected in common, and M1 has a gate and a drain connected together. The gates of p-channel transistors M3, M4 and M5 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA at a junction between the first current-to-voltage converter circuit (I-V1) and the resistor R5 is equal to the terminal voltage VB at a junction between the second current-to-voltage converter circuit (I-V2) and the resistor R5. The first current-to-voltage converter circuit is made up of parallel connection of the diode D1 and the resistor R4, whereas the second current-to-voltage converter circuit is made up of series connection of the resistor R1 and the parallel-connected diodes D2, and the resistor R2 connected in parallel with the series connection. Hence, the operating condition equivalent to that with the use of the OP amp, described above, may be achieved to implement the reference voltage generating circuit.

However, the above-described reference voltage generating circuit, shown in FIG. 46, may be affected by transistor channel length modulation. For simplicity, the startup circuit is dispensed with.

### Other Embodiment of the Invention

Referring to FIG. 47, a resistor R4 interconnects the terminal of the first current-to-voltage converter circuit (I-V1), made up of parallel connection of a diode D1 and a resistor R3, and the terminal of the second current-to-voltage converter circuit (I-V2), made up of series connection of a resistor R1 and diodes D2 and a resistor R2 connected in parallel with the series connection. The n-channel transistors M1 and M2, having sources connected together, and the p-channel transistors M5 and M7, connected between the drains of the n-channel transistors M1 and M2 and the power supply VDD, and having drains and gates connected together, each constitute a current mirror circuit. The n-channel transistors M3 and M4, having sources connected to two first current-to-voltage converter circuits (I-V1) and having gates connected together, also constitutes a current mirror circuit.

There are p-channel transistors M6 and M8, connected between the drains of the n-channel transistors M3 and M4 and the power supply VDD, and the n-channel transistors M1 and M2 are connected together, and connected to the drain of the n-channel transistor M4. The p-channel transistors M5 and M6 have gates connected together to constitute a current mirror circuit, whereas the p-channel transistors M7 and M9 have gates connected together to constitute a current mirror circuit.

Hence, a current I1 flows through transistors M1 and M7 to drive the first current-to-voltage converter circuit (I-V1) made up of the parallel connection of the diode D1 and the resistor R3. Similarly, a current I2 flows through transistors M2 and M5 to drive the second current-to-voltage converter circuit (I-V2), made up of series connection of the resistor R1 and diodes D2 and the resistor R2 connected in parallel with the series connection. The number of the parallel-connected diodes D2 of the second current-to-voltage converter circuit (I-V2) is N.

A current I3 flows through transistor M9 and through resistor R7. The output voltage Vref is generated from the terminal voltage of the resistor R7.

The operation of the present embodiment is now described. Referring to FIG. 47, the resistor R4 interconnects the first current-to-voltage converter circuit, made up of parallel connection of the diode D1 and the resistor R3, and the second current-to-voltage converter circuit, made up of the resistor R1, diodes D2 and the resistor connected in parallel with R1/D2. The currents flowing through the n-channel transistors M1 and M2, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and resistor R3, whereas the second current-to-voltage converter circuit is made up of series connection of the resistor R1 and diodes D2 and the resistor R2 connected in parallel with the serial connection, as described above. That is, the characteristic equivalent to that of FIG. 21 may be achieved, thus implementing a reference voltage generating circuit. The two first current-to-voltage converter circuits (I-V1) are inserted so that the drain voltages of the n-channel transistors M3 and M4 will be equal to each other.

The current I3 flows through transistor M9. This current is caused to flow into resistor R7 and the output voltage Vref is obtained from the terminal voltage of the resistor R7.

In FIG. 48, a resistor R6 is connected between the source of a p-channel transistor M4 and the power supply VDD. Since the p-channel transistor M4 has the gate voltage in common with a p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, thus decreasing the current flowing through the n-channel transistor M1.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of parallel connection of a diode D1 and a resistor R3, whereas the second current-to-voltage converter circuit is made up of series connection of a resistor R1 and diodes D2 and a resistor R2 connected in parallel with the series connection. The current I3 flows through transistor M7. This current is caused to flow into resistor R7 and the output voltage Vref is obtained from the terminal voltage of the resistor R7. That is, the characteristic equivalent to that of FIG. 21 are obtained to implement a reference voltage generating circuit.

### Other Embodiment of the Invention

In the embodiment (FIG. 23) of the present invention (claim 3), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

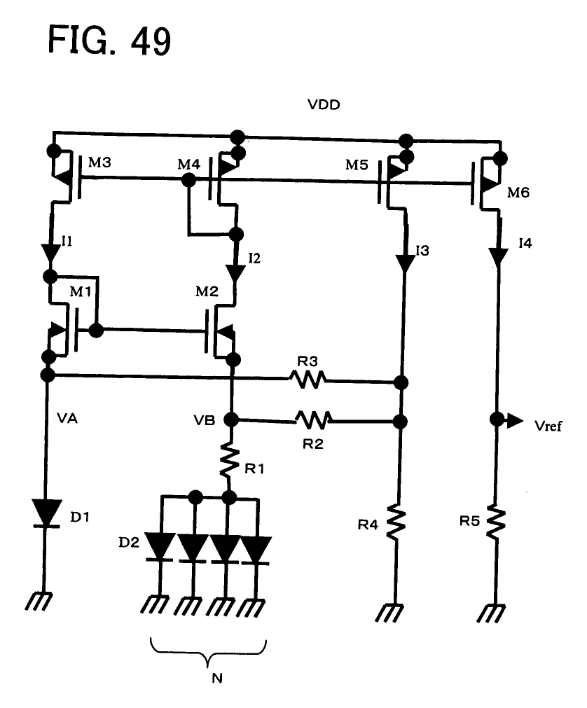

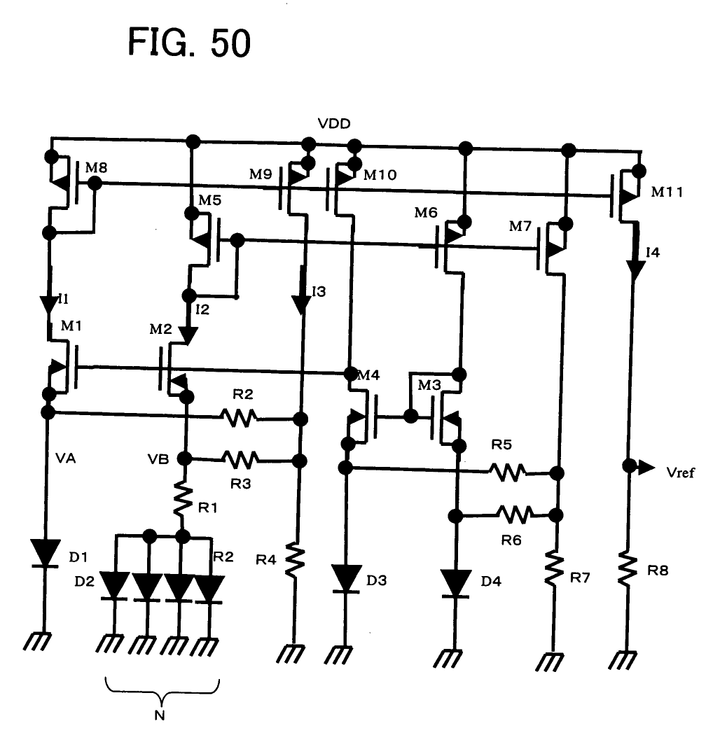

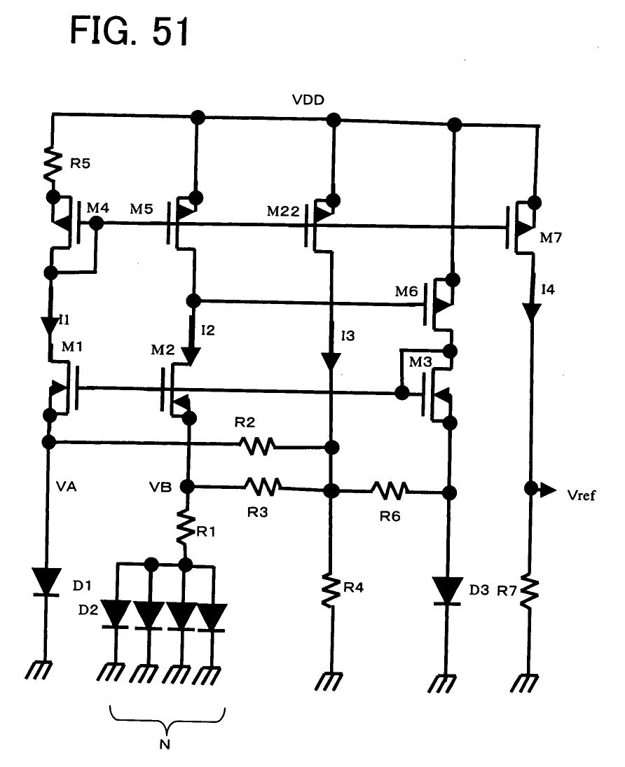

Specifically, the reference voltage generating circuit of FIG. 23 is developed as shown in FIGS. 49 to 51. For reducing the chip size, it is preferred to use the first current-to-voltage converter circuit I-V1 with a smaller number of diodes, as each of the two I-V converters in a control circuit as shown in FIGS. 50 and 51. However, the second current-to-voltage converter circuit (I-V2), with a larger number of diodes, may give the same meritorious effect insofar as the circuit operation is concerned.

In FIG. 49, the gates of n-channel transistors M1 and M2 are connected in common, and M1 has a gate and a drain connected in common. The gates of p-channel transistors M3, M4, M5 and M6 are connected in common, and M4 has a gate and a drain connected in common. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

A resistor R3 interconnects the first current-to-voltage converter circuit (I-V1), made up of a diode D1, and a resistor R4, whilst a resistor R2 interconnects the second current-to-voltage converter circuit (I-V2) made up of a series connection of a resistor R1 and diodes D2, and the resistor R4. This resistor R4 is driven by the current from the transistor M5. The current I1 flows through transistors M1, M3, and the current I2 flows through transistors M2, M4 to drive the resistors R3, R2 connected between the first current-to-voltage converter circuit (I-V1) and the second current-to-voltage converter circuit (I-V2) on one hand and the resistor R4 driven by the current from the transistor M5 on the other hand.

The current from the transistor M6 drives the resistor R5 to generate the output voltage Vref from the terminal voltage of the resistor R5.

The operation of the present embodiment is now described. By self-biasing, the OP amp in the configuration of FIG. 23 may be dispensed with, as shown in FIG. 49. In this figure, the gates of n-channel transistors M1 and M2 are connected in common, and M1 has a gate and a drain connected together. The gates of p-channel transistors M3, M4, M5 and M6 are connected in common, and M4 has a gate and a drain connected together. Hence, the n-channel transistors M1 and M2 and the p-channel transistors M3, M4, M5 and M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other. Hence, the terminal voltage VA at a junction between the first current-to-voltage converter circuit (I-V1), made up of the diode D1, and the terminal of the resistor R4, driven by the current from the transistor M5, is equal to the terminal voltage VB at a junction between the second current-to-voltage converter circuit (I-V2), made up of series connection of the resistor R1 and the diodes D2, and the terminal of the resistor R4.

Hence, the operating condition equivalent to the use of the OP amp, described above, may be achieved, thus implementing the reference voltage generating circuit. Consequently, the operating condition equivalent to that with the use of the OP amp, described above, may be achieved.

However, the above-described reference voltage generating circuit, shown in FIG. 49, may be affected by transistor channel length modulation. For simplicity, the startup circuit is dispensed with.

### Other Embodiment of the Invention

In FIG. 50, a resistor R2 interconnects the terminal of the first current-to-voltage converter circuit (I-V1), made up of a diode D1, to a resistor R4, whereas a resistor R3 interconnects the terminal of the second current-to-voltage converter circuit (I-V2), made up of series connection of a resistor R1 and diodes D2, to the resistor R4. The n-channel transistors M1 and M2, having sources connected together, and the p-channel transistors M5, M8, connected between the drains of the n-channel transistors M1 and M2 and the power supply VDD, and having drains and gates connected together, each constitute a current mirror circuit. The n-channel transistors M3 and M4, having sources connected to two first current-to-voltage converter circuits (I-V1) and having gates connected together, also constitutes a current mirror circuit.

There are p-channel transistors M6, M10, connected between the drains of the n-channel transistors M3 and M4 and the power supply VDD, and the n-channel transistors M1 and M2 are connected together, and connected to the drain of the n-channel transistor M4. The p-channel transistors M5-M7 have gates connected together to constitute a current mirror circuit, whereas the p-channel transistors M8-M11 have gates connected together to constitute a current mirror circuit. Hence, a current I1 flows through transistors M1, M8 to drive the first current-to-voltage converter circuit (I-V1), made up of the diode D1, and the resistor R2. Similarly, a current I2 flows through transistors M2 and M5 to drive the second current-to-voltage converter circuit (I-V2), made up of a series connection of a resistor R1 and diodes D2. The number of the parallel-connected diodes D2 of the second current-to-voltage converter circuit (I-V2) is N.

A current I4 flows through transistor M11 and through resistor R8. The output voltage Vref is produced from the terminal voltage of the resistor R8.

The operation of the present embodiment is now described. In FIG. 50, the resistor R2 interconnects the terminal of the first current-to-voltage converter circuit, made up of the diode D1, to the resistor R4, whereas the resistor R3 interconnects the terminal of the second current-to-voltage converter circuit (I-V2), made up of series connection of the resistor R1 and the diodes D2, to the resistor R4. The resistor R4 is driven from the current from transistor M9. The currents flowing through the n-channel transistors M1 and M2, are compared to each other via the current mirror circuit made up of the p-channel transistors M5-M7 and the current mirror circuit made up of the p-channel transistors M8-M11, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of the diode D1, whereas the second current-to-voltage converter circuit is made up of series connection of the resistor R1 and diodes D2, as described above. Thus, the operating condition similar to that in the case of using the OP amp may be achieved. That is, the characteristic equivalent to that of FIG. 21 may be achieved, thus implementing a reference voltage generating circuit. The two first current-to-voltage converter circuits (I-V1) are inserted so that the drain voltages of the n-channel transistors M3 and M4 will be equal to each other.

The current I4 flows through transistor M11. This current is caused to flow into resistor R8 and the output voltage Vref is obtained from the terminal voltage of the resistor R8.

### Other Embodiment of the Invention

In FIG. 51, a resistor R5 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit, made up of the diode D1, and to the resistor R2, is equal to that applied to the second current-to-voltage converter circuit, made up of series connection of the resistor R1 and the diodes D2, thus achieving the same operating condition as that with the use of the OP amp as described above.

The current I4 flows through transistor M7. This current is caused to flow into resistor R7 and the output voltage Vref is obtained from the terminal voltage of the resistor R7. That is, the characteristic equivalent to that of FIG. 23 are obtained to implement a reference voltage generating circuit.

### Other Embodiment of the Invention

In the embodiment (FIG. 24) of the present invention (claim 4), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

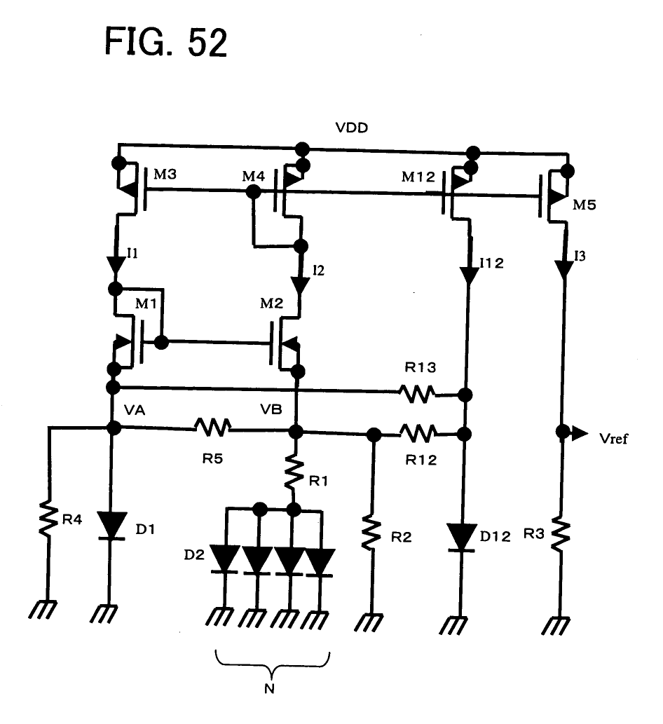

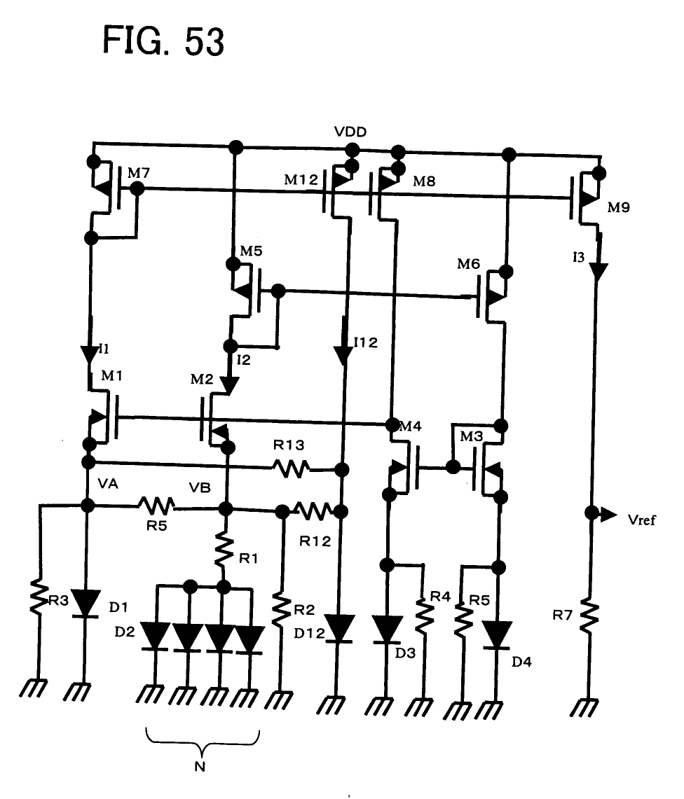

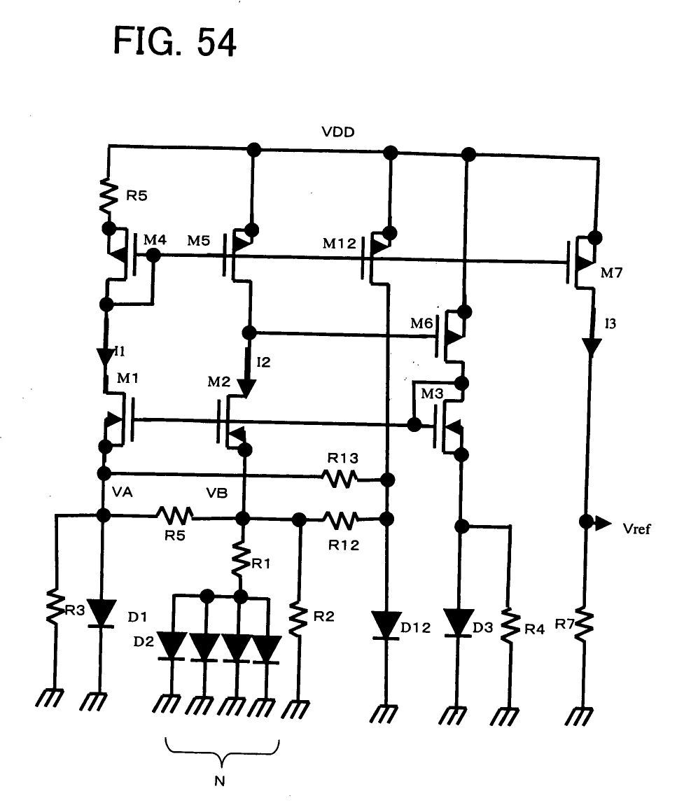

Specifically, the reference voltage generating circuit of FIG. 24 is developed as shown in FIGS. 52 to 54. For reducing the chip size, it is preferred to use the first current-to-voltage converter circuit I-V1 with a smaller number of diodes, as each of the two I-V converters in the control circuit as shown in FIGS. 53 and 54. However, the second current-to-voltage converter circuit (I-V2), with a larger number of diodes, may give the same meritorious effect insofar as the circuit operation is concerned.

In FIG. 52, the gates of n-channel transistors M1 and M2 are connected in common, and M1 has a gate and a drain connected in common. The gates of p-channel transistors M3, M4 and M5 are connected in common, and M4 has a gate and a drain connected in common. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

A resistor R5 interconnects a first current-to-voltage converter circuit (I-V1), made up of parallel connection of a diode D1 and a resistor R4, and a second current-to-voltage converter circuit (I-V2), made up of series connection of a resistor R1 and diodes D2, and a resistor R2 connected in parallel with the series connection. The current I1 flows through transistors M1, M3, and the current I2 flows through transistors M2, M4, to drive the first current-to-voltage converter circuit (I-V1), second current-to-voltage converter circuit (I-V2) and the resistor R5 connected between the terminals of the first and second current-to-voltage converter circuits.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2) via resistors R13 and R12, respectively.

The current from the transistor M5 drives the resistor R3 to generate the output voltage Vref from the terminal voltage of the resistor R3.

The operation of the present embodiment is now described. By self-biasing, the OP amp in the configuration of FIG. 24 may be dispensed with, as shown in FIG. 52. In this figure, the gates of n-channel transistors M1 and M2 are connected in common, and M1 has a gate and a drain connected together. The gates of p-channel transistors M3, M4 and M5 are connected in common, and M4 has a gate and a drain connected together. Hence, the n-channel transistors M1 and M2 and the p-channel transistors M3, M4 and M5 each constitute a current mirror circuit. The current mirror circuit of the p-channel transistors M3 and M4 self-biases the current mirror circuit of the n-channel transistors M1 and M2.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2) via resistors R13 and R12, respectively.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other. Hence the terminal voltages VA, VB of a resistor R5 connected between the first current-to-voltage converter circuit (I-V1), made up of parallel connection of the diode D1 and the resistor R4, and the second current-to-voltage converter circuit (I-V2), made up of series connection of the resistor R1 and the diodes D2, and resistor R2 connected in parallel with the series connection, become equal to each other. The resistor R5 is connected between the terminals of the first and second current-to-voltage converter circuits. Hence, the operating condition equivalent to the use of the Op amp, described above, may be achieved. That is, the characteristic similar to that of FIG. 24 may be achieved to implement the reference voltage generating circuit.

However, the above-described reference voltage generating circuit, shown in FIG. 52, may be affected by transistor channel length modulation. For simplicity, the startup circuit is dispensed with.

In FIG. 53, a resistor R5 interconnects the terminal of a first current-to-voltage converter circuit (I-V1), made up of a parallel connection of a diode D1 and a resistor R3, and the terminal of a second current-to-voltage converter circuit (I-V2), made up of a series connection of a resistor R1 and diodes D2, and a resistor R2 connected in parallel with the series connection. The n-channel transistors M1 and M2, having sources connected together, and the p-channel transistors M5 and M7, connected between the drains of the n-channel transistors M1 and M2 and the power supply VDD, and having drains and gates connected together, each constitute a current mirror circuit. The n-channel transistors M3 and M4, having sources connected to two first current-to-voltage converter circuits (I-V1) and having gates connected together, also constitutes a current mirror circuit.

There are p-channel transistors M6 and M8, connected between the drains of the n-channel transistors M3 and M4 and the power supply VDD, and the n-channel transistors M1 and M2, are connected together, and connected to the drain of the n-channel transistor M4. The p-channel transistors M5-M6 have gates connected together to constitute a current mirror circuit, whereas the p-channel transistors M7-M9 have gates connected together to constitute a current mirror circuit.

Hence, a current I1 flows through transistors M1, M7 to drive the first current-to-voltage converter circuit (I-V1) made up of a parallel connection of the diode D1 and the resistor R3. Similarly, a current I2 flows through transistors M2 and M5 to drive the second current-to-voltage converter circuit (I-V2), made up of a series connection of a resistor R1 and diodes D2 and a resistor R2 connected in parallel with the series connection. The number of the parallel-connected diodes D2 of the second current-to-voltage converter circuit (I-V2) is N.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2) via resistors R13 and R12, respectively.

A current I3 flows through transistor M9 and through resistor R7. The output voltage Vref is generated from the terminal voltage of the resistor R7.

The operation of the present embodiment is now described. In FIG. 53, the resistor R5 interconnects the terminal of the first current-to-voltage converter circuit (I-V1), made up of a parallel connection of the diode D1 and the resistor R3, and the terminal of the second current-to-voltage converter circuit (I-V2), made up of a series connection of the resistor R1 and diodes D2, and the resistor R2 connected in parallel with the series connection. The currents flowing through the n-channel transistors M1 and M2, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and the resistor R3, and the second current-to-voltage converter circuit (I-V2) is made up of series connection of the resistor R1 and diodes D2, and the resistor R2 connected in parallel with the series connection, as described above. Hence, the operating condition similar to that in the case of using the OP amp may be achieved, thereby implementing a reference voltage generating circuit.

The two first current-to-voltage converter circuits (I-V1) are inserted so that the drain voltages of the n-channel transistors M3 and M4 will be equal to each other.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The current I3 flows through transistor M9. This current is caused to flow into resistor R7, and the output voltage Vref is obtained from the terminal voltage of the resistor R7.

### Other Embodiment of the Invention

In FIG. 54, a resistor R5 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, thus decreasing the current flowing through the n-channel transistor

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of the parallel connection of the diode D1 and the resistor R3, while the second current-to-voltage converter circuit is made up of the series connection of the resistor R1 and the diodes D2 and the resistor R2 connected in parallel with the series connection.

The p-channel MOS transistor M12 is added to compensate for non-linearity of diodes, in order to drive the diode D12 and in order to supply the compensating currents between the terminal voltage of the diode D12 and the first current-to-voltage converter circuit (I-V1) and between the terminal voltage of the diode D12 and the second current-to-voltage converter circuit (I-V2), via resistors R13 and R12, respectively.

The current I3 flows through transistor M7. This current is caused to flow into resistor R7 and the output voltage Vref is obtained from the terminal voltage of the resistor R7.

That is, the characteristic equivalent to that of FIG. 24 are obtained to implement a reference voltage generating circuit.

### Other Embodiment of the Invention

In the embodiment (FIG. 26) of the present invention (claim 4), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

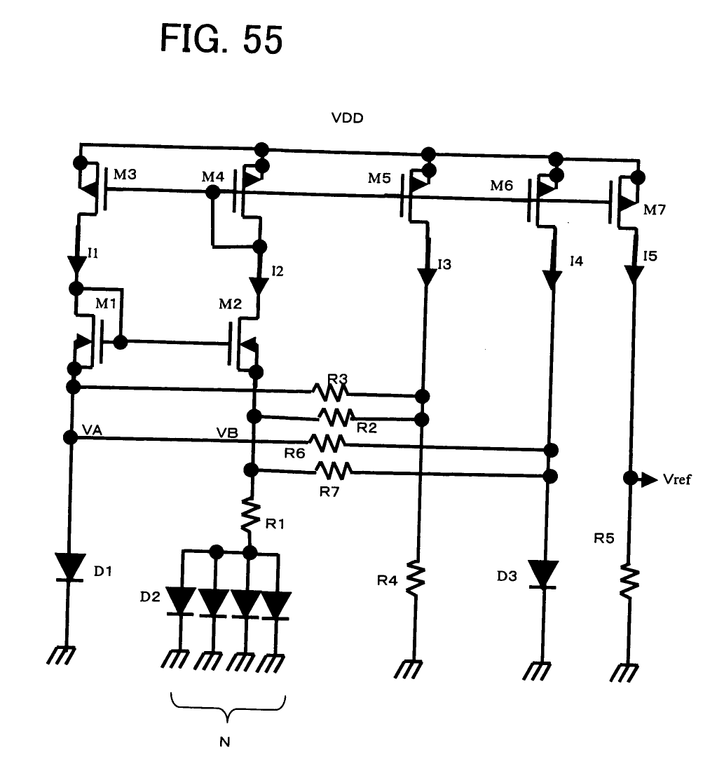

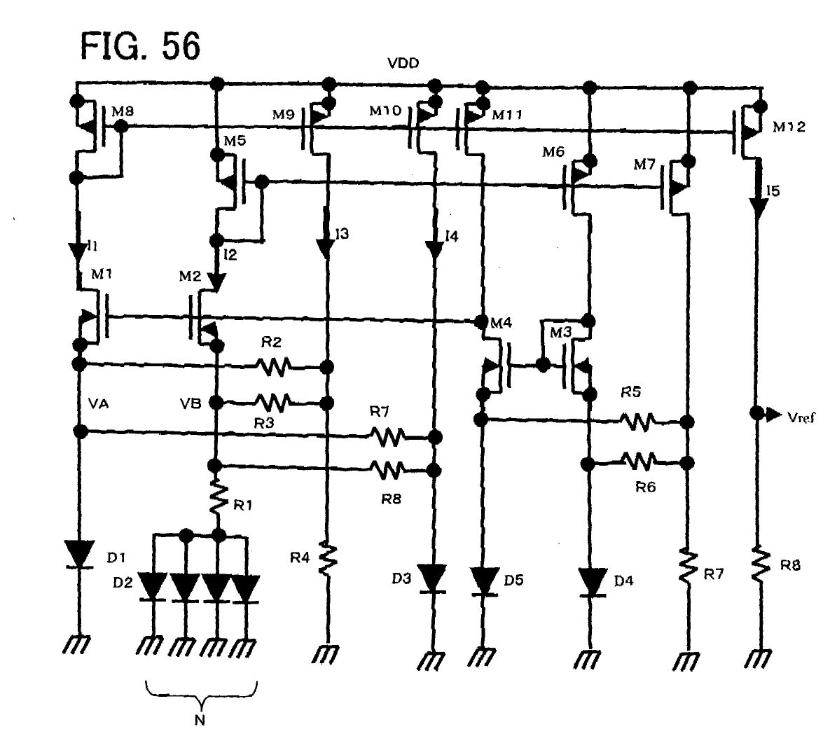

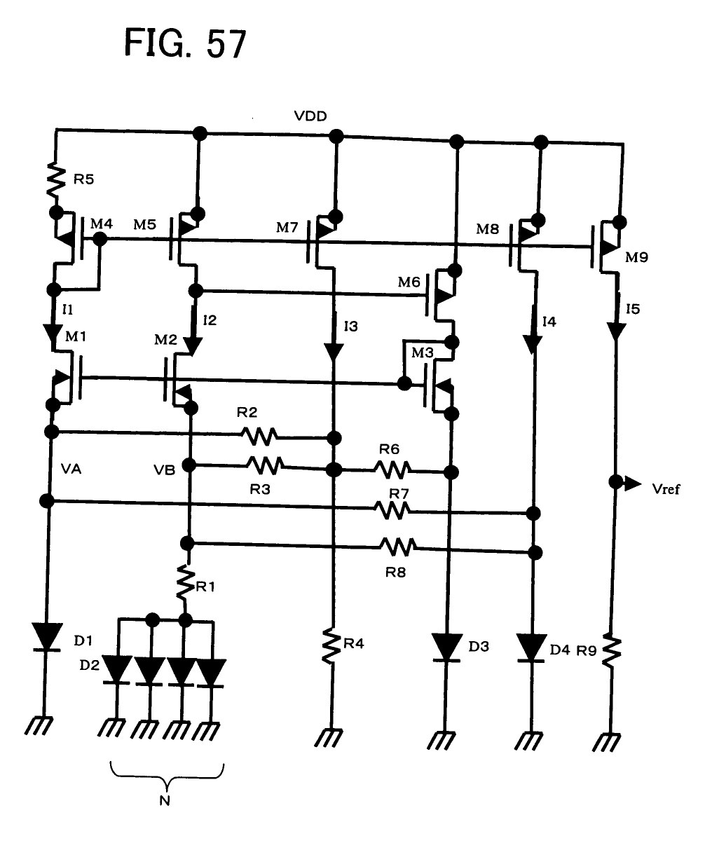

Specifically, the reference voltage generating circuit of FIG. 26 is developed as shown in FIGS. 55 to 57. For reducing the chip size, it is preferred to use the first current-to-voltage converter circuit I-V1 with a smaller number of diodes, as each of the two I-V converters in the control circuit as shown in FIGS. 56 and 57. However, the second current-to-voltage converter circuit (I-V2), with a larger number of diodes, may give the same meritorious effect insofar as the circuit operation is concerned.

In FIG. 55, the gates of n-channel transistors M1 and M2 are connected in common, and M1 has a gate and a drain connected in common. The gates of p-channel transistors M3 to M7 are connected in common, and M4 has a gate and a drain connected in common. Hence, the n-channel transistors M1 and M2 and the p-channel transistors M3 to M7 each constitute a current mirror circuit. The current mirror circuit of the p-channel transistors M3 and M4 self-biases the current mirror circuit of the n-channel transistors M1 and M2.

A resistor R3 interconnects the first current-to-voltage converter circuit (I-V1), made up of a diode D1, to a terminal of a resistor R4, driven by the current from the transistor M5, whereas a resistor R2 interconnects the second current-to-voltage converter circuit (I-V2), made up of a series connection of a resistor R1 and diodes D2, to a terminal of the resistor R4. The current I1 flows through transistors M1 and M3, and the current I2 flows through transistors M2, M4, such as to drive the resistor R3 connected between terminal of the resistor R5 driven by the current from the transistor M5 and the first current-to-voltage converter circuit (I-V1) and the resistor R2 connected between terminal of the resistor R5 and the second current-to-voltage converter circuit (I-V2).

The n-channel MOS transistor M6 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D3 and the second current-to-voltage converter circuit (I-V2), via resistors R6 and R7, respectively.

The current I5 from the transistor M7 drives the resistor R5 to generate the output voltage Vref from the terminal voltage of the resistor R5.

The operation of the present embodiment is now described. By self-biasing, the OP amp in the configuration of FIG. 26 may be dispensed with, as shown in FIG. 55. In this figure, the gates of n-channel transistors M1 and M2 are connected in common, and M1 has a gate and a drain connected together. The gates of p-channel transistors M3 to M7 are connected in common, and M4 has a gate and a drain connected together.

Hence, the n-channel transistors M1 and M2 and the p-channel transistors M3 to M7 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

The n-channel MOS transistor M6 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D3 and the second current-to-voltage converter circuit (I-V2), via resistors R6 and R7, respectively.

With self-biasing, the gate source voltages of the n-channel transistors M1 and M2 become equal to each other. Hence the terminal voltage VA of the resistor R3 connected between the first current-to-voltage converter circuit (I-V1), made up of a diode D1, and the terminal of a resistor R4, driven by the current from the transistor M5, is equal to the terminal voltage VB of the resistor R2 connected between the second current-to-voltage converter circuit (I-V2), made up of a series connection of the resistor R1 and the diodes D2, and the terminal of the resistor R4. Hence, the operating condition equivalent to the use of the Op amp, described above, may be achieved. That is, the characteristic similar to that of FIG. 26 may be achieved to implement the reference voltage generating circuit.

However, the above-described reference voltage generating circuit, shown in FIG. 55, may be affected by transistor channel length modulation. For simplicity, the startup circuit is dispensed with.

### Other Embodiment of the Invention

In FIG. 56, n-channel transistors M1 and M2, n-channel transistors M5 and M8 and n-channel transistors M3 and M4 each constitute current mirror circuits. The resistor R3 interconnects the first current-to-voltage converter circuit (I-V1), made up of the diode D1, to a terminal of the resistor R4, driven by the current from the transistor M9, whilst the resistor R2 interconnects the second current-to-voltage converter circuit (I-V2), made up of series connection of the resistor R1 and diodes D2, to the terminal of the resistor R4. The n-channel transistors M1 and M2 have sources connected to the resistors R2, R3, respectively. The p-channel transistors M5, M8 are connected between the drains of the n-channel transistors M1 and M2 and the power supply VDD, and have drains and gates connected together. The n-channel transistors M3 and M4 have sources connected to two first current-to-voltage converter circuits (I-V1), while having gates connected together. There are p-channel transistors M6, M11, connected between the drains of the n-channel transistors M3 and M4 and the power supply VDD, and the gates of the n-channel transistors M1 and M2, are connected together, and connected to the drain of the n-channel transistor M4. The p-channel transistors M5-M7 have gates connected together to constitute a current mirror circuit, whereas the p-channel transistors M8-M12 have gates connected together to constitute a current mirror circuit.

Hence, a current I1 flows through transistors M1, M8 to drive the first current-to-voltage converter circuit (I-V1), made up of the diode D1, and the resistor R2. Similarly, a current I2 flows through transistors M2 and M5 to drive the second current-to-voltage converter circuit (I-V2), made up of a series connection of a resistor R1 and diodes D2, and a resistor R3.

The n-channel MOS transistor M10 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D3 and the second current-to-voltage converter circuit (I-V2), via resistors R6 and R7, respectively.

The number of the parallel-connected diodes D2 of the second current-to-voltage converter circuit (I-V2) is N.

A current I5 flows through transistor M12 and through resistor R8. The output voltage Vref is generated from the terminal voltage of the resistor R8.

The operation of the present embodiment is now described. In FIG. 56, the resistor R2 interconnects the first current-to-voltage converter circuit (I-V1), made up of the diode D1, to a terminal of the resistor R4, driven by the current from the transistor M9, whilst the resistor R3 interconnects the second current-to-voltage converter circuit (I-V2), made up of series connection of the resistor R1 and diodes D2, to a terminal of the resistor R4. The currents flowing through the n-channel transistors M1 and M2, are compared to each other via the current mirror circuit made up of the p-channel transistors M5-M7 and the current mirror circuit made up of the p-channel transistors M8-M12, in the current mirror circuit made up of the n-channel transistors M3 and M4. The common gate voltage of the n-channel transistors M1 and M2 is controlled so that the currents flowing through the n-channel transistors M1 and M2 will be equal to each other.

The p-channel MOS transistor M10 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D12 and the second current-to-voltage converter circuit (I-V2) via resistors R7 and R8, respectively.

Since the gate source voltages of the n-channel transistors M1 and M2 become equal to each other, the voltage VA applied to the first current-to-voltage converter circuit and to the resistor R2 becomes equal to the voltage VB applied to the second current-to-voltage converter circuit and to the resistor R3, thus achieving the same operating condition as that of using the OP amp as described above. The first current-to-voltage converter circuit is made up of the diode D1, and the second current-to-voltage converter circuit (I-V2) is made up of series connection of the resistor R1 and diodes D2, as described above. Hence, the operating condition similar to that in the case of using the OP amp may be achieved. That is, the characteristic equivalent to that of FIG. 26, may be achieved, thus implementing a reference voltage generating circuit. The two first current-to-voltage converter circuits (I-V1) are inserted so that the drain voltages of the n-channel transistors M3 and M4 will be equal to each other.

The current I5 flows through transistor M12. This current is caused to flow into resistor R8, and the output voltage Vref is obtained from the terminal voltage of the resistor R8.

### Other Embodiment of the Invention

In FIG. 57, a resistor R5 is connected between the source of a p-channel transistor M4 and the power supply VDD. Since the p-channel transistor M4 has the gate voltage in common with a p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through a n-channel transistor M2, thus increasing the drain voltage of the p-channel transistor M5 and decreasing the current through a p-channel transistor M6, the gate of which is connected to the drain of the p-channel transistor M5. This decreases the current flowing through a p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

The p-channel MOS transistor M8 is added to compensate for non-linearity of diodes, in order to drive the diode D4 and in order to supply the compensating currents between the terminal voltage of the diode D4 and the first current-to-voltage converter circuit (I-V1) and between the terminal voltage of the diode D4 and the second current-to-voltage converter circuit (I-V2), via resistors R7 and R8, respectively.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit and to the resistor R2 is equal to that applied to the second current-to-voltage converter circuit and to the resistor R3, thus achieving the same operating condition as that with the use of the OP amp as described above. The first current-to-voltage converter circuit is made up of the diode D1, while the second current-to-voltage converter circuit is made up of the series connection of the resistor R1 and the diodes D2.

A current I5 flows through transistor M9. This current is caused to flow into resistor R9 and the output voltage Vref is obtained from the terminal voltage of the resistor R9.

That is, the characteristic equivalent to that of FIG. 26 are obtained to implement a reference voltage generating circuit.

### Other Embodiment of the Invention

In the embodiment (FIG. 27) of the present invention (claim 5), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

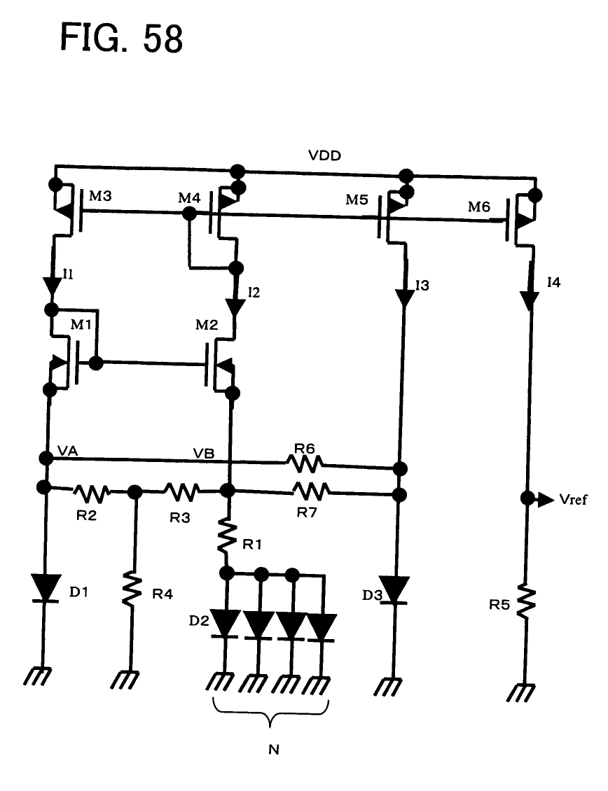

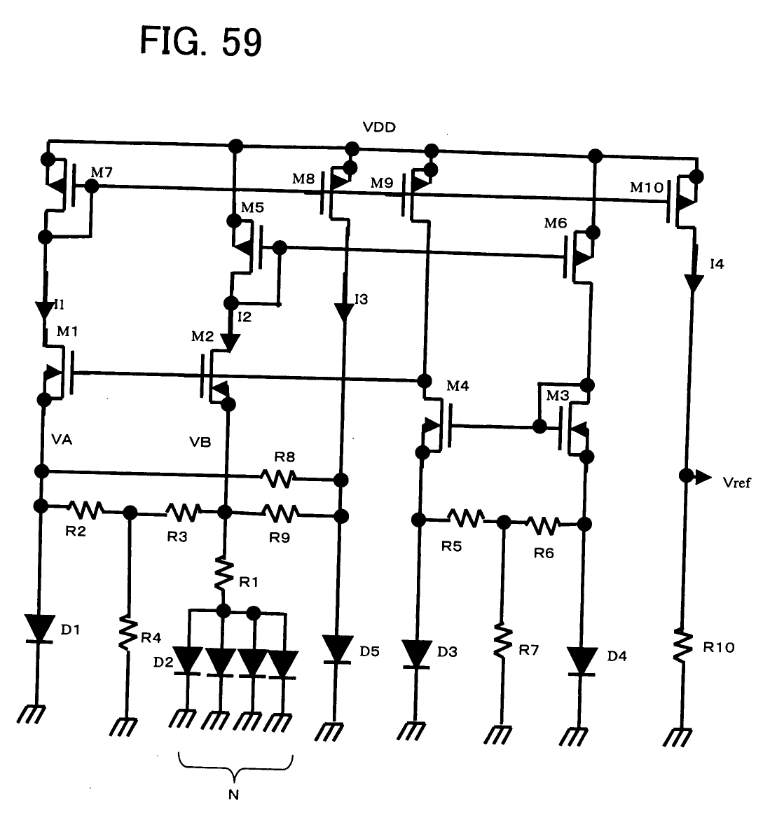

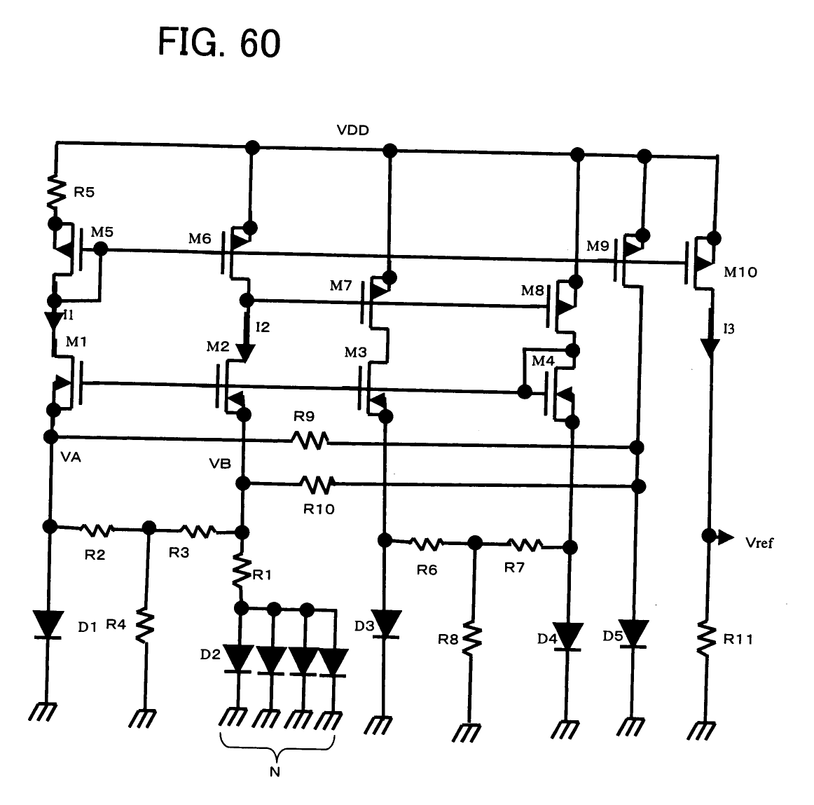

Specifically, the reference voltage generating circuit of FIG. 27 is developed as shown in FIGS. 58 to 60. For reducing the chip size, it is preferred to use the first current-to-voltage converter circuit I-V1 with a smaller number of diodes, as each of the two I-V converters in the control circuit as shown in FIGS. 59 and 60. However, the second current-to-voltage converter circuit (I-V2), with a larger number of diodes, may give the same meritorious effect insofar as the circuit operation is concerned.

In FIG. 58, the gates of n-channel transistors M1 and M2 are connected in common, and M1 has a gate and a drain connected in common. The gates of p-channel transistors M3 to M6 are connected in common, and M4 has a gate and a drain connected in common. Hence, the n-channel transistors M1 and M2 and the p-channel transistors M3 to M7 each constitute a current mirror circuit. The current mirror circuit of the p-channel transistors M3 and M4 self-biases the current mirror circuit of the n-channel transistors M1 and M2.

A first current-to-voltage converter circuit (I-V1), made up of a diode D1, and a second current-to-voltage converter circuit (I-V2), made up of a series connection of a resistor R1 and diodes D2, are interconnected by T-resistors resistors R2 to R4. The current I1 flows through transistors M1, M3, and the current I2 flows through transistors M2, M4 to drive the first current-to-voltage converter circuit (I-V1), second current-to-voltage converter circuit (I-V2) and the T-resistors R2 to R4.

The n-channel MOS transistor M5 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D3 and the second current-to-voltage converter circuit (I-V2), via resistors R6 and R7, respectively.

The current I4 from the transistor M6 drives the resistor R5 to generate the output voltage Vref from the terminal voltage of the resistor R5.

The operation of the present embodiment is now described. By self-biasing, the OP amp in the configuration of FIG. 27 may be dispensed with, as shown in FIG. 58. In this figure, the gates of n-channel transistors M1 and M2 are connected in common, and M1 has a gate and a drain connected together. The gates of p-channel transistors M3 to M6 are connected in common, and M4 has a gate and a drain connected together.

Hence, the n-channel transistors M1 and M2 and the p-channel transistors M3 to M6 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other. The n-channel MOS transistor M5 is added to compensate for non-linearity of diodes, in order to drive the diode D3 and in order to supply the compensating currents between the terminal voltage of the diode D3 and the first current-to-voltage converter circuit (I-V1) and between the terminal voltage of the diode D3 and the second current-to-voltage converter circuit (I-V2), via resistors R6 and R7, respectively.

With self-biasing, the gate source voltages of the n-channel transistors M1 and M2 become equal to each other, and hence the terminal voltage VA between the T-resistors R1 to R3 and the first current-to-voltage converter circuit (I-V1), made up of the diode D1, is equal to the terminal voltage VB between the between the T-resistors R1 to R3 and the second current-to-voltage converter circuit (I-V2), made up of series connection of the resistor R1 and the diodes D2. Hence, the operating condition equivalent to the use of the OP amp, described above, may be achieved. That is, the characteristic similar to that of FIG. 27 may be achieved to implement the reference voltage generating circuit.

However, the above-described reference voltage generating circuit, shown in FIG. 58, may be affected by transistor channel length modulation. For simplicity, the startup circuit is dispensed with.

In FIG. 59, T-resistors R2 to R4 interconnect the terminal of a first current-to-voltage converter circuit (I-V1), made up of a diode D1, to the terminal of a second current-to-voltage converter circuit (I-V2), made up of a series connection of a resistor R1 and diodes D2. The n-channel transistors M1 and M2, having sources connected to the T-resistors R2 to R4, and the p-channel transistors M5 and M7, connected between the drains of the n-channel transistors M1 and M2 and the power supply VDD, and having drains and gates connected together, each constitute a current mirror circuit. The n-channel transistors M3 and M4, having sources connected to T-resistors R5 to R7 and to two diodes D3, D4, and having gates connected in common, also constitute a current mirror circuit.

There are p-channel transistors M6, M9, connected between the drains of the n-channel transistors M3 and M4 and the power supply VDD, and the n-channel transistors M1 and M2 are connected together and connected to the drain of the n-channel transistor M4. The p-channel transistors M5-M6 have gates connected together to constitute a current mirror circuit, whereas the p-channel transistors M7-M10 have gates connected together to constitute a current mirror circuit.

Hence, a current I1 flows through transistors M1, M7 to drive the first current-to-voltage converter circuit (I-V1), made up of a diode D1, and the T-resistors, from the resistor R2. Similarly, a current I2 flows through transistors M2 and M5 to drive the second current-to-voltage converter circuit (I-V2), made up of a series connection of a resistor R1 and diodes D2, and the T-resistors, from the resistor R3.

The n-channel MOS transistor M8 is added to compensate for non-linearity of diodes, in order to drive the diode D5 and in order to supply the compensating currents between the terminal voltage of the diode D5 and the first current-to-voltage converter circuit (I-V1) and between the terminal voltage of the diode D5 and the second current-to-voltage converter circuit (I-V2), via resistors R8 and R9, respectively.

The number of the parallel-connected diodes D2 of the second current-to-voltage converter circuit (I-V2) is N.

A current I4 flows through transistor M10 and through resistor R10. The output voltage Vref is generated from the terminal voltage of the resistor R10.

The operation of the present embodiment is now described. In FIG. 59, the T-resistors R2 to R4 interconnect the terminal of the first current-to-voltage converter circuit (I-V1), made up of the diode D1, to the terminal of the second current-to-voltage converter circuit (I-V2), made up of series connection of the resistor R1 and diodes D2. The currents flowing through the n-channel transistors M1 and M2, are compared to each other via the current mirror circuit made up of the p-channel transistors M5-M6 and the current mirror circuit made up of the p-channel transistors M7-M10, in the current mirror circuit made up of the n-channel transistors M3 and M4. The common gate voltage of the n-channel transistors M1 and M2 is controlled so that the currents flowing through the n-channel transistors M1 and M2 will be equal to each other.

The p-channel MOS transistor M8 is added to compensate for non-linearity of diodes, in order to drive the diode D5 and in order to supply the compensating currents between the terminal voltage of the diode D5 and the first current-to-voltage converter circuit (I-V1) and between the terminal voltage of the diode D5 and the second current-to-voltage converter circuit (I-V2) via resistors R8 and R9, respectively.

Since the gate source voltages of the n-channel transistors M1 and M2 become equal to each other, the voltage VA applied to the first current-to-voltage converter circuit and to the resistor R2 becomes equal to the voltage VB applied to the second current-to-voltage converter circuit and to the resistor R3, thus achieving the same operating condition as that of using the OP amp as described above. The first current-to-voltage converter circuit is made up of the diode D1, and the second current-to-voltage converter circuit (I-V2) is made up of a series connection of the resistor R1 and diodes D2, as described above. Hence, the operating condition similar to that in the case of using the OP amp may be achieved. That is, the characteristic equivalent to that of FIG. 27, may be achieved, thus implementing a reference voltage generating circuit. The two diodes D3, D4 and the T-resistors R5-R7 are inserted so that the drain voltages of the n-channel transistors M3 and M4 will be equal to each other.

The current I4 flows through transistor M10. This current is caused to flow into resistor R10, and the output voltage Vref is obtained from the terminal voltage of the resistor R10.

### Other Embodiment of the Invention

In FIG. 60, a resistor R5 is connected between the source of the p-channel transistor M5 and the power supply VDD. Since the p-channel transistor M5 has the gate voltage in common with the p-channel transistor M6, the transistor size of the p-channel transistor M5 is selected to be larger than that of the p-channel transistor M6 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M5 is correspondingly increased. However, the current flowing through the p-channel transistor M6 becomes larger than the increased current through the p-channel transistor M4. Hence, the so increased current cannot flow through the n-channel transistor M2, thus increasing the drain voltage of the p-channel transistor M6 and decreasing the current through the p-channel transistor M7, the gate of which is connected to the drain of the p-channel transistor M6. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

The p-channel MOS transistor M9 is added to compensate for non-linearity of diodes, in order to drive the diode D5 and in order to supply the compensating currents between the terminal voltage of the diode D5 and the first current-to-voltage converter circuit (I-V1) and between the terminal voltage of the diode D5 and the second current-to-voltage converter circuit (I-V2) via resistors R9 and R10, respectively.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit and to the resistor R2 is equal to that applied to the second current-to-voltage converter circuit and to the resistor R3, thus achieving the same operating condition as that with the use of the OP amp as described above. The first current-to-voltage converter circuit is made up of the diode D1, while the second current-to-voltage converter circuit is made up of the series connection of the resistor R1 and the diodes D2.

The current I3 flows through transistor M10. This current is caused to flow into resistor R11 and the output voltage Vref is obtained from the terminal voltage of the resistor R11.

That is, the characteristic equivalent to that of FIG. 27, may be achieved, thus implementing a reference voltage generating circuit.

### Other Embodiment of the Invention

In the embodiment (FIG. 42) of the present invention (claim 15), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

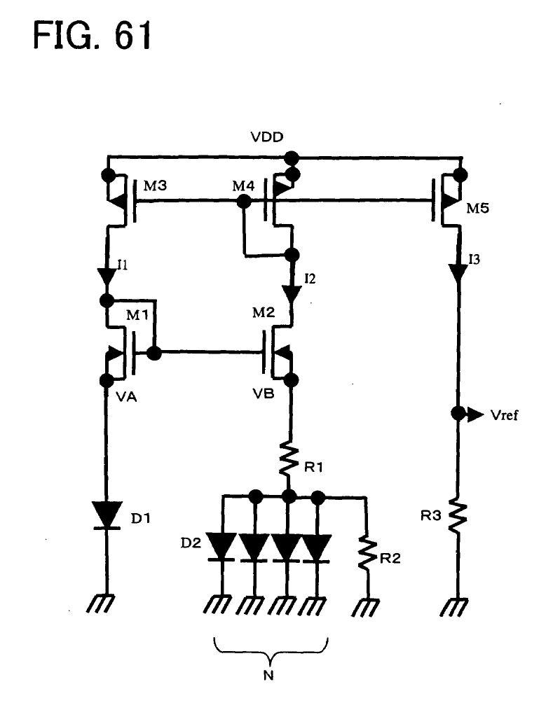

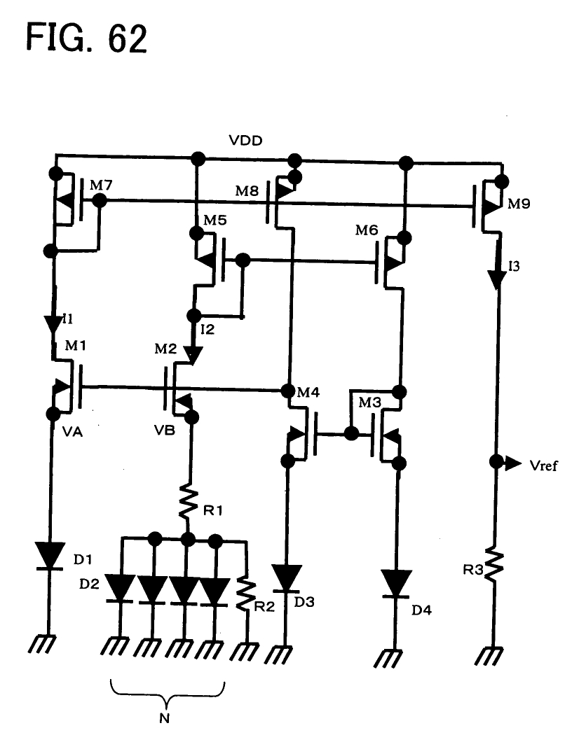

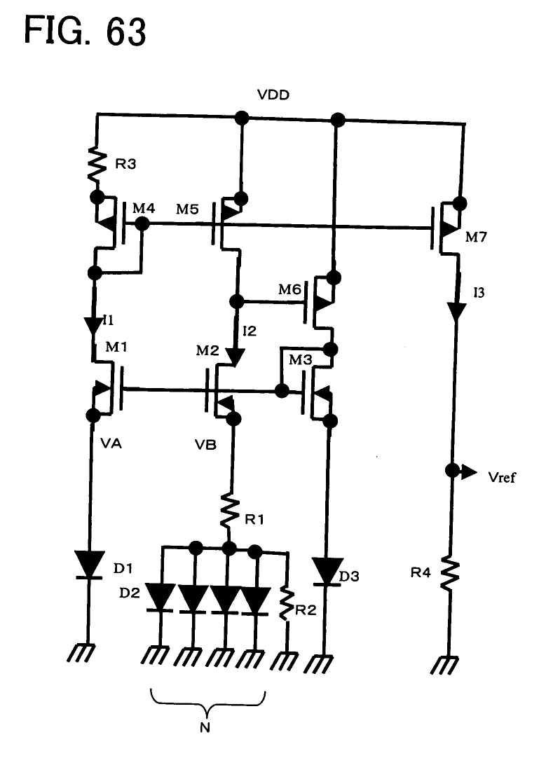

Specifically, the reference voltage generating circuit of FIG. 42 is developed as shown in FIGS. 61 to 63. For reducing the chip size, it is preferred to use the first current-to-voltage converter circuit I-V1 with a smaller number of diodes, as each of the two I-V converters in the control circuit as shown in FIGS. 62 and 63. However, the second current-to-voltage converter circuit (I-V2), with a larger number of diodes, may give the same meritorious effect insofar as the circuit operation is concerned.

In FIG. 61, the gates of n-channel transistors M1 and M2 are connected in common, and M1 has a gate and a drain connected in common. The gates of p-channel transistors M3 to M6 are connected in common, and M4 has a gate and a drain connected in common.

Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2. The current I1 flows through transistors M1, M3 to drive the first current-to-voltage converter circuit (I-V1), made up of the diode D1, whereas the current I2 flows through transistors M2, M4 to drive the second current-to-voltage converter circuit (I-V2), made up of a series connection of the resistor R1 and diodes D2 and the resistors R2 connected in parallel with the diodes.

The current I3 from the transistor M5 drives the resistor R3 to generate the output voltage Vref from the terminal voltage of the resistor R3.

The operation of the present embodiment is now described. By self-biasing, the OP amp in the configuration of FIG. 42 may be dispensed with, as shown in FIG. 61. In this figure, the gates of n-channel transistors M1 and M2 are connected in common, and M1 has a gate and a drain connected together. The gates of p-channel transistors M3 to M5 are connected in common, and M4 has a gate and a drain connected together.

Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA of the first current-to-voltage converter circuit (I-V1), made up of the diode D1, is equal to the terminal voltage VB of the second current-to-voltage converter circuit (I-V2), made up of series connection of the resistor R1 and the diodes D2 and the resistor R2 connected in parallel with the series connection. Hence, the operating condition equivalent to the use of the OP amp, described above, may be achieved. That is, the characteristic similar to that of FIG. 42 may be achieved to implement the reference voltage generating circuit.

However, the above-described reference voltage generating circuit, shown in FIG. 61, may be affected by transistor channel length modulation. For simplicity, the startup circuit is dispensed with.

### Other Embodiment of the Invention

In FIG. 62, the terminal of a first current-to-voltage converter circuit (I-V1), made up of a diode D1, and the terminal of a second current-to-voltage converter circuit (I-V2), made up of series connection of a resistor R1 and diodes D2 and a resistor R2 connected in parallel with the series connection, are connected to the sources of n-channel transistors M1 and M2, respectively. These n-channel transistors M1 and M2, p-channel transistors M5 and M7, and n-channel transistors M3 and M4, each constitute a current mirror circuit. The p-channel transistors M5 and M7 are connected between the drains of the n-channel transistors M1 and M2 and the power supply VDD, and have drains and gates connected together, whereas the n-channel transistors M3 and M4 have sources connected to two diodes D3, D4, and have gates coupled together.

There are p-channel transistors M6, M9, connected between the drains of the n-channel transistors M3 and M4 and the power supply VDD, and the gates of the n-channel transistors M1 and M2 are connected together and connected to the drain of the n-channel transistor M4. The p-channel transistors M5-M6 have gates connected together to constitute a current mirror circuit, whereas the p-channel transistors M7-M9 have gates connected together to constitute a current mirror circuit.

Hence, a current I1 flows through transistors M1, M7 to drive the first current-to-voltage converter circuit (I-V1) made up of the diode D1. Similarly, a current I2 flows through transistors M2 and M5 to drive the second current-to-voltage converter circuit (I-V2), made up of series connection of the resistor R1 and diodes D2 and the resistor R2 connected in parallel with the series connection.

The number of the parallel-connected diodes D2 of the second current-to-voltage converter circuit (I-V2) is N.

A current I3 flows through transistor M9 and thence through resistor R3. The output voltage Vref is generated from the terminal voltage of the resistor R3.

The operation of the present embodiment is now described. In FIG. 62, there are provided the first current-to-voltage converter circuit, made up of the diode D1, and the second current-to-voltage converter circuit (I-V2), made up of the resistor R1, diodes D2 and the resistor R2 connected in parallel with the diodes D2. The currents flowing through the n-channel transistors M1 and M2, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of the diode D1, and the second current-to-voltage converter circuit is made up of series connection of the resistor R1 and diodes D2 and the resistor R2 connected in parallel with the diodes, as described above. Hence, the operating condition similar to that in the case of using the OP amp may be achieved. That is, the characteristic equivalent to that of FIG. 42 may be achieved, thus implementing a reference voltage generating circuit. The two diodes D3, D4 are inserted so that the drain voltages of the n-channel transistors M3 and M4 will be equal to each other.

The current I3 flows through transistor M9. This current is caused to flow into resistor R3, and the output voltage Vref is obtained from the terminal voltage of the resistor R3.

In FIG. 63, a resistor R3 is connected between the source of the p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of the diode D1, while the second current-to-voltage converter circuit is made up of the series connection of the resistor R1 and the diodes D2 and the resistor R2 connected in parallel with the diodes D2, as described above.

The current I3 flows through transistor M7. This current is caused to flow into resistor R4 and the output voltage Vref is obtained from the terminal voltage of the resistor R4.

That is, the characteristic equivalent to that of FIG. 42, may be achieved, thus implementing a reference voltage generating circuit.

### Other Embodiment of the Invention

In the embodiment (FIG. 43) of the present invention (claim 16), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

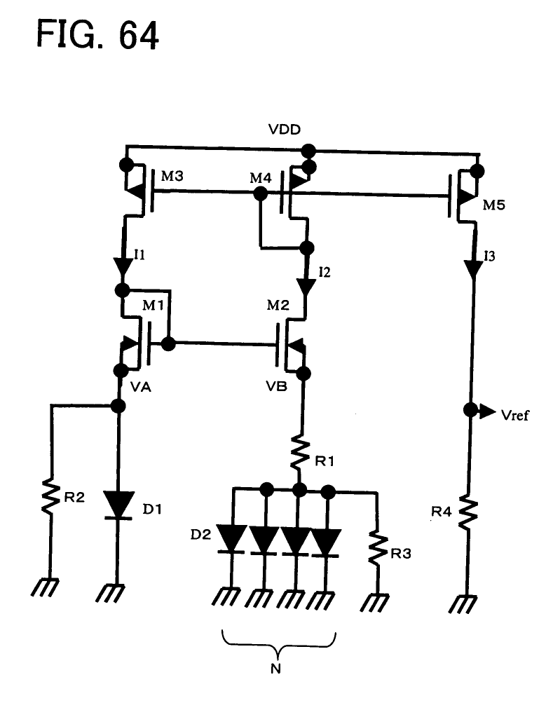

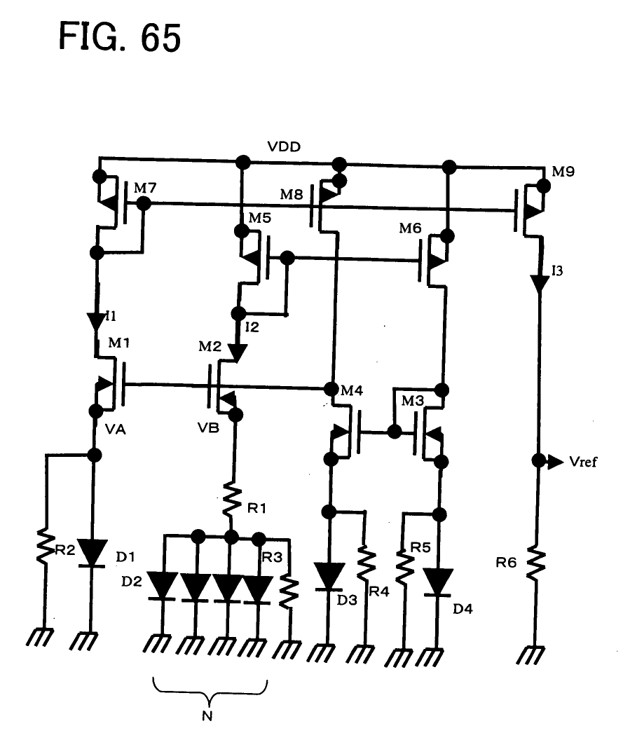

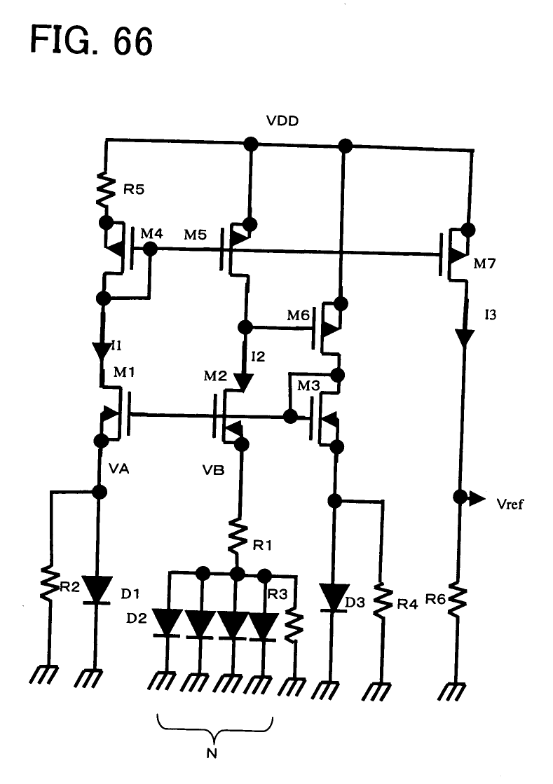

Specifically, the reference voltage generating circuit of FIG. 43 is developed as shown in FIGS. 64 to 66. For reducing the chip size, it is preferred to use the first current-to-voltage converter circuit I-V1 with a smaller number of diodes, as each of the two I-V converters in the control circuit as shown in FIGS. 65 and 66. However, the second current-to-voltage converter circuit (I-V2), with a larger number of diodes, may give the same meritorious effect insofar as the circuit operation is concerned.

In FIG. 64, the gates of n-channel transistors M1 and M2 are connected in common, and M1 has a gate and a drain connected in common. The gates of p-channel transistors M3 to M6 are connected in common, and M4 has a gate and a drain connected in common. Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2.

The current I1 flows through transistors M1, M3 to drive the first current-to-voltage converter circuit (I-V1), made up of parallel connection of the diode D1 and the resistor R2, whereas the current I2 flows through transistors M2, M4 to drive the second current-to-voltage converter circuit (I-V2), made up of a series connection of a resistor R1 and diodes D2 and the resistors R3 connected in parallel with the diodes D2.

The current I3 from the transistor M5 drives the resistor R4 to generate the output voltage Vref from the terminal voltage of the resistor R4.

The operation of the present embodiment is now described. By self-biasing, the OP amp in the configuration of FIG. 43 may be dispensed with, as shown in FIG. 64. In this figure, the gates of n-channel transistors M1 and M2 are connected in common, and M1 has a gate and a drain connected together. The gates of p-channel transistors M3 to M5 are connected in common, and M4 has a gate and a drain connected together.

Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA of the first current-to-voltage converter circuit (I-V1), made up of parallel connection of the diode D1 and the resistor R2, is equal to the terminal voltage VB of the second current-to-voltage converter circuit (I-V2), made up of series connection of the resistor R1 and the diodes D2 and the resistor R3 connected in parallel with the diodes D2. Hence, the operating condition equivalent to the use of the Op amp, described above, may be achieved. That is, the characteristic similar to that of FIG. 43 may be achieved to implement the reference voltage generating circuit.

However, the above-described reference voltage generating circuit, shown in FIG. 64, may be affected by transistor channel length modulation. For simplicity, the startup circuit is dispensed with.

### Other Embodiment of the Invention

In FIG. 65, the terminal of the first current-to-voltage converter circuit (I-V1), made up of parallel connection of the diode D1 and the resistor R2, and the terminal of the second current-to-voltage converter circuit (I-V2), made up of series connection of the resistor R1 and diodes D2 and the resistor R2 connected in parallel with the series connection, are connected to the sources of n-channel transistors M1 and M2, respectively. These n-channel transistors M1 and M2, p-channel transistors M5 and M7, and n-channel transistors M3 and M4, each constitute a current mirror circuit. The p-channel transistors M5 and M7 are connected between the drains of the n-channel transistors M1 and M2 and the power supply VDD, and have drains and gates connected together, whereas the n-channel transistors M3 and M4 have sources connected to two diodes D3, D4, and have gates coupled together.

There are p-channel transistors M6 and M8, connected between the drains of the n-channel transistors M3 and M4 and the power supply VDD, and the gates of the n-channel transistors M1 and M2 are connected together, and connected to the drain of the n-channel transistor M4. The p-channel transistors M5-M6 have gates connected together to constitute a current mirror circuit, whereas the p-channel transistors M7-M9 have gates connected together to constitute a current mirror circuit.

Hence, a current I1 flows through transistors M1, M7 to drive the first current-to-voltage converter circuit (I-V1) made up of series connection of the diode D1 and the resistor R2. Similarly, a current I2 flows through transistors M2 and M5 to drive the second current-to-voltage converter circuit (I-V2), made up of series connection of the resistor R1 and diodes D2 and the resistor R3 connected in parallel with the diodes D2. The number of the parallel-connected diodes D2 of the second current-to-voltage converter circuit (I-V2) is N.

A current I3 flows through transistor M9 and thence through resistor R6. The output voltage Vref is generated from the terminal voltage of the resistor R6.

The operation of the present embodiment is now described. In FIG. 65, there are provided the first current-to-voltage converter circuit, made up of parallel connection of the diode D1 and the resistor R2, and the second current-to-voltage converter circuit (I-V2), made up of the resistor R1, diodes D2 and the resistor R2 connected in parallel with the diodes D2. The currents flowing through the n-channel transistors M1 and M2, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of the parallel connection of the diode D1 and the resistor R2, and the second current-to-voltage converter circuit is made up of series connection of the resistor R1 and diodes D2 and the resistor R2 connected in parallel with the diodes D2, as described above. Hence, the operating condition similar to that in the case of using the OP amp may be achieved. That is, the characteristic similar to that FIG. 43 may be achieved, thus implementing a reference voltage generating circuit. The two diodes D3, D4 and the resistors R4 and R5, connected in parallel therewith, are inserted so that the drain voltages of the n-channel transistors M3 and M4 will be equal to each other.

The current I3 flows through transistor M9. This current is caused to flow into a resistor R6, and the output voltage Vref is obtained from the terminal voltage of the resistor R6.

### Other Embodiment of the Invention

In FIG. 66, a resistor R5 is connected between the source of a p-channel transistor M4 and the power supply VDD. Since the p-channel transistor M4 has the gate voltage in common with a p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, thus decreasing the current flowing through the n-channel transistor M1.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of parallel connection of the diode D1 and the resistor R2, while the second current-to-voltage converter circuit is made up of the series connection of the resistor R1 and the diodes D2 and the resistor R3 connected in parallel with the diodes D2, as described above.

The current I3 flows through transistor M7. This current is caused to flow into resistor R6 and the output voltage Vref is obtained from the terminal voltage of the resistor R6.

That is, the characteristic equivalent to that of FIG. 43 may be achieved, thus implementing a reference voltage generating circuit.

### Other Embodiment of the Invention

In the embodiment (FIG. 45) of the present invention (claim 18), described above, the OP amp is used as control means to provide for equal values of preset voltages. It should be noted however that a current mirror circuit may be used in place of the OP amp as control means for exercising control to provide for equal voltage values for preset voltages, as described in JP Patent Kokai Publication No. JP-P2006-209212A (US Patent 2006/0164158A1) or JP Patent Kokai Publication No. JP-P2006-133916A (US Patent 2006/0091875A1) by the same inventor as the present inventor.

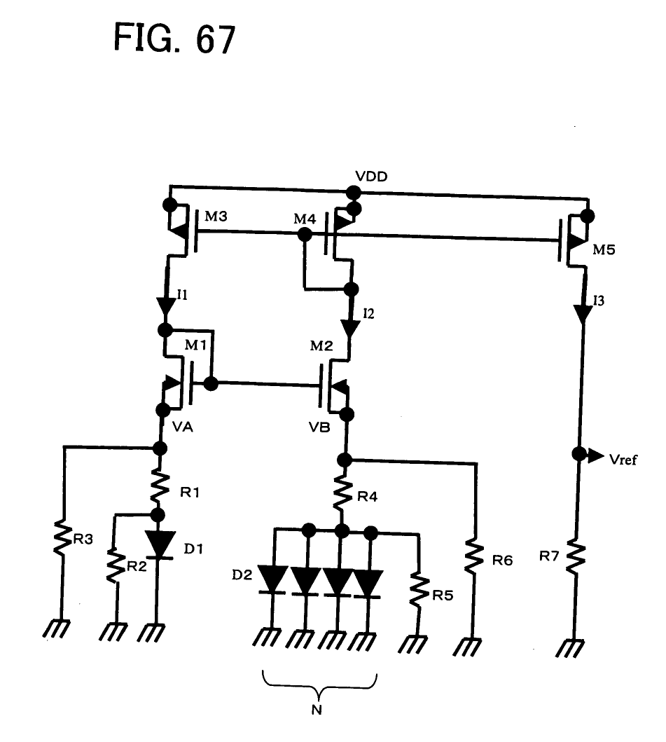

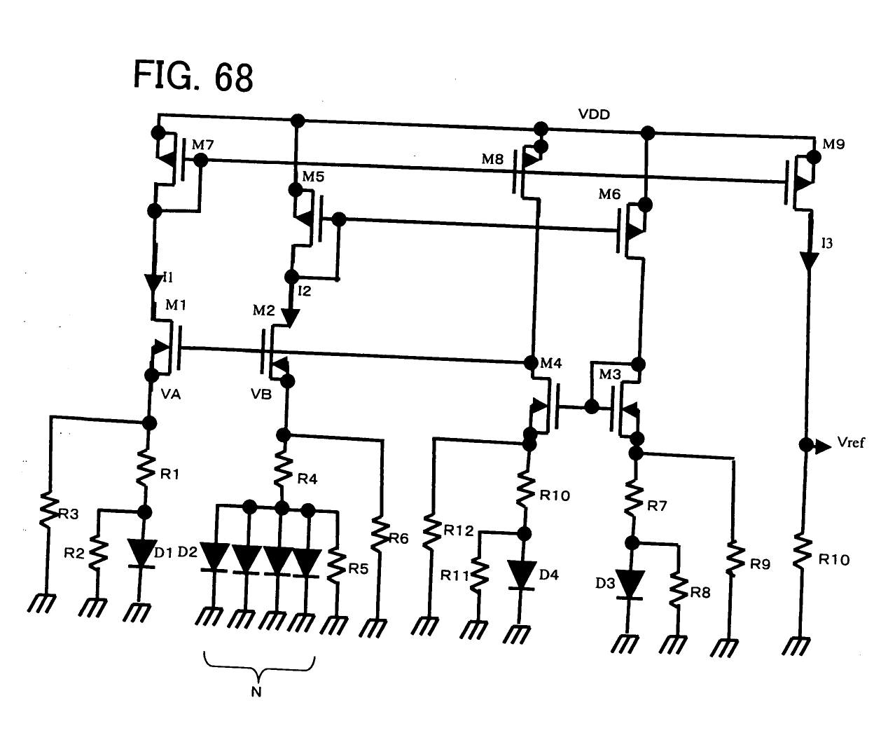

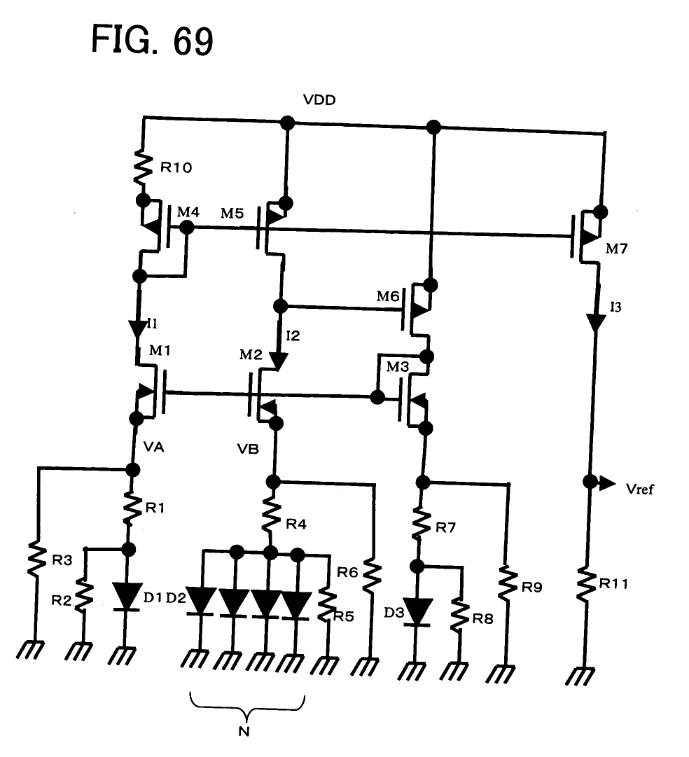

Specifically, the reference voltage generating circuit of FIG. 44 is developed as shown in FIGS. 67 to 69. For reducing the chip size, it is preferred to use the first current-to-voltage converter circuit I-V1 with a smaller number of diodes, as each of the two I-V converters in the control circuit as shown in FIGS. 68 and 69. However, the second current-to-voltage converter circuit (I-V2), with a larger number of diodes, may give the same meritorious effect insofar as the circuit operation is concerned.

In FIG. 67, the gates of n-channel transistors M1 and M2 are connected in common, and M1 has a gate and a drain connected in common. The gates of p-channel transistors M3 to M5 are connected in common, and M4 has a gate and a drain connected in common. Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2.

The current I1 flows through transistors M1, M3 to drive the first current-to-voltage converter circuit (I-V1), made up of parallel connection of the diode D1 and the resistor R2, the resistor R1 connected in series with D1-R2 and the resistor R3 connected in parallel with D1-R1-R2. The current I2 flows through transistors M2, M4 to drive the second current-to-voltage converter circuit (I-V2), made up of series connection of the resistor R4 and diodes D2, resistors R4 connected in parallel with the series connection and the resistor R6 connected in parallel with R4-D2-R5.

The current I3 from the transistor M5 drives the resistor R7 to generate the output voltage Vref from the terminal voltage of the resistor R7.

The operation of the present embodiment is now described. By self-biasing, the OP amp in the configuration of FIG. 44 may be dispensed with, as shown in FIG. 67. In this figure, the gates of n-channel transistors M1 and M2 are connected in common, and M1 has a gate and a drain connected together. The gates of p-channel transistors M3 to M5 are connected in common, and M4 has a gate and a drain connected together.

Hence, the n-channel transistors M1 and M2 and the p-channel transistors M3 to M5 each constitute a current mirror circuit. The current mirror circuit of the p-channel transistors M3 and M4 self-biases the current mirror circuit of the n-channel transistors M1 and M2.

The currents flowing through the n-channel transistors M1 and M2 are proportional to each other. If the n-channel transistors M1 and M2 are of the same size and the p-channel transistors M3 and M4 are of the same size, the currents through the n-channel transistors M1 and M2 are equal to each other.

With self-biasing, the gate source voltages of the n-channel transistors M1 and M2 become equal to each other, and hence the terminal voltage VA of the first current-to-voltage converter circuit (I-V1) is equal to the terminal voltage VB of the second current-to-voltage converter circuit (I-V2). The first current-to-voltage converter circuit is made up of parallel connection of the diode D1 and the resistor R2, resistor R1 connected in series with D1-R2 and the resistor R3 connected in parallel with D1-R1-R2, and the second current-to-voltage converter circuit is made up of series connection of the resistor R4 and diodes D2, resistors R5 connected in parallel with the diodes D2 and the resistor R6 connected in parallel with R4-D2-R5, as described above. Hence, the operating condition equivalent to the use of the OP amp, described above, may be achieved. That is, the characteristic similar to that of FIG. 44 may be achieved to implement the reference voltage generating circuit.

However, the above-described reference voltage generating circuit, shown in FIG. 67, may be affected by transistor channel length modulation. For simplicity, the startup circuit is dispensed with.

### Other Embodiment of the Invention

In FIG. 68, the terminal of the first current-to-voltage converter circuit (I-V1) and the terminal of the second current-to-voltage converter circuit (I-V2) are connected to the sources of n-channel transistors M1 and M2, respectively. The first current-to-voltage converter circuit is made up of a parallel connection of a diode D1 and a resistor R2, a resistor R1 connected in series with the parallel connection and a resistor R3 connected in parallel with R1-D1-R2, and the second current-to-voltage converter circuit is made up of a series connection of a resistor R4 and diodes D2, a resistors R5 connected in parallel with the diodes D2 and a resistor R6 connected in parallel with R4-D2-R5. These n-channel transistors M1 and M2, p-channel transistors M5 and M7, and n-channel transistors M3 and M4, each constitute a current mirror circuit. The p-channel transistors M5 and M7 are connected between the drains of the n-channel transistors M1 and M2 and the power supply VDD, and have drains and gates connected together, whereas the n-channel transistors M3 and M4 have sources connected to two diodes D3, D4, and have gates coupled together.

There are p-channel transistors M6 and M8, connected between the drains of the n-channel transistors M3 and M4 and the power supply VDD, and the gates of the n-channel transistors M1 and M2 are connected together and connected to the drain of the n-channel transistor M4. The p-channel transistors M5-M6 have gates connected together to constitute a current mirror circuit, whereas the p-channel transistors M7-M9 have gates connected together to constitute a current mirror circuit.

Hence, a current I1 flows through transistors M1 and M7 to drive the first current-to-voltage converter circuit (I-V1). Similarly, a current I2 flows through transistors M2 and M5 to drive the second current-to-voltage converter circuit (I-V2). The first current-to-voltage converter circuit is made up of parallel connection of the diode D1 and the resistor R2, the resistor R1 connected in series with the parallel connection and the resistor R3 connected in parallel with R1-D1-R2, whereas the second current-to-voltage converter circuit is made up of series connection of the resistor R4 and diodes D2, resistors R5 connected in parallel with the diodes D2 and the resistor R6 connected in parallel with R4-D2-R5, as described above.

The number of the parallel-connected diodes D2 of the second current-to-voltage converter circuit (I-V2) is N. The current I3 flows through transistor M9 and thence through resistor R10. The output voltage Vref is generated from the terminal voltage of the resistor R10.

The operation of the present embodiment is now described. In FIG. 68, there are provided the first current-to-voltage converter circuit, made up of parallel connection of the diode D1 and the resistor R2, the resistor R1 connected in series with the parallel connection and the resistor R3 connected in parallel with R1-D1-R2, whereas the second current-to-voltage converter circuit is made up of series connection of the resistor R4 and diodes D2, the resistors R5 connected in parallel with the diodes D2 and the resistor R6 connected in parallel with R4-D2-R5, as described above.

The currents flowing through the n-channel transistors M1 and M2, are compared to each other via the current mirror circuit made up of the p-channel transistors M5-M6 and the current mirror circuit made up of the p-channel transistors M7-M9, in the current mirror circuit made up of the n-channel transistors M3 and M4. The common gate voltage of the n-channel transistors M1 and M2 is controlled so that the currents flowing through the n-channel transistors M1 and M2 will be equal to each other.

Since the gate source voltages of the n-channel transistors M1 and M2 become equal to each other, the voltage VA applied to the first current-to-voltage converter circuit becomes equal to the voltage VB applied to the second current-to-voltage converter circuit, thus achieving the same operating condition as that of using the OP amp as described above. The first current-to-voltage converter circuit is made up of parallel connection of the diode D1 and the resistor R2, the resistor R1 connected in series with the parallel connection and the resistor R3 connected in parallel with R1-D1-R2, whereas the second current-to-voltage converter circuit is made up of series connection of the resistor R4 and diodes D2, the resistors R5 connected in parallel with the diodes D2 and the resistor R6 connected in parallel with R4-D2-R5, as described above. Hence, the operating condition similar to that in the case of using the OP amp may be achieved. That is, the characteristic similar to that FIG. 44 may be achieved, thus implementing a reference voltage generating circuit. The two IV-1s are inserted so that the drain voltages of the n-channel transistors M3 and M4 will be equal to each other.

The current I3 flows through transistor M9. This current is caused to flow into a resistor R10, and the output voltage Vref is obtained from the terminal voltage of the resistor R10.

### Other Embodiment of the Invention

In FIG. 69, a resistor R10 is connected between the source of a p-channel transistor M4 and the power supply VDD. Since the p-channel transistor M4 has the gate voltage in common with the p-channel transistor M5, the transistor size of the p-channel transistor M4 is selected to be larger than that of the p-channel transistor M5 so that the currents through the two transistors will be equal to each other. The current mirror circuit made up of the p-channel transistors M4, M5 constitutes an inverse-Widlar current mirror circuit.

The operation of the present embodiment is now described. When the current through the n-channel transistor M1 is increased, the current flowing through the p-channel transistor M4 is correspondingly increased. However, the current flowing through the p-channel transistor M5 becomes larger than the increased current through the p-channel transistor M4. Hence, the so increased current cannot flow through the n-channel transistor M2, thus increasing the drain voltage of the p-channel transistor M5 and decreasing the current through the p-channel transistor M6, the gate of which is connected to the drain of the p-channel transistor M5. This decreases the current flowing through the p-channel transistor M3 having the common drain current.

The n-channel transistors M3, M2 constitute a current mirror circuit, and the n-channel transistors M1 and M2 have the gate voltage in common. Hence, the common gate voltage of M1-M3 is decreased, with the result that the current flowing through the n-channel transistor M1 decreases.

That is, the current loop, composed of the n-channel transistors M1-M4 and the p-channel transistors M4-M6, constitutes a negative feedback circuit, and controls the common gate voltage of the n-channel transistors M1 and M2, via inverse-Widlar current mirror circuit, so that the currents through the n-channel transistors M1 and M2 will become of a preset value, herein equal to each other.

Hence, the gate source voltages of the n-channel transistors M1 and M2 become equal to each other. Consequently, the voltage applied to the first current-to-voltage converter circuit is equal to that applied to the second current-to-voltage converter circuit, thus achieving the same operating condition as that with the use of the OP amp as described above. The first current-to-voltage converter circuit is made up of parallel connection of the diode D1 and the resistor R2, the resistor R1 connected in series with the parallel connection and the resistor R3 connected in parallel with R1-D1-R2, whereas the second current-to-voltage converter circuit is made up of series connection of the resistor R4 and diodes D2, the resistors R5 connected in parallel with the diodes D2 and the resistor R6 connected in parallel with R4-D2-R5, as described above.

The current I3 flows through transistor M7. This current is caused to flow into resistor R11 and the output voltage Vref is obtained from the terminal voltage of the resistor R11.

That is, the characteristic similar to that FIG. 44 may be achieved, thus implementing a reference voltage generating circuit.

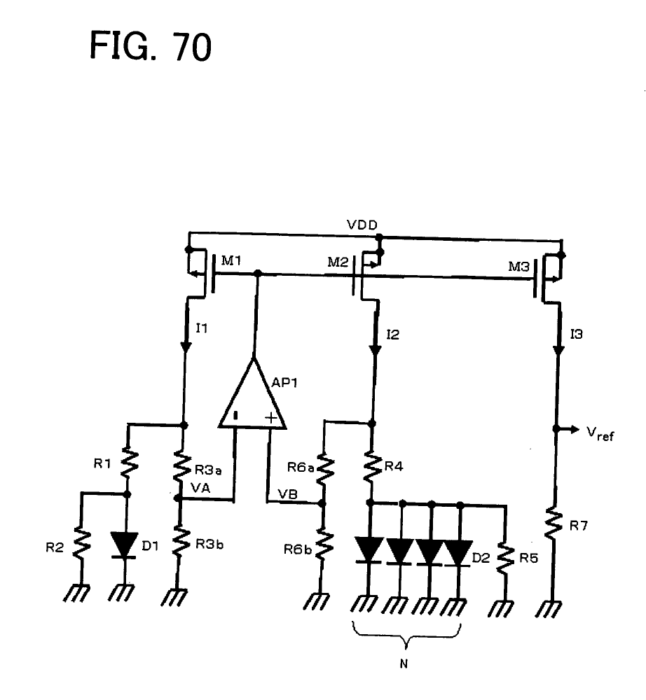

FIG. 70 shows the circuit configuration of an embodiment of a CMOS reference voltage generating circuit according to the present invention (claim 18). The circuit includes first, second and third current-voltage converter circuits, current mirror circuits for supplying currents I1, I2 and I3 to the first to third current-voltage converter circuits, and control means (OP amp AP1). The control means exercises control so that a preset mid-point terminal voltage VA of the first current-voltage converter circuit will be equal to a preset mid-point terminal voltage VB of the second current-voltage converter circuit. A preset voltage of the third current-voltage converter circuit is used as a reference voltage Vref. The first current-voltage converter circuit is made up of the diode D1, the resistor R2, connected in parallel with the diode, the resistor R1 connected in series with the parallel connection of the diode D1 and the resistor R2, and resistors R3a and R3b, connected in parallel with D1-R2-R1. The aforementioned mid-point terminal voltage VA of the first current-voltage converter circuit is output from the resistors R3a and R3b of the parallel path. The second current-voltage converter circuit is made up of a plural number of parallel-connected diodes D2, the resistor R5 connected in parallel with the diodes D2, the resistor R4, connected in series with (D2, R5), and resistors (R6a, R6b) connected in parallel with (R4, D2, R4). The aforementioned preset mid-point terminal voltage VB of the second current-voltage converter circuit is output from the resistors R6a and R6b of the parallel path. The third current-voltage converter circuit is the resistor R7. The diodes (D1, D2) may be bipolar junction transistors, connected as diodes. The constitution of FIG. 70 corresponds to the configuration of FIG. 44 in which two parallel-connected resistors R3, R6 are changed to voltage-dividing resistors (R3a, R3b) and (R6a, R6b) and preset mid-point terminals of the voltage-dividing resistors are connected to preset input terminals of the OP amp (AP1) to lower the input voltages to the OP amp (AP1).

If, with

R3a+R3b=R3 (227)

and

R6a+R6b=R6 (228)

the voltage-dividing voltage ratio is set by resistors so that

R3a/R3b=R6a/R6b (229)

will be valid, there is substantially no change in the circuit operation, and hence the reference voltage similar to that of FIG. 44 may be obtained.

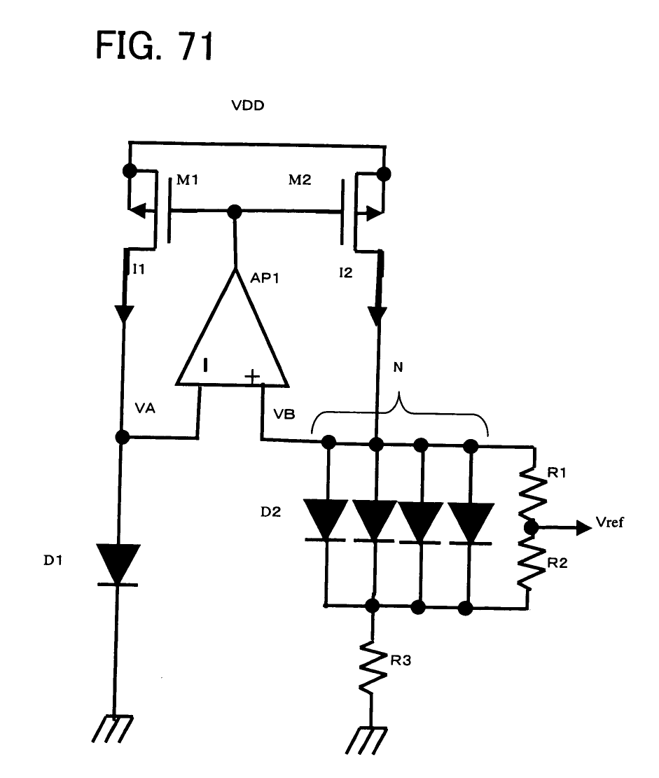

In FIG. 71, assuming that the midpoint terminal voltage of the dividing registers R1 and R2 is Vref′, since control is performed by the OP amp (AP1) such that VA=VB, the following equation holds

$${Vref}^{ ′} = {V}_{F 1} - {V}_{F 2} + \frac{{R}_{2}}{{R}_{1} + {R}_{2}} {V}_{F 2} = Δ {V}_{F} + \frac{{R}_{2}}{{R}_{1} + {R}_{2}} {V}_{F 2} = α {V}_{F 2} + Δ {V}_{F} ( α < 1 ) \qquad ( 234 )$$

Since I1=I2, we have

$$Δ {V}_{F} = {V}_{T} ln ( \frac{N}{1 - \frac{{V}_{F 2}}{{I}_{1} ( {R}_{1} + {R}_{2} )}} ) \qquad ( 235 )$$

From (235), we see that the reference voltage generating circuit shown in FIG. 71 is able to improve the non-linear temperature characteristic of the diode, as the reference voltage generating circuit shown in FIGS. 42, 43 and FIG. 44.

The reference voltage of the equation (234) is a low voltage, such as several times as large as 50 mV, as with ones of FIG. 32, 33, 34 and FIG. 36. In case of the number N of diodes D2 connected in parallel being set to 148, the reference voltage is about 250 mV. In general, the target value of the reference voltage is set to 200 mV. With the reference voltage generating circuit shown in FIG. 71, the reference voltage is speculated by the number N (log) of diodes D2 connected in parallel, for example,

100 mV@N≈3, 150 mV@N≈20, 200 mV@N≈55, 250 mV@N≈148.

The voltage obtained is far from the band-gap voltage of Si. The reason why the present inventor doesn't call it the band-gap reference but call it voltage reference would be understood.

The values of simulation result are shown below. If, with VDD=1.3V, N and R1 to R5 are set so that N=8, R1=100 kΩ, R2=5.703 kΩ, R3=5 kΩ, the reference voltage are

101.71 mV at −53° C.,

101.797 mV at −20° C.,

101.88 mVm at 27° C.,

101.882 mV, at 40° C., and

101.702 mV at 103° C.

so that the characteristic with a mountain type shape has been obtained. The temperature variation range is suppressed to 0.18%.

As described above, other than the conventional voltage Vref=VBE1+KΔVBE≈1.2V(K>>1), the temperature compensated reference voltage or the reference voltage having the temperature non-linearity of VBE of a bipolar transistor or diode compensated is able to be obtained by Vref′=αVBE+ΔVBE(α<1).

The difference between the reference voltage generation circuits shown in FIG. 71 and FIG. 42 will be explained. The reference voltage generation circuits shown in FIG. 71 and FIG. 42 are equivalent in the circuit configuration. However, in the circuit operation, the temperature characteristic of the driving currents (I1, I2) in the reference voltage generation circuit shown in FIG. 71 is positive, while in the reference voltage generation circuit shown in FIG. 42, the temperature characteristic of the driving currents (I1, I2) is compensated. In the reference voltage generation circuit, the current or voltage having a positive temperature characteristic and the current or voltage having a negative temperature characteristic is summed to cancel out the temperature characteristic so that for the different starting point, another compensation method is present.

This difference results in the difference of the output node of the reference voltage. In FIG. 42, the second current-to-voltage conversion circuit includes a parallel circuit including a plurality of diodes D2 and a resistor R2 connected in parallel; and a resistor (R1) connected in series with the parallel circuit. The position of the parallel circuit (D1/R2) and the resistor (R1) are mutually exchanged and the resistor (R1) is connected to GND. With this configuration, the reference voltage Vref can be obtained from the terminal voltage of the resistor (R1), as a result of which the second current-to-voltage conversion circuit is dispensed. In this case, the reference voltage Vref cannot be set to an arbitrary value.

### INDUSTRIAL UTILIZABILITY

Among the examples of practical application of the present invention, there are various reference voltage generating circuits integrated on an LSI. In particular, in keeping with recent progress in the ultra-miniaturization of the integrated circuit process, the effect of MOS transistor channel length modulation is apparent. Further, there is a demand for a lower supply power voltage for the LSI and for stabilized reference voltage generating circuits, free from temperature variations and which may be operated even with the power supply voltage on the order of 1V. The present invention is configured to meet such demand.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A reference voltage generating circuit comprising:
first, second, third current-to-voltage conversion circuits;
a current mirror circuit that supplies currents to the first, second and third current-to-voltage conversion circuits, respectively;
a control circuit that exercises control so that a preset output voltage of the first current-to-voltage conversion circuit is made equal to a preset output voltage of the second current-to-voltage conversion circuit; and
a resistor connected between the first and second current-to-voltage conversion circuits;
wherein the third current-to-voltage conversion circuit is composed of a resistor with a preset terminal voltage thereof used as a reference voltage;
the first current-to-voltage conversion circuit includes a diode and a resistor connected in parallel with the diode; and
the second current-to-voltage conversion circuit includes a series circuit including a diode and a resistor connected in series; and further a resistor connected in parallel with the series circuit.

2. The reference voltage generating circuit according to claim 1, wherein the preset voltages of the first and second current-to-voltage conversion circuits are divided voltages of the parallel connected resistors thereof, respectively.

3. The reference voltage generating circuit according to claim 1, wherein the first current-to-voltage conversion circuit is composed of a diode; and
the second current-to-voltage conversion circuit includes a diode and a resistor connected in series with the diode;
said reference voltage generating circuit further comprising:
a first resistor that receives a current from said first current mirror circuit;
a second resistor connected between the first resistor and the first current-to-voltage conversion circuit; and
a third resistor connected between the first resistor and the second current-to-voltage conversion circuit.

4. The reference voltage generating circuit according to claim 1, further comprising:
a first diode driven by the first current mirror circuit;
a first resistor connected between the first diode and the first current-to-voltage conversion circuit; and;
a second resistor connected between the first diode and the second current-to-voltage conversion circuit.

5. The reference voltage generating circuit according to claim 1, wherein the first current-to-voltage conversion circuit is composed of a diode; and
the second current-to-voltage conversion circuit includes a resistor and a diode that is connected in parallel with the resistor;
said reference voltage generating circuit further comprising:
first, second and third resistors having one ends connected in common and other ends connected to the first and second current-to-voltage conversion circuits and ground, respectively, to constitute a T shaped resistor;
a first diode driven by a current from first current-to-voltage conversion circuit;
a fourth resistor connected between the first diode and the first current-to-voltage conversion circuit; and
a fifth resistor connected between the first diode and the second current-to-voltage conversion circuit.

6. A reference voltage generating circuit comprising:
first, second, third and fourth current-to-voltage conversion circuits;
a first current mirror circuit that supplies currents to the first, second, third and fourth current-to-voltage conversion circuits, respectively;
a first control circuit that exercises control so that a preset output voltage of the first current-to-voltage conversion circuit is made equal to a preset output of the second current-to-voltage conversion circuit;
first and second resistors connected to the first and second current-voltage conversion circuits, respectively;
a second current mirror circuit that supplies currents to the first and second resistors, respectively; and
a second control circuit that exercises control so that a preset output voltage of the fourth current-to-voltage conversion circuit is made equal to a terminal voltage of one of the first and second resistors connected to the first and second current-to-voltage conversion circuits, respectively; wherein
the third current-to-voltage conversion circuit is composed of a resistor with a preset terminal voltage thereof used as a reference voltage;
the fourth current-to-voltage conversion circuit is composed of a diode;
the first current-to-voltage conversion circuit includes a diode and a resistor connected in parallel with the diode; and
the second current-to-voltage conversion circuit includes a series circuit including diode and a resistor connected in series and the series circuit.

7. The reference voltage generating circuit according to claim 6, further comprising:
a first diode driven by the current from the first current mirror circuit;
a second current mirror circuit that supplies currents to the first and second current-to-voltage conversion circuits, via first and second resistors, respectively; and
a second control circuit that exercises control so that a preset output voltage of the first diode is made equal to a terminal voltage of one of the first and second resistors connected to the first and second current-to-voltage conversion circuits, respectively

8. The reference voltage generating circuit according to claim 6, wherein the first current-to-voltage conversion circuit is composed of a diode; and
the second current-to-voltage conversion circuit include a diode and a resistor connected in parallel;
said reference voltage generating circuit further comprising:
first, second and third resistors having one ends connected in common and other ends connected to the first current-to-voltage conversion circuit and the second current-to-voltage conversion circuit and the ground, respectively, to constitute a T shaped resistor.

9. A reference voltage generating circuit comprising:
first and second or third current-to-voltage conversion circuits;
a current mirror circuit that supplies currents to the first and second or third current-to-voltage conversion circuits, respectively;
wherein the first current-to-voltage conversion circuit is composed of a diode;
the second current-to-voltage conversion circuit includes a plurality of diodes connected in parallel and a resistor connected in series with the diodes; and
the third current-to-voltage conversion circuit is composed of a resistor;
said reference voltage generating circuit further including:
a divider circuit that divides the voltage across the terminals of the parallel connected diodes; and
a control circuit that exercises control so that a preset terminal voltage of the first current-to-voltage conversion circuit is made equal to the divided voltage of the parallel connected diodes constituting the second current-to-voltage conversion circuit;
the terminal voltage of the resistor of the second current-to-voltage conversion circuit or a preset voltage of the third current-to-voltage conversion circuit being used as a reference voltage.

10. A reference voltage generating circuit comprising:
first, second and third current-to-voltage conversion circuits;
a current mirror circuit that supplies currents to the first, second and third current-to-voltage conversion circuits, respectively;
a control circuit that exercises control so that a preset voltage of the first current-to-voltage conversion circuit is made equal to a preset voltage of the second current-to-voltage conversion circuit;
wherein the first current-to-voltage conversion circuit is composed of a diode;
the second current-to-voltage conversion circuit includes a plurality of diodes connected in parallel and a resistor connected in series with the diodes, the divided voltage of the resistor being made said preset voltage thereof.

11. The reference voltage generating circuit according to claim 10, wherein the current mirror circuit includes:
a non-linear current mirror circuit that supplies currents to the first and second current-to-voltage conversion circuits, respectively; and
a linear current mirror circuit that supplies a current to the third current-to-voltage conversion circuit, said current being proportionate to a current driving one of the first and second current-to-voltage conversion circuits.

12. The reference voltage generating circuit according to claim 10, wherein the first current-to-voltage conversion circuit includes a diode and a resistor connected in parallel with the diode.

13. The reference voltage generating circuit according to claim 10, wherein the divided voltage of the parallel-connected resister in the first current-to-voltage conversion circuit is made the preset voltage of the first current-to-voltage conversion circuit; and
the divided voltage of the parallel-connected resister in the second current-to-voltage conversion circuit is made the preset voltage of the second current-to-voltage conversion circuit.

14. A reference voltage generating circuit comprising:
a MOS transistor having a drain grounded via a resistor, a gate grounded directly, and a source driven by a current having a positive temperature characteristic; and
a voltage divider that divides the drain-to-source voltage of the MOS transistor, the divided voltage being used as a reference voltage.

15. The reference voltage generating circuit according to claim 10, wherein the second current-to-voltage conversion circuit includes:
a parallel circuit including a plurality of diodes connected in parallel and a resistor connected in parallel with the diodes; and
a resistor connected in series with the parallel circuit; with the terminal voltage of the second current-to-voltage conversion circuit being made said preset voltage of the second current-to-voltage conversion circuit.

16. The reference voltage generating circuit according to claim 15, wherein the second current-to-voltage conversion circuit includes a diode and a resistor connected in series with the diode.

17. The reference voltage generating circuit according to claim 10, wherein the first current-to-voltage conversion circuit comprises a series circuit that includes a parallel circuit including a diode and a resistor connected in parallel with the diode, and a resistor connected in series with the parallel circuit; and
a resistor connected in parallel with the series circuit; and
the second current-to-voltage conversion circuit comprises:
a series circuit that includes a parallel circuit including a plurality of diodes connected in parallel and a resistor connected in parallel with the diodes, and a resistor connected in series with the parallel circuit; and
a resistor connected in parallel with the series circuit.

18. The reference voltage generating circuit according to claim 9, comprising:
first and second or third current-to-voltage conversion circuits;
a current mirror circuit that supplies currents to the first and second or first, second and third current-to-voltage conversion circuits, respectively;
wherein the first current-to-voltage conversion circuit is composed of a diode;
the second current-to-voltage conversion circuit includes a plurality of diodes and a resistor connected in series with the parallel connected diodes; and
the third current-to-voltage conversion circuit is composed of a resistor;
said reference voltage generating circuit further comprising:
a circuit that divides the voltage across the terminals of the parallel connected diodes; and
a control circuit that exercises control so that a preset terminal voltage of the first current-to-voltage conversion circuit is made equal to a preset terminal voltage of the second current-to-voltage conversion circuit;
the divided voltage of the terminal voltage across the parallel connected diodes of the second current-to-voltage conversion circuit being used as a reference voltage.

19. The reference voltage generating circuit according to claim 1, wherein the control circuit includes an operational amplifier that has non-inverting and inverting input terminals for receiving two input voltages and an output terminal connected to the coupled gates of the current mirror circuit.

20. The reference voltage generating circuit according to claim 1, wherein the control circuit includes another current mirror circuit connected between said current mirror circuit and the current-to-voltage conversion circuits.

21. The reference voltage generating circuit according to claim 1, wherein the diode is composed by a diode-connected bipolar junction transistor.
